(19) United States
(12) Patent Application Publication
(10) Pub. No.: US 2026/0223119 A1
(43) Pub. Date: Jul. 30, 2026

(54) DYNAMIC UPLINK MANAGEMENT FOR XR WTRUS

(71) Applicant: Oswego Technologies LLC, columbus, NJ (US)

(72) Inventor: Ali Esswie, Calgary (CA)

(21) Appl. No.: 19/371,958

(22) Filed: Oct. 28, 2025

Related U.S. Application Data
(60) Provisional application No. 63/749,657, filed on Jan. 26, 2025.
(60) Provisional application No. 63/766,673, filed on Mar. 4, 2025.
(60) Provisional application No. 63/770,408, filed on Mar. 12, 2025.

(51) Int. Cl. H04W 72/21; H04W 28/02

(52) U.S. Cl. CPC H04W 72/21; H04W 28/0278

(57) ABSTRACT

Disclosed herein is a method performed by a wireless device operating in a wireless local area network (WLAN). The method comprises receiving, by the wireless device, one or more data packets and transmitting, by the wireless device, a response message on an uplink resource, wherein the response message comprises one or more acknowledgements to the first message. The response message further comprises one or more of: one or more buffer delay reports indicative of an amount of data currently awaiting transmission; an urgency level of low latency traffic; and information indicative of a data bearer.

This application claims the benefit of U.S. Provisional Application No. 63/749,657 filed on Jan. 26, 2025, U.S. Provisional Application No. 63/766,673 filed on Mar. 4, 2025 and U.S. Provisional Application No. 63/770,408 filed on Mar. 12, 2025, the contents of each of which are incorporated herein by way of reference in their entirety.

### BACKGROUND

The advent of 5G New Radio (NR) technology has revolutionized cellular networks, offering unprecedented data rates, ultra-reliable low-latency communication (URLLC), and massive machine-type communication (mMTC) capabilities. These advancements enable a wide array of applications, including autonomous vehicles, remote surgery, and augmented reality. However, delivering seamless connectivity across diverse scenarios, such as high-speed vehicular environments and densely populated urban areas, remains a critical challenge. One key requirement for maintaining a high-quality user experience is ensuring seamless handovers between cells, which allows devices to transition between radio access network (RAN) nodes without service disruption. The high density of 5G base stations and the dynamic nature of modern networks further complicate this process, making efficient handover management a cornerstone of 5G performance.

Extended reality (XR) application, refers to, or comprises, an immersive application that requires stringent latency and reliability requirements to ensure seamless and responsive user experiences. Particularly in the uplink direction, XR traffic flows are characterized by critical and fast user-generated updates, such as positional tracking, motion data, gesture inputs, or other real-time behavioral updates, which should be transmitted to the application server with minimal delay and high reliability.

To meet these requirements, the XR uplink traffic flow may leverage mechanisms such as low-latency data radio bearers, prioritized scheduling algorithms, or enhanced retransmission techniques to ensure that packets are delivered within the application's strict latency and error tolerance thresholds. By way of illustration and not limitation, uplink XR traffic may include positional data updates transmitted in intervals as small as a few milliseconds, ensuring that the XR application can process and reflect user actions in real time without noticeable lag or interruptions.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

In one exemplary embodiment, the XR WTRU establishes an XR session and categorizes traffic flows of the XR application into high-priority traffic flows, such as real-time motion tracking updates, and low-priority traffic flows, such as background synchronization data. The WTRU receives uplink congestion information from a RAN node, which includes real-time average delay and the average data rate of the uplink DRB. When the congestion information indicates that target application requirements are fulfilled, the WTRU erases the congestion information and resumes the XR session with first application parameters, including initial codecs, modulation and coding schemes, and data rates.

In one exemplary embodiment, the WTRU stores pre-defined QoS profiles in its device memory for each active XR application. These QoS profiles include specific performance parameters such as minimum and maximum latency budgets and data rate thresholds tailored to different types of traffic flows generated by the application. When the XR session is established, the WTRU retrieves the relevant QoS profile and analyzes the traffic flows based on their characteristics and requirements. Traffic flows with latency or data rate demands exceeding high-priority thresholds defined in the QoS profile are categorized as high-priority, while flows with less stringent requirements are categorized as low-priority, enabling the WTRU to manage and prioritize the traffic accordingly.

In another exemplary embodiment, the XR WTRU receives uplink congestion information indicating that target application requirements are violated. The WTRU determines whether the available DRB capacity and average delay are sufficient to fulfill high-priority traffic flow requirements. If sufficient, the WTRU reallocates uplink capacity to prioritize high-priority traffic flows, such as gesture inputs, while deferring or compressing low-priority flows, such as environmental updates. It transmits a logical channel capacity reallocation request to the RAN node, detailing prioritized logical channel IDs, compression details, and the validity period of the reallocation.

In another embodiment, the XR WTRU detects that the received uplink congestion information indicates the high-priority traffic flow requirements are not met. The WTRU determines minimum acceptable application performance metrics, including the minimum data rate and maximum delay budget. The WTRU calculates a ramp-down period with reduced streaming codecs and adjusted MCS levels and transmits an XR application ramp-down report to the RAN node. This report includes a timeline for ramping down XR application performance while maintaining minimal essential functionality.

In a further embodiment, the XR WTRU, during an active ramp-down period, receives updated uplink congestion information indicating that the target requirements of the XR application are satisfied. The WTRU preemptively stops and erases the current ramp-down timeline and determines maximum application performance metrics, such as increased data rate and reduced delay. The WTRU calculates ramp-up details with upgraded streaming codecs and MCS levels and transmits an XR application ramp-up report to the RAN node, including the ramp-up timeline and enhanced application parameters.

In another embodiment, the XR WTRU monitors the uplink congestion state for each DRB. When the congestion state changes, the WTRU uses predefined congestion metric thresholds stored in device memory to map the new state to average delay and data rate metrics. For example, when the DRB utilization percentage exceeds a threshold, the WTRU dynamically adapts application parameters, such as codecs or data rates, to align with the updated DRB performance.

In an additional embodiment, the XR WTRU detects a DRB switching indication from a RAN node, where the uplink traffic flow is reassigned to a higher-priority DRB. During the switching period, the WTRU ensures uninterrupted XR application performance by adapting application parameters, such as codecs and data rates, to match the characteristics of the higher-priority DRB. Upon expiry of the switching period, the WTRU reverts to the original DRB, re-adapting the parameters as needed.

In another embodiment, the XR WTRU identifies a buffer overflow event for low-priority logical channels by comparing the packet generation rate with the buffer outflow rate. Upon detecting a buffer overflow event, the WTRU transmits an uplink DRB upscale request to the RAN node. This request includes an indication of the need for a higher-priority DRB to handle deferred traffic flows and provides a partial buffer status report specifying the payload size of the affected logical channels.

In one embodiment, the XR WTRU receives an indication from the RAN node approving a DRB upscale request. The WTRU transitions the transmission of deferred traffic flows to the higher-priority DRB during the specified DRB switching period. This ensures that buffer overflow conditions for deferred logical channels are resolved without disrupting high-priority traffic flows, maintaining the overall performance of the XR application.

In one exemplary embodiment, the RAN node tracks, filters, and calculates real-time aggregate uplink congestion information for each active DRB associated with uplink devices, including metrics such as average uplink packet delay, average data rate, and per-DRB utilization percentages. Upon detecting that the rate of change of these metrics exceeds predefined thresholds, the RAN node compiles congestion reports and transmits them to active devices using downlink control channels, such as a device-common PDCCH scrambled with congestion-specific device-group scrambling codes, to enable efficient communication of congestion states.

In another exemplary embodiment, the RAN node monitors the performance of active uplink traffic flows and determines whether any uplink flow fails to meet its performance targets, such as latency or data rate requirements. If a violation is detected, the RAN node temporarily switches the impacted uplink flow to a higher-priority DRB that satisfies the performance requirements. The higher-priority DRB is preconfigured with more stringent QoS Class Identifiers (QCIs) specifying the lowest packet delay budgets and highest guaranteed bit rates, ensuring improved performance for the impacted flow.

In another embodiment, the RAN node quantizes real-time uplink congestion metrics into binary congestion state indicators for each DRB. These state indicators are transmitted to active XR WTRUs via device-specific or common downlink control channels, enabling the devices to adapt their application parameters accordingly. The use of quantized congestion states simplifies communication overhead while ensuring timely updates about the uplink performance conditions.

In one embodiment, the RAN node assigns congestion state-specific scrambling codes to downlink control channels carrying real-time uplink congestion information reports. This approach allows for efficient communication with device groups experiencing similar congestion conditions, enabling XR WTRUs to simultaneously receive and act on updated congestion states in a coordinated manner, improving resource utilization and system responsiveness.

### BRIEF DESCRIPTION OF THE DRAWINGS

FIG. 1 illustrates the WTRU device action for categorizing various XR traffic flows;

FIG. 2 illustrates the dynamic WTRU action for compressing low priority traffic flows;

FIG. 3 illustrates an example of the WTRU ramp down timeline of the XR application;

FIG. 4 illustrates the WTRU device action for preempting low priority traffic compression based on buffer overflow detection;

FIG. 5 illustrates the RAN node quantization of congestion information into congestion states;

FIG. 6 illustrates a timeline of an overall WTRU device action;

FIG. 7 illustrates two devices in communication with one another;

FIG. 8 illustrates the downlink Buffer delay reporting configurations (DCI) signaling and buffer delay table selection;

FIG. 9 illustrates the generation of individual buffer delay reports;

FIG. 10 illustrates the case where control channel resource fits all generated high priority delay reports;

FIG. 11 illustrates the case where control channel resource is limited to carry all eligible buffer reports, leading devices to generate multi-precision buffer delay reports;

FIG. 12 illustrates multiple exemplary variants of transmitted buffer delay information;

FIG. 13 illustrates an overall timeline of the device actions executing the proposed buffer delay reporting scheme;

FIG. 14 illustrates a plurality of graphs;

FIG. 15 illustrates local rendering capability indication signaling in the uplink direction;

FIG. 16 illustrates the backhaul signaling exchange of future time transport blocks;

FIG. 17 illustrates a scenario involving five active XR WTRUS;

FIG. 18 illustrates a multi-device future time transport block format;

FIG. 19 illustrates the future time transport blocks delivery over the radio interface;

FIG. 20 illustrates the radio signaling structure of the buffered pre rendering blocks;

FIG. 21 illustrates the RAN node categorization of active devices upon congestion detection; and

FIG. 22 illustrates an overall timeline of the RAN node actions;

FIG. 23 illustrates a timing diagram on device ERMD configuration from a first RAN node; and

FIG. 24 illustrates the proposed change of device behavior based on ERMD configurations from RAN node.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

As used in this disclosure, in some embodiments, the term “Data Radio Bearer” (DRB) is intended to refer to, or comprise, a logical channel or a set of associated parameters that define downlink or uplink rules, scheduling policies, or performance targets for data transmission in a wireless communication system. A DRB can represent, but is not limited to, an entity that manages the transmission of data packets, assigns priority levels, or enforces quality-of-service (QoS) criteria based on predefined requirements or dynamic network conditions.

By way of illustration and not limitation, a DRB can encompass a configuration for handling packets according to latency, throughput, or reliability constraints; a scheduling policy for allocating radio resources; or a set of QoS targets that ensure compliance with application-specific performance metrics. Both the logical structure governing packet flow and the execution of such rules on a network element, such as a user equipment (UE) or a base station (e.g., gNB), can be considered part of the DRB.

As used in this disclosure, in some embodiments, the term “logical channel” is intended to refer to, or comprise, an abstraction or representation of a device buffer that stores one or more packets associated with specific traffic flows or traffic streams. A logical channel may encompass, but is not limited to, a data structure, queue, or memory segment within a device configured to temporarily hold data packets awaiting transmission or processing according to predefined rules, priorities, or scheduling policies. Each logical channel can be uniquely identified by a logical channel ID (LCID), which serves as an identifier for the corresponding buffer and its associated traffic flow or stream. By way of illustration and not limitation, a logical channel may represent a buffer for real-time traffic, such as voice or video, with strict latency constraints, or for non-real-time traffic, such as file transfers, with relaxed delay requirements. Logical channels may be dynamically created, modified, or terminated based on the requirements of the communication system or the application in use.

As used in this disclosure, in some embodiments, the term “traffic flow” or “traffic stream” is intended to refer to, or comprise, a set of application-generated packets that are produced as a result of specific application reactions or events. These reactions may include, but are not limited to, user interactions, automated system triggers, or periodic updates. A traffic flow represents packets that share unique characteristics and are associated with a common set of performance targets, such as latency, reliability, or throughput, to fulfill specific application requirements. The type of traffic generated within a traffic flow is arbitrary and may vary across applications. By way of illustration and not limitation, examples of traffic flows include File Transfer Protocol (FTP) sessions, Extended Reality Media (XRM) streams, full-buffer downloads, interactive gaming data, or any other packetized communication reflecting a specific application state or behavior. A traffic flow may target one or more performance objectives, which are determined dynamically or based on pre-configured application or network policies.

XR traffic flows exhibit diverse Quality of Service (QoS) requirements, as they encompass a wide range of data types with varying performance needs. Certain traffic flows, such as those tied to real-time user interactions, demand stringent uplink scheduling and transmission latencies to ensure rapid responses in the downlink direction. For example, real-time updates of user actions should be transmitted promptly in the uplink to allow the XR application to process the data and provide instantaneous feedback. Meeting these demands is critical to delivering a seamless and immersive user experience, as any delay in uplink transmission can result in noticeable latency and degrade application performance.

A key challenge in achieving such stringent uplink QoS targets lies in managing uplink congestion within the network. XR deployments often involve a large number of devices transmitting high volumes of data simultaneously, leading to congestion in the uplink direction. This congestion is particularly problematic because it introduces delays, reduces the available capacity for time-critical traffic flows, and impacts the overall performance of the XR sessions. The effects of uplink congestion are compounded in scenarios involving dense network deployments where multiple XR devices compete for limited uplink resources, further straining the network's ability to meet QoS requirements for real-time traffic.

A significant limitation arises from the fact that uplink congestion information is only known to the Radio Access Network (RAN) node, leaving XR devices unaware of the network's real-time congestion state. As a result, uplink devices are instantly impacted when uplink performance degrades due to congestion, leading to unexpected impacts on XR traffic flows. This lack of visibility prevents devices from proactively adapting their transmission behavior, causing high-priority traffic flows to experience delays or disruptions, ultimately affecting the XR application's responsiveness and user experience.

Uplink congestion information may be transmitted from a Radio Access Network (RAN) node to an Extended Reality (XR) Wireless Transmit/Receive Unit (WTRU) through various signaling mechanisms. An XR WTRU may include a phone and/or AR glasses, etc. The uplink congestion information may be delivered via Downlink Control Information (DCI) signaling, where the congestion data is embedded within device-specific or common physical downlink control channels (PDCCH). The RAN node may encode the congestion information using a binary or quantized format, indicating the congestion state of individual Data Radio Bearers (DRBs), such as packet delay budgets, data rates, or per DRB utilization levels. The DCI signaling is scrambled with either device-specific or congestion-specific group scrambling codes to ensure accurate and efficient communication. Alternatively, the congestion information may be conveyed using Radio Resource Control (RRC) signaling, in which the RAN node transmits dedicated RRC messages to the XR WTRU. Further, the RAN node may trigger broadcasting of the uplink congestion information as part of System Information Block (SIB) messages, wherein it may incorporate new or existing SIB information elements to include aggregate or DRB-specific congestion states. These broadcast signals provide congestion metrics to multiple devices, in idle state, within the coverage area of the RAN.

TABLE 1
IE: Uplink congestion information

| | Uplink congestion information |
|---|---|
| Information element 1 | (a) Real-time average delay of the uplink |
| | bearer or flow |
| Information element 2 | (b) Average data rate of the uplink bearer or |
| | flow |

As illustrated in Table 1, the uplink congestion information is provided to Wireless Transmit/Receive Units (WTRUs) via device-specific control signaling. In this case, the Radio Access Network (RAN) node compiles congestion information specifically for each WTRU, considering only the Data Radio Bearers (DRBs) actively utilized by that device. This tailored approach minimizes the computational complexity at the WTRU, as it decodes only the uplink congestion information relevant to its assigned DRBs. The device-specific signaling allows the WTRU to efficiently process congestion feedback without filtering unrelated data. However, this method requires the RAN to generate and transmit separate congestion reports for each active WTRU, leading to increased signaling overhead in the network, particularly in scenarios with a high density of active devices.

TABLE 2
IO: Uplink congestion information

| | | Uplink congestion information |
|---|---|---|
| Information object 1 | Uplink bearer ID X₁ | (a) Real-time average delay |
| | | (b) Average data rate |
| Information object 2 | Uplink bearer ID X₂ | . |
| | | . |
| | | . |

As shown in Table 2, uplink congestion information may be transmitted as device-group control signaling. Here, the RAN node broadcasts congestion reports organized by DRB IDs, without targeting specific WTRUs. Each WTRU receives and decodes the entire set of information objects, independently identifying and utilizing only the congestion data associated with the DRBs it is actively employing for uplink traffic. While this approach reduces the signaling overhead by enabling shared reporting across multiple WTRUs, it imposes additional decoding complexity at the WTRU level. Each WTRU should parse the complete set of broadcast information to extract relevant congestion data, increasing the processing burden on the device. This method is particularly advantageous in environments with overlapping DRB usage among multiple WTRUs, as it minimizes duplication of transmitted information across the network.

Further, the WTRU may receive, as part of the uplink congestion information, utilization information, including the DRB utilization percentage and a binary flag indicating whether an uplink DRB switch to a higher-priority bearer is pending. The DRB utilization percentage, referred to as the first utilization ratio, is highlighted as a critical metric in enabling the WTRU to assess the current load on its active DRB. This metric assists the WTRU in determining the likelihood of congestion occurring in the near future. The WTRU uses this information to proactively adjust its transmission parameters, such as re-prioritizing traffic flows, modifying streaming codecs, or adapting the modulation and coding schemes (MCS), even before actual DRB congestion occurs.

The binary flag provides the WTRU with an indication that, irrespective of the received congestion information for active DRBs, the RAN node has already initiated or scheduled a switch to a higher-priority DRB. This switch is typically based on predefined criteria, such as the WTRU's subscription level or assigned priority. Thus, the indicated DRB switching binary flag allows the WTRU to infer that a higher-priority DRB allocation has been or is being provisioned by the RAN node, thereby enabling the WTRU to align its operational parameters with the characteristics of the upgraded DRB.

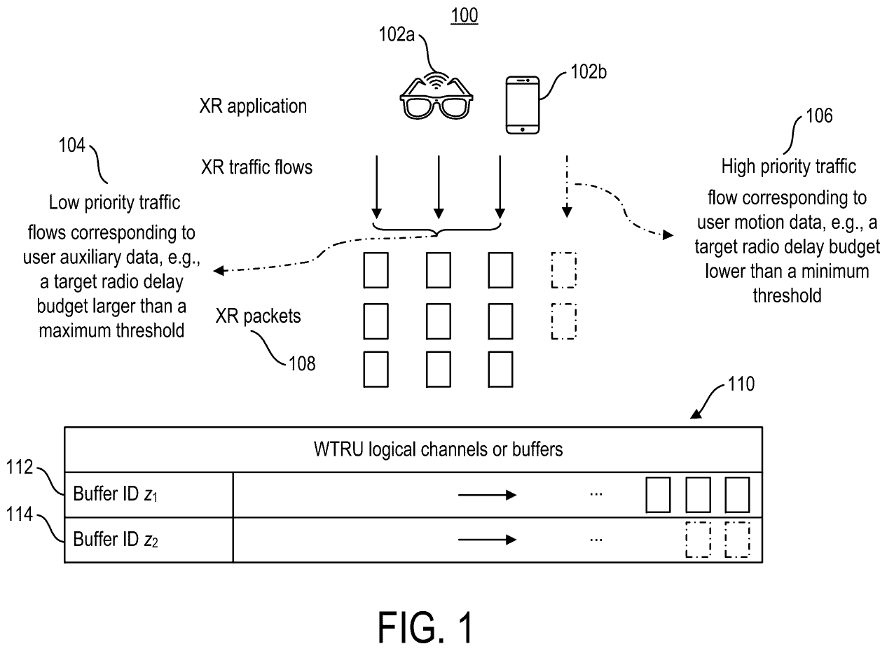

FIG. 1 illustrates WTRU device actions 100 for categorizing various XR traffic flows, storing the generated packets 108, and prioritizing logical channel buffers 110 to ensure efficient management of uplink traffic under congestion conditions. A WTRU 102a, 102b categorizes XR traffic flows generated by the application into low-priority traffic flows 104 and high-priority traffic flows 106. This classification is based on device-stored QoS profiles, where each profile defines threshold values for key QoS parameters such as latency, data rate, and reliability. For example, a flow is designated as low priority if its associated QoS targets exceed a predefined maximum threshold, such as a radio latency target larger than an upper limit. Such flows are deemed delay-tolerant and assigned to the low-priority category. Conversely, traffic flows requiring stringent latency targets, higher data rates, or greater reliability, i.e., those with QoS parameters below a defined minimum threshold, are categorized as high-priority flows. This classification allows the WTRU to dynamically adapt to the performance needs of different XR application components while maintaining overall system efficiency. Specifically of the WTRUs logical channels or buffers 110, Buffer ID Z₁ 112 may comprise low priority packets and Buffer ID Z₂ 114 may comprise high priority packets.

In another embodiment, WTRU determines the overall and per-flow target requirements of the active XR application by utilizing predefined application performance profiles stored in the device memory. Each performance profile is associated with a specific XR application type and includes key parameters such as target data rates, latency budgets, and acceptable jitter levels for each traffic flow generated by the application. The WTRU identifies the active XR application and its associated traffic flows by analyzing metadata and signaling information exchanged during session initialization. The WTRU retrieves the corresponding performance profile and derives the target requirements for both the aggregate application traffic and individual flows. These target requirements include, for example, minimum and maximum allowable data rates, latency thresholds, and codec performance metrics required to sustain both essential and enhanced XR functionalities.

In an additional embodiment, the ‘application target capacity’ is determined by the WTRU, based on retrieved QoS profile of the active XR application, and is defined as the aggregate data throughput required to sustain the continuous operation of both high-priority and low-priority traffic flows within an XR application. This metric is calculated by summing the individual bandwidth requirements of all active data streams generated by the application. For example, in a virtual reality application, such as Meta Quest Link, the target capacity is determined by the resolution and frame rate of the streamed content, the audio bitrate, and the additional control data required for head tracking and user input. For a 4K resolution at 90 frames per second (fps), the video stream alone may require up to 120 Mbps, while spatial audio contributes an additional 1 Mbps and head tracking/control data adds 0.5 Mbps, leading to an overall application target capacity of approximately 121.5 Mbps.

In an additional embodiment, the ‘target radio delay’ is determined by the WTRU, based on retrieved QoS profile of the active XR application, and is defined as the maximum allowable latency for data packets transmitted between the XR WTRU and the RAN node, ensuring the application maintains its real-time performance requirements. This parameter is calculated by analyzing the end-to-end latency budget allocated for the application and subtracting fixed delays, such as server processing times, rendering delays, expected propagation delays, RAN node processing delay, and expected scheduling delay (e.g., delay before an uplink resource is allocated from the time the data is available, which can be determined from received uplink congestion reports). For example, on condition of the total latency budget for maintaining accurate spatial alignment and real-time user interactions upper bounded by 50 ms. If server-side processing accounts for 20 ms and rendering/RAN node processing requires another 10 ms, the target radio delay is calculated as 20 ms.

In an additional embodiment, WTRU determines and calculates a ‘performance metric operational range’ for an active XR application by calculating the difference between the current performance metric setting and a predefined target setting. The target setting is derived from the application's operational requirements and stored QoS profile and can represent either the maximum or minimum permissible value for the specific performance metric, such as data rate or latency. To calculate the operational range, the WTRU retrieves the current data rate or latency setting being utilized by the application and compares it to the target value specified in the application's performance profile. The difference between these values defines the operational range, providing a clear indication of how much flexibility exists for adjusting the application's performance to respond to changing network conditions.

The WTRU stores all generated packets in one or more logical channel buffers, each associated with a specific traffic flow priority. For example, packets from high-priority traffic flows are directed to high-priority logical channels or buffers, while packets from low-priority traffic flows are assigned to low-priority buffers. This buffer organization ensures that the WTRU maintains a clear separation between different traffic categories, facilitating precise control over the handling of packets during transmission.

On condition of an uplink congestion occurrence, the WTRU orders all active logical channel IDs or buffers from the highest to the lowest priority. This ordering enables the WTRU to prioritize high-priority logical channel IDs, ensuring that packets from critical traffic flows are transmitted first. By contrast, packets from low-priority buffers may be deferred, compressed, or subjected to other delay-tolerant handling mechanisms to accommodate the limited uplink capacity.

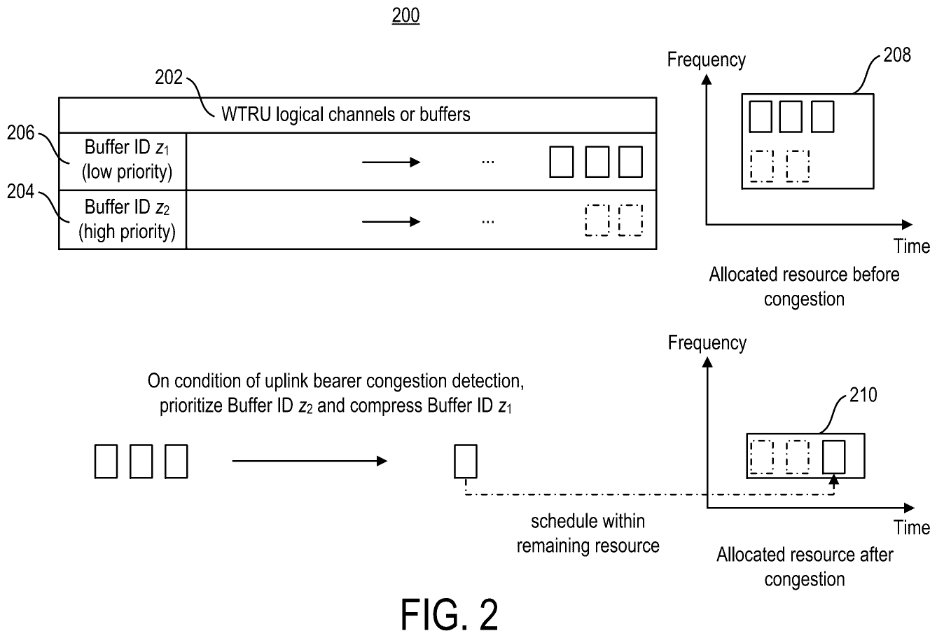

FIG. 2 illustrates the WTRU device action 200 for managing uplink traffic when an uplink congestion report indicates a degraded uplink Data Radio Bearer (DRB) capacity that does not fulfill the target requirements of all buffered logical channel IDs of the running XR application. Upon receiving an uplink congestion report from the Radio Access Network (RAN) node, the WTRU evaluates the reported DRB capacity and determines whether it satisfies the target QoS requirements of all logical channel buffers 202 currently holding data for transmission. If the report indicates degraded DRB capacity that cannot accommodate the aggregate target requirements of the buffered logical channels, the WTRU identifies the high-priority logical channels 204 or buffers based on their associated QoS profiles. These high-priority channels correspond to traffic flows with stringent latency, data rate, or reliability requirements. The WTRU then allocates the available DRB capacity to ensure that the high-priority channels 204 can be transmitted without significant degradation, thereby maintaining the performance of critical application components.

Further, for the lower-priority logical channels 206 or buffers, which correspond to delay-tolerant or less time-sensitive traffic flows, the WTRU executes a payload compression. This process reduces the payload size of the buffered data by applying a quantization algorithm such that compressed low priority payloads are adjusted to fit within the remaining DRB capacity, ensuring that the low-priority traffic flows are transmitted, albeit with reduced quality, rather than being dropped or excessively delayed.

In embodiments, before congestion, the WTRU may transmit high priority data along with low priority data, simultaneously on different frequencies 208. After detecting congestion, the WTRU may prioritize high priority data over low priority data and use only a single frequency or fewer frequencies to transmit 210. In this embodiment, data may be transmitted in a time division manner.

TABLE 3
Logical channel capacity reallocation request
Logical channel capacity reallocation request

| Logical channel IDs for | |
|---|---|
| compression | Buffer ID Z₁ |
| Compression information | (a) Compression algorithm |
| | indication |
| | (b) Compression block size |
| | (c) Quantization levels |

Table 3 illustrates a logical channel capacity reallocation request. A signaling procedure may comprise a WTRU triggering the transmission of the Logical channel capacity reallocation request in response to a received uplink congestion report that fails to fulfil predefined target QoS requirements of both the buffered active low and high priority logical channels. This signaling ensures that the uplink data is transmitted effectively under constrained conditions while maintaining compatibility with the RAN node's decoding capabilities.

On condition of the WTRU determining that the its active DRB capacity is insufficient to meet the target requirements of all active logical channel buffers, it first categorizes the logical channels into high- and low-priority buffers, based on their QoS profiles. High-priority logical channels are transmitted as generated, preserving the original data quality to meet the stringent latency and performance requirements. For lower-priority logical channels, the WTRU applies a lossy compression algorithm to reduce the payload size. This compression involves adjusting parameters such as compression block size and quantization levels, which results in a trade-off between data quality and the ability to fit the reduced traffic within the remaining DRB capacity.

The WTRU triggers the transmission of a logical channel capacity reallocation request. The request signaling specifies the logical channel IDs of the high-priority traffic flows, which are transmitted without modification, as well as the logical channel IDs of the low-priority traffic flows that have been compressed. Additionally, the request includes the compression parameters adopted by the WTRU. These parameters may include an indication of the lossy compression algorithm used, the compression block size or an identifier indicating the block size, and quantization level information or quantization level indications. By providing these details, the WTRU ensures that the RAN node is aware of the alterations made to the uplink traffic, enabling the RAN node to correctly decode the compressed data streams.

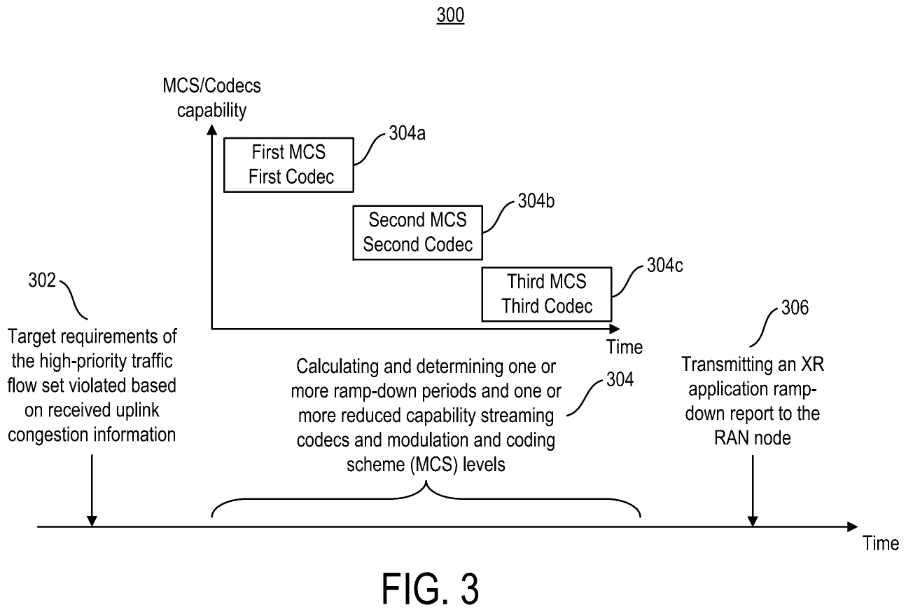

FIG. 3 illustrates the WTRU device action 300 for adapting its XR application behavior when uplink congestion information received from the RAN indicates that the active DRBs cannot satisfy the target requirements of all logical channel buffers, including high-priority ones. This adaptation involves calculating and implementing a ramp-down timeline to ensure a gradual reduction in application performance, preserving a balance between operational capability and end-user experience.

Upon receiving the uplink congestion information 302, the WTRU determines that the current XR application's performance targets cannot be met within the available DRB capacity, the WTRU calculates a ramp-down timeline 304, which may consist or comprise multiple ramp-down periods. During the first ramp-down period 304a, the WTRU transitions to a reduced performance level by employing a first set of reduced capability parameters, including a first modulation and coding scheme (MCS) and first streaming codecs. This adjustment reduces the application's demand on the uplink while maintaining operational continuity.

On condition of determining the available DRB capacity insufficient to meet the requirements of the reduced XR application behavior, the WTRU continues the ramp-down process. During a second ramp-down period 304b, the WTRU adopts further reduced capability parameters, such as a second MCS level and a second set of streaming codecs. This iterative process continues, with each subsequent ramp-down period introducing progressively reduced application performance parameters, until the WTRU identifies a combination of MCS level and streaming codecs that align with the available DRB capacity. In the example, during a third ramp down period 304c, the WTRU adopts further reduced capability parameters such as a third MCS level and a third set of streaming codecs.

By implementing a gradual ramp-down strategy, it ensures that the XR application operates within the constraints of the available DRB capacity, avoiding performance degradation that would otherwise occur if the application attempted to maintain optimal performance under insufficient uplink resources. Second, the gradual nature of the ramp-down minimizes the perception of quality degradation for the XR end-user, preventing a sudden, noticeable drop in application performance and thus maintaining a more seamless user experience.

As the WTRU transitions through each ramp-down period, it generates and transmits an XR application ramp-down report 306 to the RAN node. This report specifies the ramp-down timeline, including the duration of each ramp-down period, the adjusted MCS levels, and the selected streaming codecs. This communication ensures that the RAN node remains synchronized with the WTRU's application behavior, enabling efficient resource allocation and system coordination.

TABLE 4
XR application ramp-down/ramp-up report
XR application ramp-down/ramp-up report

| | |
|---|---|
| Ramp up/down period 1: start | (MCS1 index, Codec1 index) |
| slot indication, end slot indication | |
| Ramp up/down period 2: start | (MCS2 index, Codec2 index) |
| slot indication, end slot indication | |
| . | . |
| . | . |
| . | . |

Table 4 is an example XR application ramp-down/ramp-up report. A signaling procedure may be performed wherein the WTRU (e.g. a phone, tablet, AR headset, etc.) transmits a ramp-down report to the RAN node upon calculating and finalizing a ramp-down timeline. This timeline, developed in response to uplink congestion conditions, consists or is comprised of one or more ramp-down periods, each characterized by a specific duration and associated reduced capability parameters, such as modulation and coding scheme (MCS) levels and streaming codec configurations.

When the WTRU identifies that the current DRB capacity is insufficient to meet the target requirements of all active logical channel buffers, including high-priority ones, it calculates a detailed ramp-down timeline. The WTRU divides this timeline into discrete ramp-down periods, with each period defined by a starting slot and an ending slot. Within each ramp-down period, the WTRU transitions to progressively reduced capability configurations. For example, during the first ramp-down period, the WTRU may use a first reduced MCS level and a first set of streaming codecs. In subsequent periods, these parameters are further downgraded to ensure compatibility with the available DRB capacity.

Similarly to the ramp-down reporting, WTRU may calculate, compile and transmit a ramp-up report to the RAN node upon determining that uplink conditions have improved sufficiently to support enhanced XR application performance. This signaling is initiated when the WTRU receives updated uplink congestion information from the RAN node indicating that the available DRB capacity satisfies or exceeds the target requirements for active logical channel buffers, including high-priority ones.

The WTRU calculates a ramp-up timeline to gradually transition the XR application from its current reduced-capability behavior to an enhanced operational state. This ramp-up timeline is divided into one or more ramp-up periods, each defined by a specific starting slot and ending slot. Each period corresponds to progressively upgraded capability parameters, such as modulation and coding scheme (MCS) levels and streaming codec configurations. For example, during the first ramp-up period, the WTRU may transition to a slightly higher MCS level and an improved codec configuration. Subsequent periods further increase these parameters, optimizing application performance while ensuring network stability.

The ramp-up report enables effective synchronization between the WTRU and the RAN node, facilitating a coordinated approach to network resource management. By providing a detailed and phased ramp-up timeline, the WTRU ensures that the XR application transitions to optimal performance without abrupt changes that could destabilize the network or negatively impact other users.

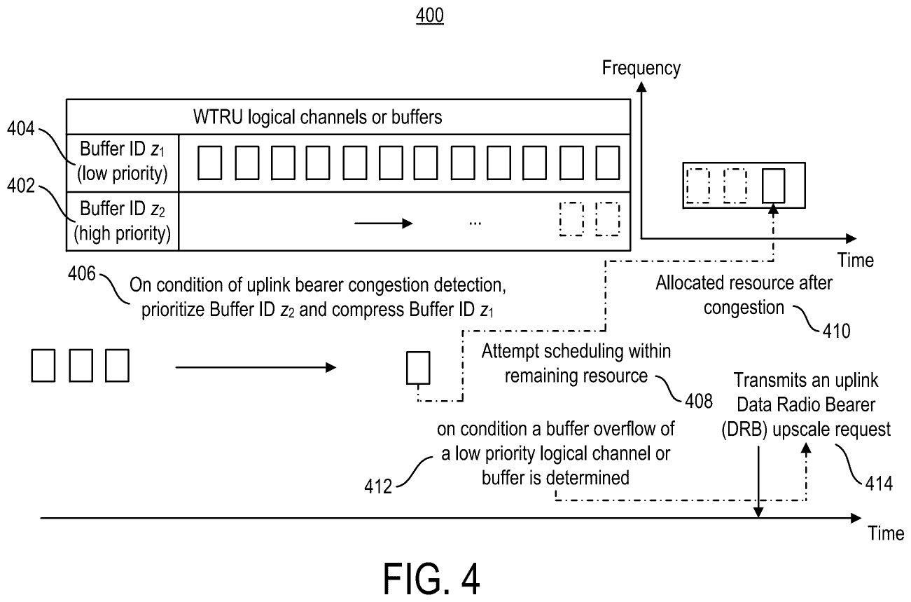

FIG. 4 depicts the case 400 wherein the WTRU receives uplink congestion information 406 from the serving RAN node indicating that the current active DRB capacity is insufficient to meet the target requirements of all buffered logical channels 402, 404, including high-priority buffers 402. Upon receiving such information 406, the WTRU prioritizes the transmission of data from high-priority logical channels, allocating the available DRB capacity accordingly. For lower-priority logical channels, the WTRU applies compression techniques and rate reduction to reduce their traffic volume, attempting to fit the data transmission within the remaining DRB capacity.

Specifically, the WTRU attempts low-priority 404 buffer scheduling with a remaining resource 408 using an allocated resource 410 after compression.

On condition of the WTRU determining that the compression and rate reduction applied to low-priority buffers result in a significant disparity between the inflow rate (i.e., new packets being added) and the outflow rate (i.e., compressed packets being transmitted), this leads to a buffer overflow 412. Such overflow 412 indicates that the available DRB capacity is inadequate even with compression, and packets in the low-priority logical channel buffers are being dropped. This scenario is particularly relevant for XR application classes that generate a high volume of low-priority traffic flows, which cannot be sustained with the current uplink resources.

In response to detecting a positive buffer overflow 412, the WTRU triggers the transmission of an uplink DRB upscale request 414 to the serving RAN node. This request signals the need to prioritize and upscale the DRB capacity to ensure sustainable uplink performance.

TABLE 5
Uplink Data Radio Bearer (DRB) upscale request
Uplink Data Radio Bearer (DRB) upscale request

One bit indication of DRB switching (1)
(Buffer ID Z₁, Buffer size (bytes) or size indication), . . .

Table 5 illustrates an example Uplink Data Radio Bearer (DRB) upscale request. In the case wherein the WTRU detects positive buffer overflow of one or more low priority logical channels, the WTRU transmits an uplink Data Radio Bearer (DRB) upscale request to a Radio Access Network (RAN) node. The DRB upscale request includes a single-bit request indication, signaling the need to upscale the current DRB to a higher-priority DRB. Additionally, the WTRU transmits a buffer status report (BSR) alongside the upscale request, which specifies the buffered data volume of the active low-priority logical channels expected to exceed their current buffer capacity.

By providing the RAN node with the exact volume of buffered traffic for the identified low-priority logical channels, the WTRU enables the RAN node to make an informed decision about the required DRB capacity. Specifically, the RAN node uses the buffered data size information to determine whether the next higher-priority DRB can accommodate the overflowed traffic or whether an even higher-priority DRB with greater capacity is necessary to meet the requirements. This approach ensures efficient utilization of network resources while addressing congestion conditions and maintaining application performance for the XR session.

On receiving an indication from the RAN node of an approved Data Radio Bearer (DRB) upscale request, the WTRU transitions its operation to utilize the higher-priority DRB. The indication from the RAN node includes details of the DRB switching period, specifying the time duration during which the higher-priority DRB is allocated for the WTRU's use.

During the DRB switching period, the WTRU reconfigures its uplink transmission to redirect the deferred traffic flows, previously buffered or compressed, to the newly assigned higher-priority DRB. This ensures that the WTRU takes full advantage of the increased capacity and lower latency characteristics of the higher-priority DRB, effectively alleviating the congestion conditions impacting the deferred traffic flows. The transition process is executed seamlessly to minimize disruptions to the ongoing XR application session, preserving the user experience while maintaining the required quality of service (QoS) for critical and auxiliary traffic flows.

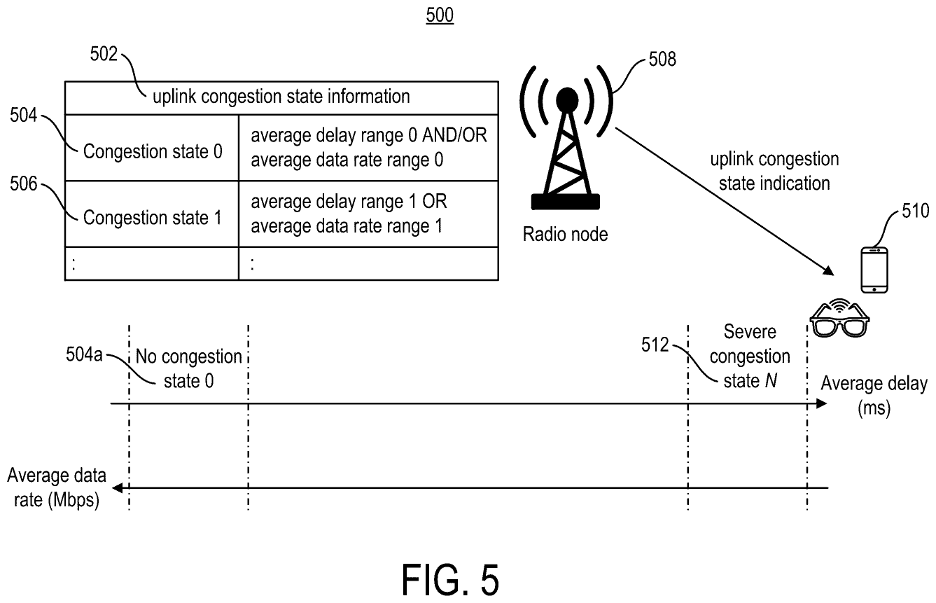

FIG. 5 depicts the RAN node action 500 of quantizing various uplink performance metrics into simplified congestion states 502 to enhance signaling efficiency. The RAN node continuously monitors uplink performance metrics, such as average uplink delay, data rate, and utilization levels for each Data Radio Bearer (DRB). Based on predefined threshold ranges, the RAN node maps these metrics to corresponding congestion states 502 including congestion state 0 and congestion state 1. For instance, a range indicating low uplink delay and high data rate may be classified as a “no congestion” or “low congestion” state 504a, while metrics reflecting increased delay or reduced data rates may correspond to “moderate congestion” or “severe congestion” states, including severe congestion state n 512.

The RAN node 508 includes these quantized congestion states 502 in the uplink congestion information reports transmitted to Wireless Transmit/Receive Units (WTRUs) 510. By signaling only the state indications rather than detailed performance metrics, the RAN node significantly reduces the signaling overhead associated with congestion reporting. This reduction in overhead allows the network to allocate more resources to critical data transmissions while maintaining effective communication of congestion conditions to the WTRUs.

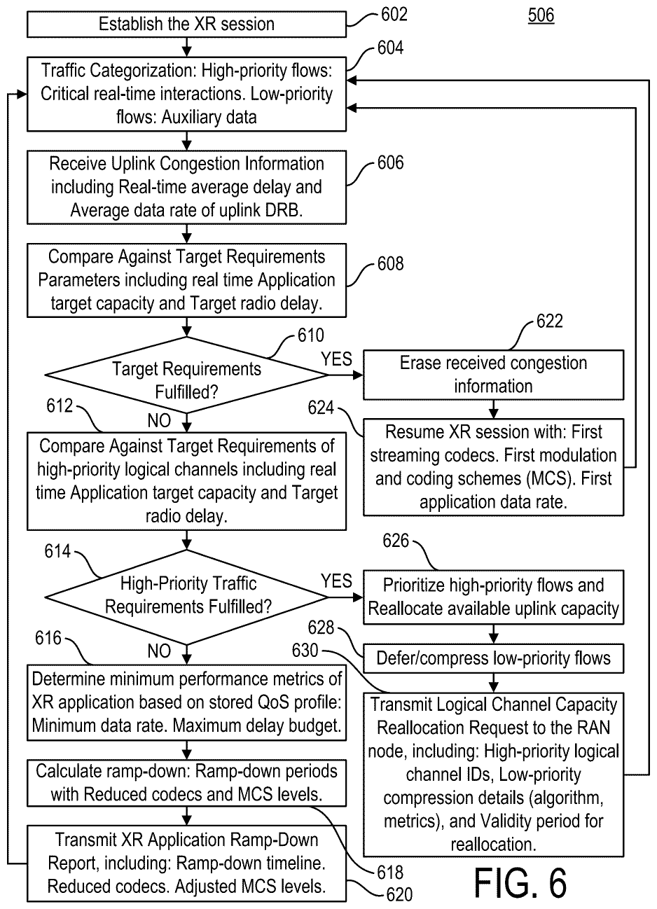

FIG. 6 depicts a timeline of actions 600 executed by a Wireless Transmit/Receive Unit (WTRU) in response to dynamic network conditions. Initially, the WTRU establishes an XR session 602 and categorizes 604 the traffic flows of the upper XR application into high-priority and low-priority flows based on latency and capacity requirements. As the XR session progresses, the WTRU receives 606 uplink congestion information from a Radio Access Network (RAN) node, including metrics such as average delay and data rate. Upon analyzing 608 the congestion information, the WTRU determines whether the current uplink Data Radio Bearer (DRB) can fulfill 610 the application's target performance requirements.

The WTRU compares target requirements 612 and determines fulfillment 614. If the received congestion information indicates a violation of target requirements, the WTRU prioritizes actions to ensure service continuity. For high-priority traffic flows, the WTRU reallocates available DRB capacity to these flows, deferring or compressing low-priority flows as needed. The WTRU determines minimum performance metrics of the XR Application based on stored QoS profile 616: minimum data rate+maximum delay budget. Concurrently, it transmits a logical channel reallocation request to the RAN node, specifying prioritized logical channels, compression metrics, and validity periods. If the congestion persists and affects high-priority traffic flows, the WTRU calculates a ramp-down period 618 with reduced streaming codecs and modulation and coding schemes (MCS), generating a ramp-down report 620 detailing the adjustments and transmitting it to the RAN node.

During an active ramp-down period, the WTRU monitors for subsequent congestion updates from the RAN node. Upon receiving updated congestion information indicating improved uplink conditions, the WTRU halts the ramp-down process and initiates a ramp-up sequence. This involves determining maximum achievable application performance metrics and calculating upgraded codecs and MCS levels to enhance the XR session's quality. The WTRU then transmits a ramp-up report to the RAN node, detailing the transition timeline and enhanced configurations.

The WTRU also responds dynamically to buffer overflow events for low-priority logical channels. Upon detecting such an event, it transmits a DRB upscale request, including a single-bit indication for DRB upscaling and a buffer status report specifying the buffered traffic volume. If the RAN node approves the upscale request, the WTRU transitions deferred traffic flows to the higher-priority DRB during the specified switching period, ensuring efficient use of the upgraded resources.

Throughout this process, the WTRU continuously classifies and re-prioritizes logical channels, adjusts application parameters, and collaborates with the RAN node to maintain optimal performance across all traffic flows. These coordinated actions create a dynamic timeline of adaptations, ensuring the seamless operation of the XR session under varying network conditions.

If the WTRU determines 610 that target requirements are fulfilled it may clear its congestion information 622 and resume 624 an XR session with high order MCS and codec.

In cases where high priority traffic requirements are fulfilled 614, but the target requirements 610 are not fulfilled, the WTRU may prioritize high priority flows 626, defer/compress low priority flows 628 and transmit a reallocation request to the RAN 630.

An Extended Reality (XR) Wireless Transmit/Receive Unit (WTRU), comprising a processor, transmitter and receiver, that performs a method of: establishing an XR session and categorizing traffic flows of the upper XR application into high-priority traffic flows, corresponding to critical real-time interactions, and low-priority traffic flows, corresponding to auxiliary data; receiving uplink congestion information from a Radio Access Network (RAN) node, wherein the congestion information includes real-time average delay and average data rate of an uplink data radio bearer (DRB) carrying the uplink traffic; determining whether the received congestion information satisfies the target requirements of the aggregate XR application traffic including application target capacity, and target radio delay; on condition the target XR application requirements fulfilled based on received uplink congestion information: erasing the received congestion information and resuming the XR session with current application parameters, including a first streaming codecs, first modulation and coding schemes (MCS), and first application data rate; on condition of the target XR application requirements violated based on received uplink congestion information: determining whether the available uplink DRB capacity and average delay of the received uplink congestion information is sufficient to fulfill the requirements of the high-priority traffic flow set; re-allocating uplink capacity to prioritize transmission of the high-priority traffic flows, and deferring and/or compressing the low-priority traffic flows within the remaining capacity; and transmitting a logical channel capacity reallocation request to the RAN node, the request specifying prioritized logical channel IDs of high priority traffic flows, logical channel IDs of low priority traffic flow for data compression, the compression algorithm indication, data compression metrics including compression block size and quantization levels, and a validity period for the reallocation; on condition of the target requirements of the high-priority traffic flow set violated based on received uplink congestion information: determining minimum acceptable application performance metrics, including minimum data rate and maximum delay budget, and calculating and determining one or more ramp-down periods and one or more reduced capability streaming codecs and modulation and coding scheme (MCS) levels starting from the current first active codecs and MCS to second streaming codecs and MCS level that fulfil the determined minimum acceptable application performance metrics, and transmitting an XR application ramp-down report to the RAN node, the report including the ramp-down timeline of one or more XR application ramp down periods, reduced streaming codecs, and adjusted MCS level indications; on condition of receiving a second uplink congestion information from a Radio Access Network (RAN) node, wherein the congestion information satisfies the target requirements of the XR application during an active XR WTRU ramp down period: preemptively stopping and erasing the current XR application ramp down timeline, and determining maximum application performance metrics, including a maximum data rate and a minimum delay budget, and calculating and determining one or more ramp-up periods and one or more upgraded capability streaming codecs and modulation and coding scheme (MCS) levels starting from the current first active codecs and MCS to second streaming codecs and MCS level that fulfil the determined maximum best application performance metrics, and transmitting an XR application ramp-up report to the RAN node, the report including the ramp-up timeline of one or more XR application ramp up periods, upgraded streaming codecs, and adjusted MCS level indications.

The received uplink congestion information further includes an indication of the current uplink DRB utilization percentage and a binary flag indicating whether uplink DRB switching to a higher-priority bearer is pending.

The WTRU classifies generated application traffic flows into high-priority and low-priority traffic flow sets by comparing their target latency and capacity requirements of each against predefined threshold values.

The WTRU determines the target requirements for high-priority and low-priority traffic streams generated by the XR application based on predefined performance profiles stored in the device memory, wherein each performance profile is associated with a specific XR service type and defines both minimum and maximum application performance bounds of various traffic flows.

The determined performance bounds include, for each XR service profile, a minimum target performance comprising a minimum application capacity, a maximum allowable delay budget, and a minimum codec performance threshold required to sustain essential XR functionality, and a maximum target performance comprising a maximum application capacity, a minimum achievable delay budget, and an optimal codec performance threshold to provide enhanced user experience.

For each traffic flow, a separate QoS Class Identifier (QCI) is determined based on the flow type and/or application type, with higher QCIs assigned to latency-critical traffic flows and lower QCIs assigned to less time-sensitive traffic flows.

The WTRU orders the active XR logical channel IDs from the highest-priority to lowest-priority channels, which correspond to the buffered channels of the QCIs of the lowest target delay budget to channels of the target QCIs of the highest target delay budget.

The WTRU determines and re-allocates a first set of logical channel IDs, corresponding to higher-priority traffic flows with QCIs of the lowest target delay budget, to fit within the available DRB capacity, and deferring or compressing a second determined set of buffered logical channel IDs associated with QCIs of the highest target delay budget.

The WTRU receives, from a Radio Access Network (RAN) node, a congestion information report comprising a congestion state indication for one or more uplink data radio bearers (DRBs), and wherein the WTRU determines uplink per-DRB congestion metrics associated with the present congestion state indication by mapping the received binary congestion state to corresponding thresholds for delay, data rate, or a combination thereof.

The WTRU stores predefined congestion metric thresholds in device memory and, upon receiving a congestion state indication, retrieves the thresholds associated with the indicated congestion state to estimate the average uplink delay and data rate for the affected DRBs.

The WTRU detects a data radio bearer (DRB) switching indication transmitted by a Radio Access Network (RAN) nod, and resumes XR application over the updated higher-priority DRB.

The WTRU monitors the validity period of the DRB switching, and upon expiry of the predefined switching period, WTRU reverts the uplink traffic flow associated with the XR application from the higher-priority DRB back to the first assigned DRB, while adapting its application parameters, including streaming codecs and data rates, to align with the characteristics of the original first DRB.

The WTRU, before deferring and/or compressing the low-priority traffic flows, determines a buffer overflow event for logical channels or buffers associated with the deferred traffic flows by calculating packet generation rates of those low priority traffic flows in comparison with the buffer outflow rates.

On condition that a buffer overflow is determined, WTRU transmits an uplink Data Radio Bearer (DRB) upscale request to the Radio Access Network (RAN) node, wherein the request includes an indication of the need to assign a higher-priority DRB to accommodate the deferred traffic flows and a partial buffer status report (BSR) specifying only the buffered payload size of the deferred logical channel IDs.

The WTRU receives, from the RAN node, an indication of an approved DRB upscale request and a DRB switching period for the higher-priority DRB allocation and transitions the transmission of the deferred traffic flows to the higher-priority DRB during the indicated DRB switching period.

A Radio Access Network (RAN) node, comprising: tracking, filtering, and calculating real-time aggregate uplink congestion information, including average uplink packet delay, and/or average uplink packet data rate and/or per-DRB utilization or load percentage, for each active uplink DRB across active uplink devices; on condition of determining a change rate or change percentile of the determined per-DRB uplink performance metrics beyond a predefined threshold: compiling and transmitting real-time uplink congestion information reports per-DRB to active devices over downlink control channels; on condition of determining that performance targets for one or more active uplink traffic flows of an eligible device violated: temporarily switching determined uplink traffic flows to a higher-priority uplink data radio bearer that meets target performance metrics; and scheduling the switched uplink traffic flows according to the updated DRB.

The downlink control channel carrying the determined uplink congestion reports is a device-common physical downlink control channel (PDCCH), scrambled by a congestion-specific device-group scrambling code.

The RAN node determines and prioritizes a subset of uplink traffic flows, selected from the set of determined uplink flows, for switching to a higher-priority Data Radio Bearer (DRB) associated with QoS Class Identifiers (QCIs) that specify the lowest packet delay budgets (PDBs) and/or the highest guaranteed bit rates (GBRs).

The RAN node selects a higher-priority Data Radio Bearer (DRB), for a specific uplink traffic flow affected by determined congestion information, by determining the next higher-priority one or more DRBs relative to the currently assigned DRB of the impacted uplink flow.

The RAN node evaluates candidate DRBs from a pool of preconfigured DRBs based on fulfilment of the latency and data rate requirements of the determined uplink flow, as determined by the most recent coverage and/or quality measurement report received, via a receiver of the RAN node, from the impacted XR WTRU.

The real-time uplink congestion information reports include per-DRB binary indicators of congestion states, wherein the RAN node quantizes the determined per-DRB congestion metrics into a congestion state indication.

The RAN node transmits determined congestion state indicators to active XR WTRUs via device-specific or common downlink control channels.

Upon detecting that an uplink traffic flow associated with an active XR WTRU fails to meet its performance targets, the RAN node triggers a temporary data radio bearer (DRB) switching operation, assigning the determined uplink flow to a higher-priority DRB that satisfies the flow's latency and data rate requirements wherein, the DRB switching remains valid for a predefined time period, during which the higher-priority DRB resources are allocated to the impacted uplink flow.

A Radio Access Network (RAN) node, comprising: circuitry configured to track, filter and calculate aggregate uplink congestion information, including average uplink packet delay, and/or average uplink packet data rate and/or per-DRB utilization or load percentage, for each active uplink DRB across active uplink devices; circuitry configured to, on a condition a change rate or change percentile of the determined per-DRB uplink performance metrics is determined to be beyond a predefined threshold: compile and transmit real-time uplink congestion information reports per-DRB to active devices over downlink control channels; circuitry configured to, on a condition of determining that performance targets for one or more active uplink traffic flows of an eligible device violated: temporarily switch determined uplink traffic flows to a higher-priority uplink data radio bearer that meets target performance metrics; and schedule the switched uplink traffic flows according to the updated DRB.

Extended Reality (XR) applications, encompassing virtual reality (VR), augmented reality (AR), and mixed reality (MR), demand ultra-reliable, low-latency communication (URLLC) to maintain immersive user experiences. These applications rely on real-time bidirectional data flows, where even minor delays in uplink (UL) or downlink (DL) transmissions can disrupt synchronization between physical interactions and digital rendering, leading to motion sickness, visual artifacts, or degraded haptic feedback. For instance, in collaborative XR environments, delayed uplink reporting of user movements or sensor data prevents timely server-side rendering updates, while downlink delays in streaming high-fidelity 3D content degrade perceptual continuity.

A critical challenge lies in managing multiple concurrent traffic streams associated with XR services, such as video feeds, pose tracking data, audio channels, and haptic feedback, each with distinct quality-of-service (QoS) requirements and dynamic buffer occupancy patterns. Traditional buffer management systems, which rely on static thresholds or periodic reporting, fail to address the variable buffering delays and potential buffer overflows inherent to XR traffic. For example, abrupt changes in scene complexity or user motion may cause unpredictable packet inflow bursts, rapidly depleting buffer delay or capacity budgets. Without dynamic, per-logical-channel monitoring and prioritized reporting, networks cannot allocate resources efficiently, leading to either excessive scheduling grants (wasting bandwidth) or buffer underflows/overflows (increasing latency jitter).

Related art includes U.S. Pat. No. 8,625,415 to Sebire et al., US Pat Pub no. 20230232277 to Yi et al., US Pat Pub no. 20240381167 to Kuo et al., US Pat Pub no. 20240205915 to Esswie et al., R2-2307830 titled “Buffer Delay Reporting and BSR Enhancements for XR,” and R2-2307902 titled “Discussion on delay status reporting for XR.” Each one of these related art references is incorporated herein by reference in its entirety.

Also disclosed herein by reference in its entirety is IEEE 802.11-21/1577r2 titled “CR for Low-Latency BSR” to Baron et al. Embodiments, fields and information elements disclosed herein may be employed in WLAN environments, in particular 802.11 environments when employed with or without buffer status reporting measured. Embodiments disclosed herein allow an 802.11 station to indicate the timing/delay constraint related to the pending traffic. This information is for a STA to inform its AP about its real and instant needs for sending low latency and fluctuating traffic.

In one exemplary embodiment, an XR wireless transmit/receive unit initiates communication with the network by signaling its capability to perform dynamic buffer delay compilation and reporting. This signaling may occur during initial network attachment through a dedicated field in a setup message or by mapping a capability indicator into uplink control information. Once the network acknowledges this capability, it sends back specific configurations that include one or more delay thresholds and constraints on the maximum number of buffer delay reports that may be sent within a given uplink control channel occasion. The received configuration parameters controls device actions for how the device will monitor and manage its buffer delays throughout its operation.

In another exemplary embodiment, the device actively monitors each logical channel by timestamping the buffered packets as they enter the buffer. For each channel, it calculates the shortest remaining delay before the delay budget is exceeded by comparing the elapsed buffering time against a predefined target delay, which is determined by the application's requirements and may be dynamically adjusted based on rendering latency or network feedback. The device compiles a detailed report for each logical channel that has crossed one or more delay thresholds, including an indication of the threshold triggered, the channel identifier, the current buffer size, and the explicitly computed shortest remaining delay. This monitoring and reporting process ensures that the network receives accurate and timely updates on the status of buffered data.

In another embodiment, the device incorporates a capacity evaluation step where it determines the current transmission capability of the uplink control channel. By assessing parameters such as signal quality, channel conditions, and the modulation and coding scheme provided by the network, the unit computes the available payload size and determines the number of delay reports that may be accommodated during the current control channel occasion. This calculation may prevent the overloading of the control channel and ensures that the number of transmitted reports does not exceed both the network-imposed limits and the physical capacity available at the moment.

When the number of eligible buffer delay reports exceeds the calculated transmission capacity, the device prioritizes the reporting of channels that are at the highest risk of buffer overflow or delay outage. This is achieved by comparing the packet inflow and outflow rates over a specific interval to predict potential overflow events. High-priority channels are reported individually to provide detailed information, while lower-priority channels are aggregated into a combined report. The combined report is generated by computing a weighted average of the shortest remaining delays, where the weights correspond to the buffer sizes of the individual channels. This dual approach of individualized reporting for critical channels and aggregated reporting for less critical ones allows the device to efficiently manage and transmit delay information within the constraints of the current uplink control channel capacity.

In an additional embodiment, the device may trigger the reporting process either periodically or conditionally. Periodic reporting is initiated by the expiration of a timer configured by the network, ensuring that regular updates are provided, while conditional reporting is triggered when the computed shortest remaining delay of any channel falls below a set threshold, providing an early warning of potential service degradation. Moreover, the capability indication itself may be encoded as a single-bit flag, offering a simple yet effective method for the device to communicate its support for these advanced delay management features. Auxiliary parameters, such as the maximum number of logical channels supported for monitoring and the desired granularity for delay measurements, may also be transmitted during initial setup to further refine the delay reporting process and ensure that the solution adapts dynamically to varying network conditions and application requirements.

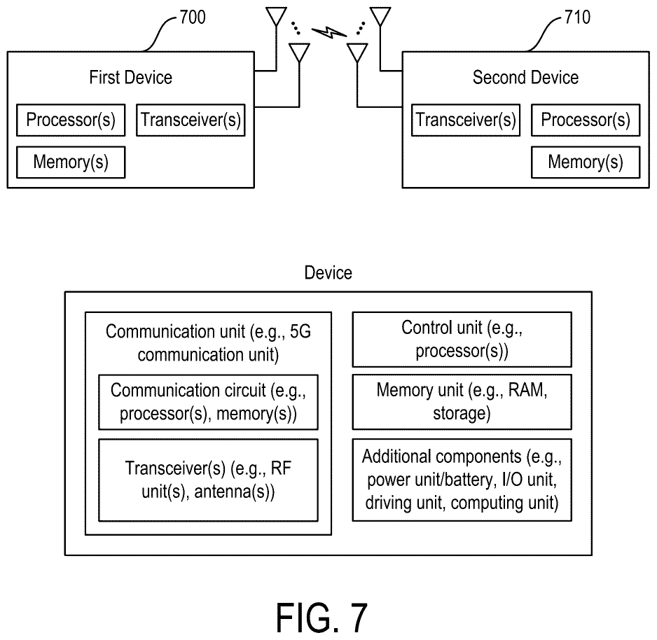

FIG. 7 illustrates two devices 700, 710 in communication with one another. A first device may have circuitry comprising a processor, transceiver (transmitter/receiver) and memory. The second device may also have circuitry comprising a processor, transceiver (transmitter/receiver) and memory. The first device may be a station and the second device may be an access point. In embodiments, both devices may be stations or both devices may be access points. Each device may have a communication unit, communication circuitry, transceivers, a control unit, memory unit and additional auxiliary components.

Extended reality (XR) services demand ultra-low latency and precise synchronization to deliver immersive experiences, yet the uplink delay handling remains a critical challenge. The network's radio access node typically operates without direct insight into the buffering and delay performance within XR devices. This lack of visibility implies that even if the network optimizes its scheduling and resource allocation based on standard channel quality indicators, it remains unaware of the actual delay conditions experienced by the device. Consequently, when an XR device accumulates buffered data, any delay in reporting its status may lead to suboptimal handling of data transmission and, ultimately, a degraded user experience.

Furthermore, the problem is exacerbated by the fact that the dynamic and often unpredictable nature of XR data flows is not fully captured by traditional network metrics. The radio access network may assume that conditions are favorable based on its measurements, yet the device's internal buffers could be approaching critical delay thresholds without the network's knowledge. This disconnect between the device's internal state and the network's perception results in potential risks of buffer overflow or delay outages, which may interrupt the seamless delivery of XR content.

Moreover, the challenge of reporting buffer delay information in the context of XR services is compounded by the inherent limitations of the uplink control channel. In these systems, the available control channel resources are finite, meaning that any additional data transmitted may be carefully managed to avoid congestion and potential degradation of overall system performance. This limitation makes it insufficient to simply send straightforward delay reports, as the network may become overwhelmed by the volume of control information, thereby compromising the timely delivery of critical updates.

Given these constraints, XR devices are compelled to exhibit highly adaptive behavior when compiling and transmitting buffer delay information. The devices may intelligently assess the current state of the control channel and determine the optimal number of delay reports that may be sent without exceeding capacity. This involves not only calculating precise metrics such as the shortest remaining delay for each logical channel but also prioritizing which reports are most critical. The adaptive approach ensures that the most urgent data, such as channels nearing buffer overflow or experiencing delay outages, is reported immediately, while less critical information is aggregated or reported at a coarser granularity.

TABLE 6
Capability information object
Capability information object

Binary capability indication of dynamic buffer delay reporting {1}
Maximum supported number of logical channels for simultaneous
delay monitoring
Granularity level for delay reporting in terms of a time unit (e.g., 1 ms,
5 ms);
Preferred periodicity information for buffer delay reporting occasions

Table 6 illustrates a capability information object that may be signaled between an XR WTRU and a network node such as a base station (e.g. a gNB, 802.11AP, etc.). An XR wireless transmit/receive unit (e.g. a phone or other device) may initiate a process by transmitting capability information to the serving radio access network, signaling its support for on-device dynamic buffer delay compilation and reporting. This transmission is fundamental in establishing a communication baseline whereby the device informs the network of its advanced delay management features. By conveying its capability, the device lays the groundwork for a tailored interaction with the network, ensuring that subsequent control messages and configurations are aligned with its sophisticated internal processing abilities.

The capability information is embedded within dedicated fields of signaling messages or mapped to predefined bit positions within the uplink control information, depending on the state of the connection. This method of transmission allows the network to quickly and reliably ascertain that the device is equipped to monitor and compile its own buffer delay metrics dynamically. Such early indication is beneficial as it enables the network to later dispatch optimized configuration parameters that leverage the device's ability to perform detailed delay analysis and reporting, thereby enhancing the overall efficiency of data transmission and resource allocation.

Specifically, during initial network attachment, an XR device embeds a binary capability indicator into a dedicated field of an RRCSetupRequest message. This signaling mechanism informs the network that the device supports on-device dynamic buffer delay compilation and reporting. In scenarios where the device is already in an RRC connected state, the same binary indicator may be transmitted within a UEAssistanceInformation message, ensuring that the network remains aware of the device's advanced buffer management capabilities. By integrating this capability information early in the communication process, the device enables the network to tailor subsequent configuration messages and optimize resource allocation based on its inherent delay reporting functionality.

Alternatively, the device may signal its capability by mapping the binary indicator to a predefined bit position in the uplink control information. This uplink control information, which is transmitted via a physical uplink control channel or a physical uplink shared channel, is already configured to carry critical control data. By embedding the capability indication directly within this channel, the device effectively leverages existing signaling structures to provide device-specific capability signaling without introducing additional overhead. This approach streamlines the communication process, ensuring that the network receives timely and accurate information about the device's support for dynamic buffer delay reporting, thereby enabling more efficient scheduling and control decisions.

Further, the dedicated fields in the signaling message is enhanced to include additional auxiliary parameters that detail the XR device's buffer management capabilities. Beyond merely indicating support for dynamic buffer delay reporting, the message carries additional data that informs the network about the device's operational limits and preferences. This information encompasses critical parameters such as the maximum number of logical channels that the device may monitor concurrently, ensuring that the network is aware of the device's capacity for handling simultaneous delay measurements.

Another auxiliary parameter conveyed is the granularity level for delay reporting. By specifying a time unit, such as one millisecond or five milliseconds, the device communicates the precision with which it may measure and report buffer delays. This granularity setting is to optimize the timing of delay reports, as it allows the network to understand the resolution of the reported information and adjust its scheduling and resource management strategies accordingly. The precision of delay measurement becomes increasingly important in the context of XR services, where even minor delays may significantly impact the quality of the user experience.

Additionally, the message may include information about the preferred periodicity for buffer delay reporting occasions. This preferred periodicity informs the network of the optimal intervals at which the device wishes to send its delay reports, facilitating a more efficient and adaptive control channel scheduling process. With this periodicity parameter, the network may better align the transmission of control information with the device's reporting needs, ensuring that delay data is communicated in a timely manner without overburdening the available control channel resources.

Collectively, these auxiliary parameters provide a richer, more detailed picture of the device's buffer management capabilities. This enhanced signaling allows the network to tailor its resource allocation and control strategies to the specific operational characteristics of the XR device. By understanding not only that the device supports dynamic buffer delay reporting but also the extent and precision of that support, the network may more effectively manage its scheduling and optimize the overall performance of delay-sensitive XR services.

TABLE 7
Buffer delay reporting configurations (RRC signaling)
Buffer delay reporting configurations (RRC signaling)

One or more delay thresholds to trigger buffer delay reporting
Maximum allowable number of buffer delay reports per uplink
control channel occasion

Table 7 illustrates buffer delay reporting configurations (e.g. provided by way of RRC signaling). An XR device may receive the buffer delay reporting configurations by decoding a radio resource control reconfiguration message, a system information block or another information element sent by the serving radio access network. These messages carry a BufferDelayReportingConfig information object that details essential parameters for managing delay reporting. The information object provides, on a per-logical channel and quality of service basis, specific delay thresholds that determine when the device should initiate the compilation and transmission of buffer delay reports.

Additionally, the information object specifies the maximum allowable number of delay reports that may be sent during a single uplink control channel occasion. This limit is not fixed; instead, it is designed to be adaptive, changing in response to varying network loads and the priority levels of active XR services. By dynamically adjusting this maximum level, the network ensures that critical delay information is communicated while efficiently managing the constrained uplink control channel resources.

This adaptive configuration process enables the XR device to align its reporting strategy with the real-time operational conditions of the network. The device uses the decoded parameters to decide not only when to report delays but also how many reports to send, ensuring that only the most critical information is prioritized during periods of high demand. Such an approach supports the stringent latency requirements of XR applications and contributes to a smoother, more responsive user experience.

The BufferDelayReportingConfig is enriched with a reporting format field that instructs the XR device on the specific type of delay information to include in its reports. The field offers flexibility by specifying whether the device should transmit explicit remaining delay values, quantized delay ranges, or triggered threshold identifiers. When explicit delay values are provided, the network receives precise measurements that allow for fine-grained scheduling and resource allocation. Alternatively, quantized delay ranges may reduce the overhead of data transmission by categorizing delays into broader bins, which is particularly useful when control channel capacity is limited. The use of triggered threshold identifiers further streamlines reporting by signaling only that certain predefined delay thresholds have been crossed, thus efficiently alerting the network to potential issues without detailed numerical data.

Complementing the reporting format field, the configuration also incorporates a validity timer that defines the duration for which these settings remain active. This timer ensures that the device's delay reporting behavior is continuously synchronized with the current network conditions. Once the validity period elapses, the XR device is prompted to undergo a reconfiguration through a subsequent round of RRC or DCI signaling. This mechanism prevents outdated configurations from persisting in a dynamic network environment, thereby maintaining the relevance and accuracy of the delay reporting process. The validity timer thus plays a critical role in balancing the need for adaptive reporting with the practical limitations imposed by the uplink control channel.

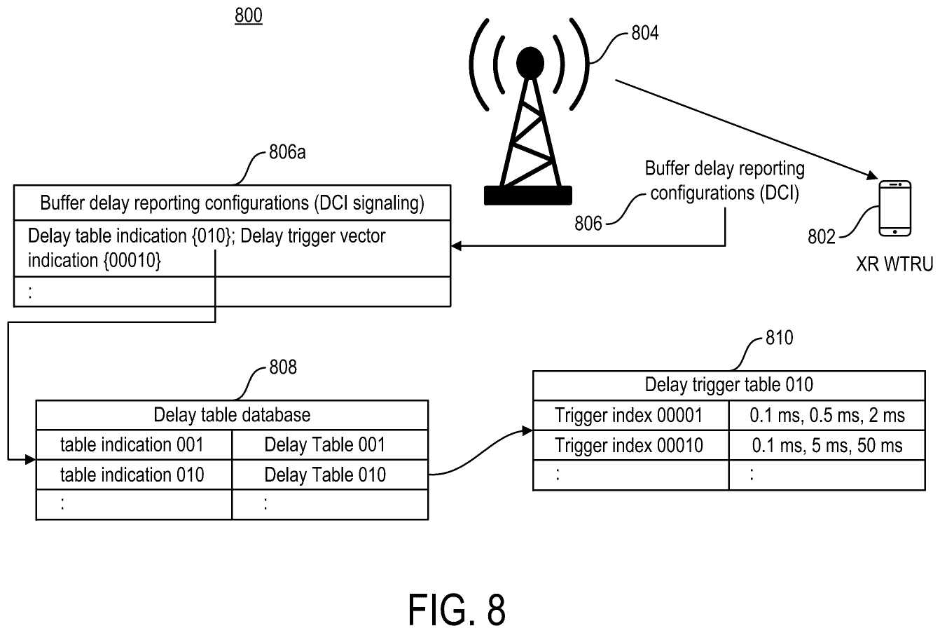

FIG. 8 is an illustration 800 that depicts the XR device 802 receiving its buffer delay reporting configurations 806 by decoding a downlink control information message transmitted via the physical downlink control channel (DCI) from a RAN node 804. The DCI message is designed to carry a compact configuration payload 806a that minimizes signaling overhead on a resource-limited channel. Rather than transmitting extensive information, the message includes an index that is mapped to a predefined delay threshold table 808 stored within the device. This table associates each index with specific delay threshold values 810 that have been carefully scaled to match application-specific delay budgets, ensuring that the device may maintain precise delay management without burdening the channel with excessive data.

By leveraging the compact configuration payload, the system significantly reduces the amount of signaling required to update delay reporting parameters. The use of an index allows the XR device to quickly reference a locally stored table rather than relying on the transmission of full delay threshold values over the air. This approach is particularly advantageous in the highly dynamic environment of XR services, where rapid changes in network conditions and application demands necessitate frequent updates, yet the available DCI resources remain constrained. The minimized signaling overhead not only conserves valuable channel resources but also enhances the responsiveness of the system in adapting to varying operational conditions.

This method of configuration ensures that the device operates with a high degree of precision in its delay reporting, while also maintaining an efficient use of the downlink control channel. The predefined delay threshold table acts as a reliable reference that is continuously updated through minimal DCI signaling, allowing the XR device to adjust its performance based on current network load and service priorities. Such efficiency is critical for managing the stringent latency requirements of immersive XR experiences, where even slight delays can adversely affect performance and user satisfaction.

The XR device continuously monitors the buffering time of packets on each active logical channel by employing a timestamping mechanism. As each payload is stored in the buffer, its arrival time is recorded, establishing a precise baseline for measuring the elapsed time. This systematic tracking allows the device to maintain an accurate history of how long each packet has been held, which is essential for managing delay-sensitive data streams effectively.

The device determines the remaining time of a buffered packet by tracking the moment it is processed and generated at the Packet Data Convergence Protocol (PDCP) layer. This timestamp, referred to as the packet generation time, serves as the reference point for delay calculations. From this point onward, the device continuously monitors the passage of time as the packet undergoes processing, buffering, and preparation for transmission when the scheduled resources are available, including delay for data encoding and symbol modulation. By maintaining an elapsed time counter, the device accumulates the delay experienced by the packet at various stages before its successful transmission.

As the packet progresses through different protocol layers, the device accounts for delays introduced by processing at the Radio Link Control (RLC) and Media Access Control (MAC) layers, as well as any queuing and scheduling delays incurred before transmission over the air interface. The remaining time is dynamically updated by subtracting the accumulated delay from the predefined target delay budget assigned to the packet. This allows the device to determine the urgency of transmission and prioritize packets with shorter remaining times accordingly. If a packet remains buffered for an extended period due to network congestion or scheduling constraints, the device continuously decrements its remaining time and reevaluates whether it is at risk of exceeding its target delay budget. In cases where the remaining time falls below a critical threshold, the device may trigger an urgent buffer delay report to notify the network of potential latency violations.

Building on this recorded information, the device calculates the shortest remaining delay for each logical channel by identifying the payload that is closest to exceeding its target delay budget. The remaining delay is computed by subtracting the elapsed buffering time from the predetermined target delay budget for each payload. By comparing these values across all buffered packets, the WTRU determines which packet has the smallest margin before reaching its delay threshold, thereby pinpointing the most critical delay condition on that channel.

This process of tracking and calculation is important in the overall delay management strategy of the device. The real-time determination of the shortest remaining delay provides a dynamic metric that may trigger timely interventions, such as prioritizing the transmission of high-risk data or initiating corrective actions to avoid buffer overflow. It ensures that the device may adapt its reporting and resource allocation strategies promptly, maintaining the high-performance requirements necessary for immersive XR experiences.

Furthermore, the target delay budget for each payload is initially defined according to the specific requirements of the XR application associated with each logical channel. This predetermined budget reflects the unique latency constraints necessary for delivering a high-quality immersive experience. The application-specific criteria, such as the type of content, interactive elements, and overall rendering demands, guide the establishment of these delay thresholds. By setting these values upfront, the XR device is primed to manage and monitor buffered data in a manner that aligns with the stringent performance requirements typical of XR services.

The XR device dynamically adjusts the target delay budget in real time, responding to changes in application rendering latency or feedback received from the network. When rendering delays increase due to higher computational demands or shifts in network conditions, the device recalibrates its delay budget to accommodate these variations. This adaptive mechanism ensures that the device may preemptively manage potential delays, optimizing its buffer management and delaying reporting strategies to maintain service quality even under fluctuating conditions.

XR rendering introduces additional complexity in calculating the remaining delay for buffered packets. Unlike conventional data transmission, where buffer delay is primarily determined by queuing and transmission latency, XR services require rendering operations that add an extra processing delay before the data may be utilized. This rendering delay may be accounted for when determining the remaining time a packet has before exceeding its outage delay budget. To achieve accurate delay tracking, the XR device factors in a rendering offset, which represents the time required to process and render an XR packet after it has been transmitted and received.

The rendering offset may be determined by the device itself based on its own processing capabilities. Devices with advanced rendering hardware may require a lower rendering offset, while devices with constrained processing power may need a higher offset to account for additional computational overhead. In such a case, the device dynamically calculates and applies an appropriate offset to its buffer delay reports, ensuring that the network is aware of the total end-to-end delay, including both transmission and rendering. The device may adjust this offset in real time based on workload fluctuations or rendering pipeline optimizations, leading to an adaptive delay reporting mechanism.

Alternatively, the rendering offset may be standardized and unified by the RAN node for all active XR devices. This is particularly useful in scenarios where joint rendering is executed across multiple core network entities or edge computing nodes. In such cases, the network may dictate a fixed rendering offset that all devices may apply, ensuring synchronization and consistency across the entire XR environment. The standardized offset prevents discrepancies between devices with different processing capabilities and enables better coordination in multi-user XR applications where rendering consistency is crucial.

In joint rendering scenarios where multiple entities contribute to the final XR output, the rendering delay may not be limited to the device itself but also include network-assisted processing time. If the RAN node, an edge server, or a cloud-based XR rendering unit is involved in processing and synthesizing XR content before transmission, the rendering offset may be adjusted to include this additional delay. In such cases, the RAN node may explicitly signal the rendering offset configuration to all devices, ensuring that their remaining time calculations align with the actual end-to-end processing requirements.

This dynamic adjustment not only enhances the responsiveness of the XR device but also ensures that the overall system remains synchronized with the evolving performance landscape. By continuously tuning the target delay budget, the device minimizes the risk of buffer overflow or service interruption, thereby safeguarding the immersive user experience. The interplay between predefined delay budgets and their real-time adjustments creates a robust framework that may accommodate both expected and unexpected variations in network and rendering performance.

Moreover, the XR device may employ a sophisticated monitoring mechanism that incorporates prioritization of buffered packets based on priority levels assigned by the XR application. In this approach, each payload stored within a logical channel is tagged with a priority indicator, allowing the device to differentiate between high-priority data that is important for maintaining the quality of the immersive experience and lower-priority data that is less time-sensitive. The priority indications may be generated by the PDCP layer on board of the device or assigned by the active XR applications for each traffic flow. This method ensures that the device's internal buffering and delay management processes are aligned with the specific performance requirements of the XR application, thereby optimizing the overall system responsiveness.

When it comes to calculating the shortest remaining delay, the device specifically focuses on evaluating only those payloads that are marked as high-priority. By narrowing the assessment to this critical subset of data, the system may efficiently determine which payload is closest to exceeding its target delay budget. This targeted evaluation not only streamlines the computational process by ignoring less critical packets but also enhances the precision of delay reporting, ensuring that only the most urgent data triggers necessary actions. As a result, the device may prioritize transmission or corrective measures that are essential for sustaining uninterrupted and high-quality XR services.

This selective approach to buffer monitoring and delay computation reinforces a dynamic management strategy that is responsive to both application-specific requirements and fluctuating network conditions. By concentrating resources and attention on high-priority packets, the XR device is better equipped to prevent potential service degradation caused by buffer overflows or delay outages. The integration of application-defined priority levels into the delay management process ultimately leads to more effective reporting and resource allocation, ensuring that critical delay information is conveyed to the network promptly, thereby preserving the immersive quality and reliability of XR experiences.

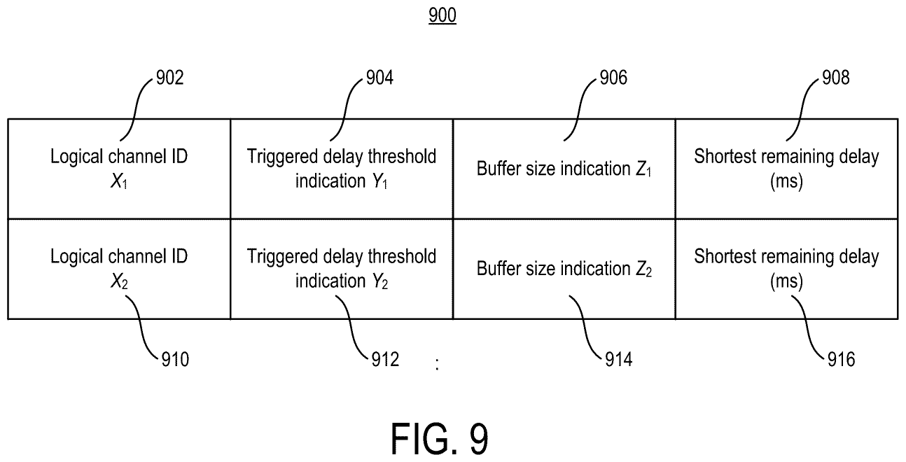

FIG. 9 depicts the XR device compiling a buffer delay report 900 by gathering a set of parameters for each eligible logical channel. For every channel that meets the criteria for reporting, the device includes a triggered delay threshold indication, which specifies that a preconfigured delay threshold has been crossed. Alongside this, the report includes the logical channel identifier, enabling the network to accurately determine the source and context of the reported delay information.

Specifically, FIG. 9 demonstrates, for a first logical channel ID 902, an associated: triggered delay threshold 904, buffer size indication 906 and shortest remaining delay 908. For a second logical channel ID 910, an associated: triggered delay threshold 912, buffer size indication 914 and shortest remaining delay 916.

In addition to the threshold indication, the report contains a buffer size indication, which quantifies the amount of data currently stored in the channel's buffer. This parameter provides insight into the extent of data accumulation, which is critical for understanding potential delays or the risk of buffer overflow. Furthermore, the report is enriched with explicit shortest remaining delay information. This value is computed by determining the payload within the channel that is closest to its target delay budget, thus offering a precise measurement of the remaining time before the onset of a delay outage.

By compiling these details into a single comprehensive report, the device delivers a multifaceted snapshot of the buffer status across all monitored logical channels. This aggregated report not only facilitates targeted interventions by the network but also supports efficient resource management, ensuring that channels with imminent delay issues are prioritized. The careful structuring of the report—with its clear indicators of delay thresholds, channel identifiers, buffer sizes, and explicit delay metrics—ensures that the network receives the critical information needed to maintain the performance and responsiveness of immersive XR services.

Additionally, the XR device calculates the current capacity of the available uplink control channel occasion by first assessing the constraints imposed by the physical layer conditions and the network's resource allocation. This process begins with determining the available resource unit (RU) budget or the maximum payload size that may be used for transmitting buffer delay reports. The available capacity is influenced by factors such as the measured signal-to-interference-plus-noise ratio (SINR), which provides an estimate of the wireless channel's quality, as well as the channel quality indicator (CQI) and modulation and coding scheme (MCS) assigned by the serving RAN node. These parameters collectively define the efficiency with which data may be encoded and transmitted over the uplink control channel. A higher SINR and CQI may allow the use of higher-order modulation and coding schemes, resulting in an increased payload capacity, while lower values may limit the available space for transmission.

Once the available payload size is determined, the device computes the number of buffer delay reports that may be transmitted within the current capacity. This calculation is performed by dividing the available payload size by the predefined size of a single buffer delay report. The predefined size of the report is configured based on the number of representation bits required for various report components, including triggered delay threshold indications, logical channel identifiers, buffer size indications, and explicit shortest remaining delay values. These parameters may be defined using a fixed configuration or a semi-static configuration that adapts to network conditions or reporting policies. A same control channel resource may be used by a device to transmit different signals, including for instance acknowledgment(s) to older packets as well as buffer delay reports and so, the amount of capacity available for devices to transmit buffer delay reports are not always the same.

By dynamically adjusting the number of reports transmitted in each uplink control channel occasion based on the available capacity, the XR device ensures optimal utilization of limited uplink resources. This adaptive approach prevents excessive signaling overhead while still providing timely and accurate delay information to the network. Additionally, by considering real-time radio conditions, the method enhances the robustness of buffer delay reporting, ensuring that critical delay information is conveyed even in challenging network environments. This capability is essential for maintaining low-latency performance in XR services, where rapid feedback on buffer conditions is necessary to support immersive and interactive experiences.

The XR device dynamically adjusts the predefined size of the buffer delay report based on the number of triggered delay thresholds or logical channels that require reporting. This adaptation ensures efficient utilization of the available uplink control channel resources, particularly in scenarios where the number of active logical channels fluctuates due to changing traffic conditions or application requirements. When multiple delay thresholds are triggered simultaneously across different logical channels, the XR device increases the report size to accommodate the additional information. This expansion allows the device to comprehensively convey the necessary delay metrics to the serving RAN node, ensuring that network scheduling decisions may be made with full awareness of the current buffer conditions.

Conversely, when only a subset of logical channels remains active or fewer delay thresholds are triggered, the XR device reduces the size of the buffer delay report. This reduction minimizes the signaling overhead and optimizes the use of the limited uplink control resources. By dynamically scaling the report size based on real-time conditions, the XR device avoids unnecessary transmission of redundant or low-priority information, ensuring that the uplink control channel is used efficiently for critical data. This adaptive behavior is particularly beneficial in high-load network scenarios where the available uplink bandwidth is constrained and may be allocated among multiple users and services.

The triggered delay threshold indication may be, in one option, encoded as a multi-bit field when multiple thresholds are crossed by the logical channel, allowing for efficient representation of buffer delay status within the available uplink control signaling resources. The multi-bit field is structured as a bitmap where each bit position corresponds to a specific configured threshold. When the shortest remaining delay for a logical channel surpasses a given threshold, the corresponding bit is set, enabling the serving RAN node to quickly assess the severity of the buffer delay condition without requiring explicit transmission of exact delay values.

By using a bitmap representation, the XR device optimizes the signaling overhead associated with buffer delay reporting, particularly in scenarios where multiple thresholds are exceeded simultaneously. This approach reduces the need for extensive numerical encoding of delay values while still providing granular delay status updates. The network may interpret the bitmap to determine the urgency of scheduling decisions based on how many and which thresholds have been crossed, ensuring that critical delay conditions receive priority treatment in uplink resource allocation.

The XR device dynamically updates the bitmap in response to changing buffer conditions, ensuring that only the most recent and relevant delay information is reported. If a payload with a significant delay expires or is transmitted before the next reporting occasion, the corresponding bit in the bitmap is reset, preventing outdated delay indications from persisting in the report. Additionally, the network may configure the number and spacing of delay thresholds based on service-specific requirements, allowing finer or coarser granularity in delay tracking. This adaptability ensures that the buffer delay reporting mechanism aligns with the varying latency sensitivities of different XR applications, providing a balance between efficient signaling and precise network scheduling awareness.

Determining the buffer delay reporting instant involves both periodic and conditional mechanisms to ensure timely and efficient updates on buffer status. For periodic reporting, the XR device initiates a buffer delay report upon the expiration of a timer that is configured via radio resource control (RRC) signaling. The duration of this timer is specific to the XR service type or logical channel priority, allowing for service-aware adaptation of the reporting periodicity. XR applications with stringent latency constraints may be assigned shorter timer durations to ensure frequent updates, while services with more relaxed latency requirements may operate with longer intervals to optimize uplink resource usage.

In addition to periodic reporting, conditional reporting is triggered when the shortest remaining delay of at least one logical channel falls below a configured delay threshold. This threshold is set as a percentage of the target delay budget to enable pre-outage notification, ensuring that the network is alerted before a payload reaches a critical delay condition. By configuring the threshold as a relative fraction of the target delay budget, the mechanism remains adaptable across different XR service classes, each of which may have distinct latency constraints. This proactive approach allows the network to take corrective actions, such as allocating additional uplink resources or adjusting scheduling priorities, before significant service degradation occurs.

The combination of periodic and conditional reporting provides a flexible and scalable approach to buffer delay monitoring. Periodic reports offer consistent visibility into buffer conditions, while conditional reports ensure that the network receives immediate updates when delay-sensitive conditions arise. The XR device dynamically evaluates whether a report is necessary based on current buffer status and network configurations, reducing unnecessary signaling overhead while ensuring critical delay information is promptly conveyed. This dual-trigger mechanism enhances network efficiency and responsiveness, improving the overall quality of experience for XR services.

Encoding the explicit shortest remaining delay information as a fixed-length field ensures that the buffer delay reports maintain a predictable structure while conveying critical timing details with the required precision. The field is defined with a resolution in milliseconds or sub-milliseconds, enabling fine-grained tracking of buffering conditions in alignment with the latency constraints of various XR applications. By standardizing the encoding format, the serving RAN node may efficiently decode and process the reported delay values without additional complexity, facilitating rapid network-side decision-making for scheduling and resource allocation.

The precision of the shortest remaining delay field is predefined based on the application requirements of the XR service associated with the logical channel. Applications such as augmented reality (AR) and virtual reality (VR) may demand sub-millisecond accuracy to meet stringent frame rendering and synchronization constraints, while other XR services with higher tolerance for latency variations may operate with millisecond-level granularity. The predefined precision ensures that the encoded delay information remains optimized for the specific quality-of-service (QoS) needs of the active XR session without consuming unnecessary uplink control resources.

To maintain efficiency in reporting, the fixed-length encoding approach balances the need for accuracy with the constraints of limited uplink control channel capacity. The chosen precision level is carefully determined to minimize signaling overhead while still providing actionable delay information to the network. This structured approach allows the RAN to make proactive scheduling decisions, such as prioritizing retransmissions or dynamically adjusting resource allocations, based on the real-time buffer conditions of the XR device. By leveraging a well-defined encoding scheme, the method supports scalable and adaptive buffer delay reporting across diverse XR service scenarios.

Further, to optimize uplink control channel utilization, the buffer size indication is omitted from the buffer delay report for logical channels with buffer sizes below a configured minimum threshold. This threshold-based omission reduces unnecessary signaling overhead, ensuring that only significant buffer occupancy data is transmitted. By filtering out buffer size indications for logical channels with negligible data accumulation, the method prioritizes the transmission of delay-critical information while preserving limited uplink control resources. The configured minimum threshold may be predefined by the network or dynamically adjusted based on network congestion levels and XR service requirements.

The explicit shortest remaining delay information is selectively reported only for logical channels that are flagged as high-priority by the serving RAN node. This prioritization mechanism ensures that network resources are allocated efficiently, focusing on XR traffic streams that have stringent latency constraints. Logical channels associated with lower-priority data traffic may not require explicit shortest remaining delay reporting, as their transmission deadlines are less critical to overall service performance. By restricting detailed delay reporting to high-priority channels, the method aligns reporting granularity with the urgency of different XR application flows, preventing excessive control signaling for non-critical traffic.

This selective reporting strategy enables the network to make intelligent scheduling and resource allocation decisions without being overwhelmed by excessive delay data. The serving RAN node may configure priority flags for logical channels based on service-level agreements, QoS class indicators, or real-time network conditions. When multiple logical channels are active, this approach ensures that the most time-sensitive data streams receive the necessary attention, while background or non-interactive XR services do not contribute to unnecessary control channel congestion. Through the combination of buffer size filtering and priority-based delay reporting, the method achieves an adaptive and scalable solution for XR buffer delay management.

To effectively manage XR traffic and prevent service degradation, buffer delay reports are prioritized for logical channels that are at risk of experiencing a buffer overflow or delay outage. The prioritization process begins with calculating the packet inflow rate and packet outflow rate for each logical channel over a time interval that spans the current uplink control channel occasion and the next scheduled control channel occasion. The inflow rate represents the volume of new packets arriving at the buffer, while the outflow rate corresponds to the volume of packets successfully transmitted or discarded. By analyzing these rates, the XR WTRU establishes a dynamic assessment of buffer utilization trends.

A rate difference is then determined for each logical channel by subtracting the packet outflow rate from the packet inflow rate. A positive rate difference indicates an accumulation of buffered data, while a negative or zero difference suggests a stable or decreasing buffer load. If the rate difference exceeds the buffer capacity of the logical channel divided by the time interval, the system predicts a buffer overflow event. This prediction enables proactive management of buffer congestion, allowing critical data to be transmitted before exceeding the available buffer capacity. The approach minimizes packet loss and ensures that delay-sensitive XR applications maintain their expected quality of service.

To further enhance reporting efficiency, buffer delay reports are assigned higher transmission priority when logical channels exhibit a predicted overflow event or when their shortest remaining delay falls below a critical outage threshold. The critical outage threshold is defined as a fraction of the target delay budget, ensuring that imminent delay violations are preemptively reported to the RAN node. Logical channels that exceed the threshold are flagged for prioritized buffer delay reporting, enabling the network to adjust scheduling and resource allocation in real time. By implementing this intelligent prioritization mechanism, the method ensures that network resources are directed toward mitigating service disruptions while reducing unnecessary reporting for less critical traffic flows.

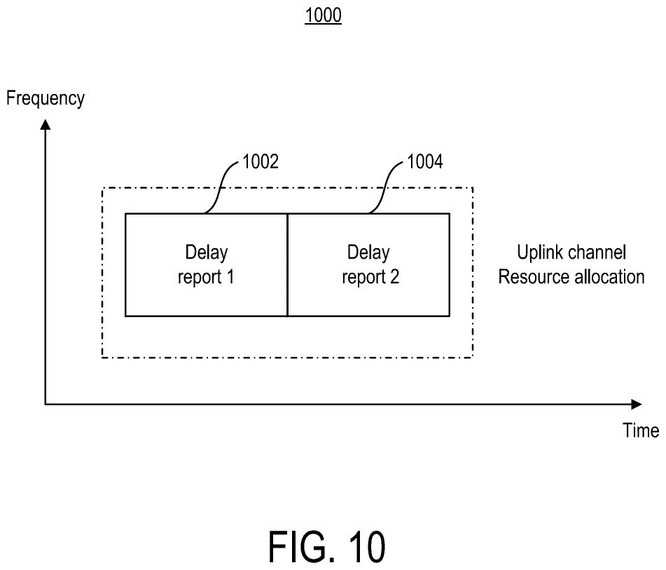

FIG. 10 is an illustration 1000 that shows individual buffer delay reports 1002, 1004 are being compiled and transmitted by the WTRU for all eligible logical channels. The process begins with generating a separate buffer delay report 1002, 1004 for each logical channel that has crossed at least one configured delay threshold. Each report contains essential information, including the triggered delay threshold indication, which specifies the extent to which the buffering time has exceeded predefined limits. Additionally, the logical channel identifier is included to distinguish the report's applicability to a specific traffic flow, ensuring that the network may apply targeted resource adjustments. Reports 1002, 1004 may be transmitted on a same frequency at separate times or they may be transmitted simultaneously over more than one frequency.

Each buffer delay report also incorporates a buffer size indication, providing insight into the amount of data currently awaiting transmission. This helps the RAN node assess congestion levels and allocate resources accordingly. Furthermore, explicit shortest remaining delay information is provided, detailing the minimum time remaining before the most urgent buffered packet exceeds its allowable delay budget. By including this information, the network gains a precise understanding of potential service disruptions and can proactively adjust scheduling policies to mitigate latency-sensitive issues.

Once individual reports are compiled, they are aggregated into a single uplink control information (UCI) payload. This aggregation ensures that multiple reports may be efficiently transmitted within a single uplink control channel occasion, reducing signaling overhead while maintaining comprehensive reporting. The aggregated payload is transmitted without truncation or compression, provided that its total size does not exceed the available capacity of the uplink control channel occasion. If the payload remains within capacity limits, all relevant buffer delay reports are successfully conveyed, enabling the network to make well-informed decisions on prioritization and resource allocation.

By structuring buffer delay reporting in this manner, the system ensures that delay-critical information is relayed effectively without unnecessary fragmentation. The approach maximizes the utility of limited uplink control resources while preserving the granularity of per-logical-channel reporting, allowing the network to respond dynamically to congestion and delay variations in real time.

Alternatively, to optimize uplink resource utilization while maintaining effective buffer delay reporting, a combined multi-buffer delay report is generated for low-priority logical channels. Instead of transmitting individual reports for each logical channel, which could introduce excessive signaling overhead, the system compiles an aggregated report by calculating a weighted average of the shortest remaining delays. This process begins by determining the shortest remaining delay for each unreported low-priority logical channel and multiplying it by its respective buffer size to derive a weighted delay value. By incorporating buffer size into the weighting process, the report ensures that logical channels with larger pending data volumes contribute more significantly to the overall delay assessment.

After obtaining the weighted delay values for all unreported low-priority logical channels, the system computes the total weighted delay sum by summing these values. Simultaneously, the buffer sizes of all these logical channels are summed to determine the total buffer size. These two aggregated values form the basis for the weighted average delay calculation. By dividing the total weighted delay sum by the total buffer size, the system derives a single representative delay metric that encapsulates the overall delay condition of the low-priority logical channels. This approach effectively balances granularity with signaling efficiency, providing the RAN node with meaningful delay information without overwhelming the limited uplink control resources.

The resulting combined multi-buffer delay report includes two aggregated parameters: the computed weighted average delay and the total buffer size of the low-priority logical channels. By summarizing delay conditions in this manner, the report enables the network to make informed scheduling and resource allocation decisions for lower-priority traffic flows without requiring per-logical-channel reporting. This method ensures that high-priority logical channels retain the necessary reporting accuracy while low-priority channels are efficiently represented, reducing transmission overhead while maintaining overall system responsiveness to buffer delay variations.

The WTRU selectively identifies low-priority logical channels based on their likelihood of experiencing buffer overflow or delay outage. This determination is made by evaluating the packet inflow and outflow rates of each logical channel over a time period spanning the current uplink control channel occasion and the next scheduled occasion. By analyzing the difference between the packet inflow and outflow rates, the system may predict whether a logical channel is at risk of exceeding its buffer capacity or experiencing a significant delay violation.

Logical channels are classified as low-priority if their packet inflow-outflow rate differences indicate stable buffer conditions without a risk of overflow or excessive delay accumulation. Specifically, if the rate difference remains below a threshold determined by the logical channel's buffer capacity divided by the time interval between uplink control occasions, the channel is considered stable and eligible for inclusion in the aggregated multi-buffer delay report. This approach ensures that reporting resources are primarily allocated to logical channels that are at immediate risk of performance degradation, while still providing summarized delay information for those with stable buffer conditions.

By identifying and grouping only the low-priority logical channels into the combined multi-buffer delay report, the system minimizes unnecessary signaling overhead while preserving accuracy in network decision-making. This classification mechanism allows the network to prioritize individual buffer delay reports for logical channels experiencing congestion, ensuring timely intervention when needed. Meanwhile, stable channels are efficiently represented through weighted aggregation, enabling the RAN node to maintain an overview of buffer conditions without being burdened by excessive control signaling.

The weighted average delay in the combined multi-buffer delay report is quantized to a coarser granularity compared to the explicit shortest remaining delay information used in high-priority reports. This quantization reduces the resolution of the delay representation, minimizing the number of bits required to encode the delay value. By using coarser granularity, the XR device optimizes the utilization of the limited uplink control channel capacity while still conveying a general overview of the buffer delay status for low-priority logical channels. This approach ensures that the most critical delay information remains highly detailed, while less time-sensitive data is compressed into a more resource-efficient format.

The quantization level of the weighted average delay is dynamically adjusted based on the total buffer size of the combined logical channels and the available control channel capacity. When the total buffer size is high or the uplink control channel capacity is constrained, the quantization level is increased, resulting in fewer bits representing broader delay ranges. This dynamic adjustment enables the device to maintain a balance between report accuracy and signaling efficiency, particularly in scenarios where multiple logical channels require simultaneous reporting. Conversely, when the buffer size is low or sufficient uplink capacity is available, the quantization level is reduced, allowing the weighted average delay to be represented with finer granularity and greater precision.

By dynamically adapting the quantization level, the XR device maximizes the efficiency of buffer delay reporting without compromising the overall quality of service. This adaptive mechanism ensures that high-priority traffic is reported with the highest precision, while low-priority traffic is conveyed in a compact format that preserves control channel resources. The flexibility in quantization enhances the scalability of the reporting system, allowing the device to adjust to varying network loads and application requirements in real time. This approach ultimately supports seamless delivery of XR services, maintaining low latency and consistent performance across a wide range of operating conditions.

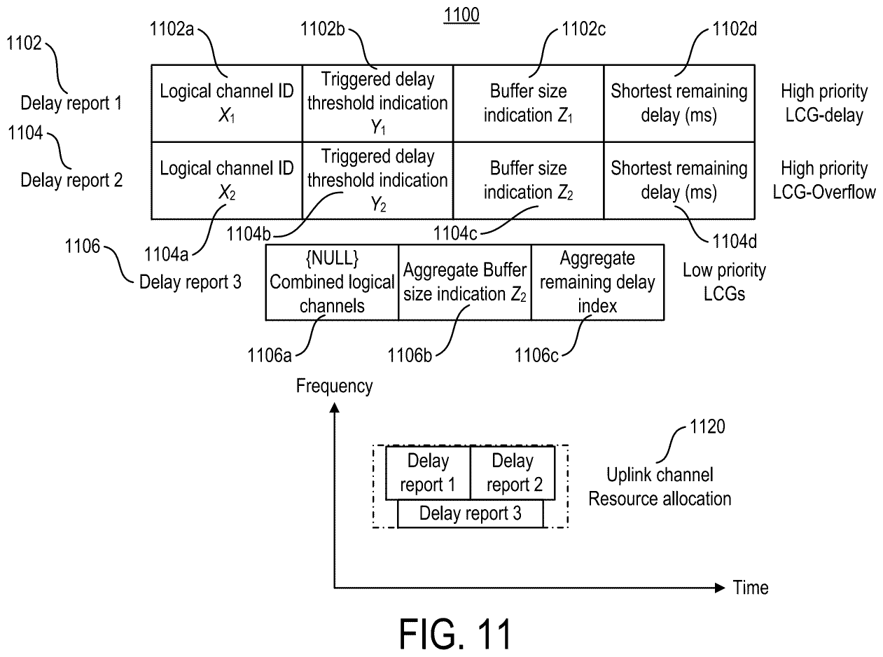

FIG. 11 illustrates the case 1100 where a control channel resource is limited to carry all eligible buffer reports, leading devices to generate multi-precision buffer delay reports. Specifically, FIG. 11 shows three delay reports, delay report 1 1102, delay report 2 1104 and delay report 3 1106.

As shown by FIG. 11, the high-priority sub-report includes individual buffer delay reports 1102, 1104 for logical channels that have been flagged as experiencing or being at risk of imminent buffer overflow or delay outage. Each of these reports 1102, 1104 contains triggered delay threshold indication 1102b, 1104b, buffer size indication 1102c, 1104c and explicit shortest remaining delay information 1102d, 1104d, ensuring that the serving RAN node receives precise delay data for channels that require immediate attention. This level of detail allows the network to take timely corrective actions, such as adjusting scheduling priorities or allocating additional resources to alleviate congestion and prevent service degradation.

The low-priority sub-report 1106 is designed to provide a compact summary of buffered delay information for logical channels that do not exhibit critical delay issues. Instead of individual reports for each of these channels, the low-priority sub-report contains a combined multi-buffer delay report. This report includes a weighted average delay value and an aggregated buffer size, offering the network a broader overview of the delay status of multiple logical channels without overwhelming the limited uplink control channel capacity. To differentiate this aggregated report from individual buffer delay reports, the low-priority sub-report 1106 includes a dedicated header field. This indication ensures that the RAN node may correctly interpret the format and apply appropriate processing logic based on the type of report received. Specifically, delay report 3 1106 includes an indication of combined logical channels 1106a, aggregate buffer size indication 1106b and aggregate remaining delay index 1106c.

By structuring the aggregated buffer delay report in this manner, the XR device enhances reporting efficiency, prioritizing critical delay information while ensuring that network resources are utilized optimally. This hybrid reporting strategy supports scalable buffer delay management, allowing the network to dynamically respond to congestion levels while maintaining the reliability of XR service delivery. The ability to distinguish high-priority and low-priority reports within a single uplink transmission minimizes signaling overhead and enables more adaptive network behavior, ultimately improving overall performance in latency-sensitive applications.

The uplink channel resource allocation 1120 for transmitting delay reports 1102-1106 may be such that delay report 1 and 2 1102-1104 are larger than delay report 3 1106. Delay reports 1, 2 1102, 1104 may be transmitted on a different frequency or frequencies than delay report 3 1106.

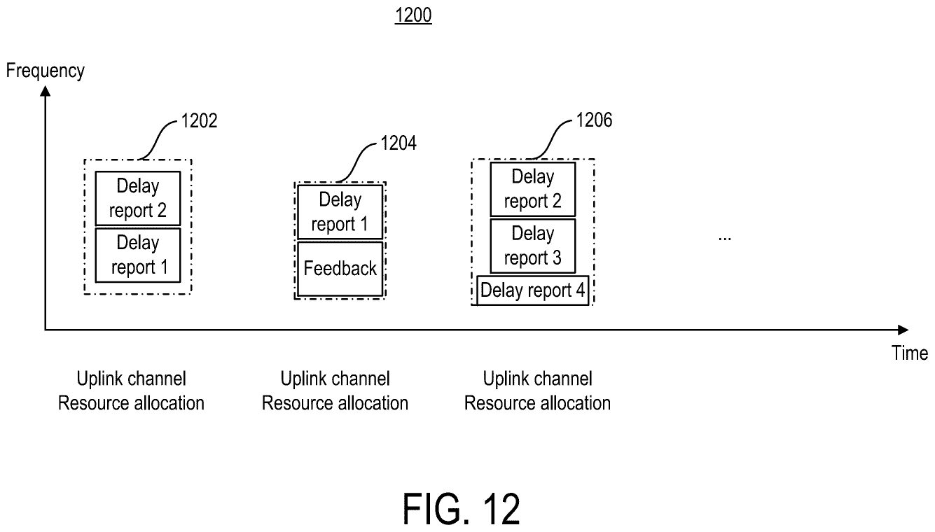

FIG. 12 is a timing diagram 1200 which illustrates multiple exemplary variants 1202-1206 of transmitted buffer delay information, showcasing how the device dynamically adjusts its reporting strategy based on uplink control capacity and priority constraints. In one instance 1202, the device transmits two high-priority delay reports, each reported with high precision since the available uplink control channel capacity permits the transmission of both reports. This scenario represents an ideal case where sufficient resources allow detailed reporting without requiring multiplexing or prioritization adjustments.

In the next instance 1204, a higher-priority feedback control message, such as ACK/NACK signaling, may be forwarded to the RAN. Given the strict prioritization of feedback control information, the device first multiplexes the ACK/NACK messages, ensuring they are transmitted before any available buffer delay reports. Due to limited uplink capacity, the device evaluates whether any remaining space in the second control channel resource may accommodate a buffer delay report. It determines that it may fit the first available delay report within the remaining capacity without exceeding the control channel limits. The device also determines that no buffer violations will occur for the remaining logical channels if their delay reports are transmitted in the next available control channel occasion, ensuring an optimized and efficient delay reporting strategy.

Over the third control channel occasion 1206, the device transmits the pending delay reports from the previous instance. Specifically, it multiplexes the previously deferred high-priority buffer delay reports with high precision, ensuring that delay-sensitive data is reported with maximum accuracy. Simultaneously, the device generates and transmits a low-priority multi-buffer delay report within the remaining capacity. The device triggers this multi-precision reporting strategy after determining that a buffer overflow may occur in one of the low-priority buffers if the delay information is not transmitted before the next scheduled control channel opportunity. By dynamically balancing high-precision and aggregated low-priority reporting, the device ensures that critical delays are conveyed accurately while preventing potential buffer overflows in lower-priority logical channels.

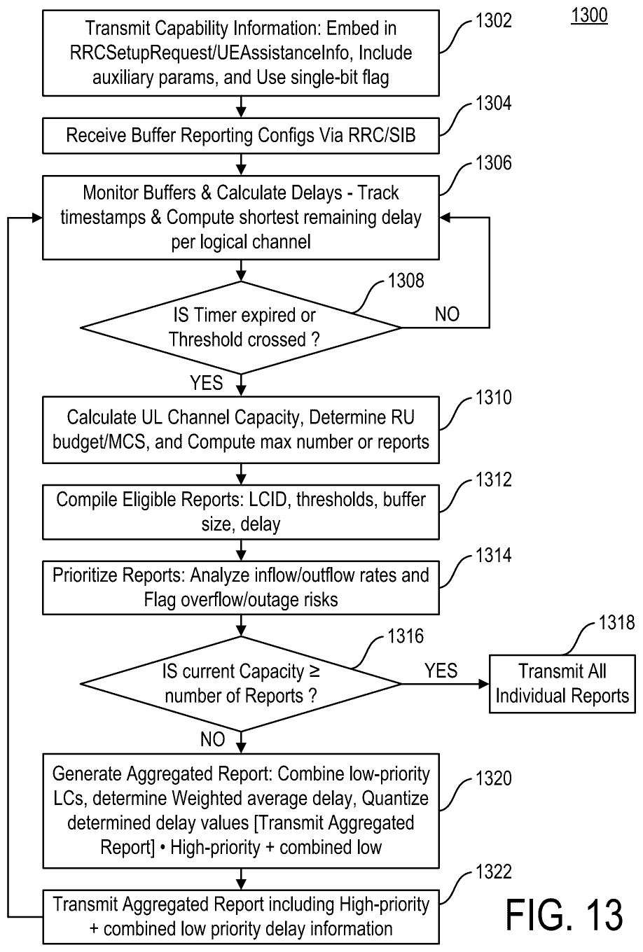

FIG. 13 depicts the overall logical action flow 1300 of the WTRU executing the proposed solution which follows a structured sequence of operations that enables efficient buffer delay reporting while optimizing uplink resource usage. The process begins with the WTRU transmitting capability information 1302 to the serving RAN node, indicating support for on-device dynamic buffer delay compilation and reporting. This capability is communicated during initial network attachment via an RRC setup request message or dynamically updated during an active connection through a UE assistance information message. The RAN node, upon receiving this information, configures the WTRU 1302 with buffer delay reporting parameters 1304 tailored to the network's resource constraints and the XR service requirements.

Once configured, the WTRU continuously monitors 1306 the buffering time of packets stored across multiple logical channels. A timestamping mechanism tracks the elapsed time since each payload was enqueued, allowing the WTRU to calculate the shortest remaining delay for each logical channel. This is achieved by identifying the payload closest to exceeding its target delay budget and computing its remaining time before a delay outage occurs. The WTRU prioritizes monitoring for high-priority logical channels, ensuring that XR services with strict latency requirements are proactively managed.

To reduce signaling overhead, the RAN node transmits buffer delay reporting configurations using an RRC reconfiguration message or compact DCI signaling. These configurations define reporting thresholds, allowable report frequencies, and the format of buffer delay reports. The WTRU decodes these instructions and determines the appropriate moments to transmit buffer delay reports. For periodic reporting, a timer expiration 1308 triggers the report, whereas for conditional reporting, the WTRU detects when the shortest remaining delay of any logical channel falls below a predefined threshold, prompting immediate transmission.

When compiling buffer delay reports, the WTRU evaluates the current uplink control channel capacity 1310 by considering available resource units, signal quality, and modulation and coding schemes. The WTRU compiles reports 1312 and prioritizes reports 1314. Based on the capacity, it determines how many buffer delay reports 1316 may be transmitted without exceeding the allocated uplink resources. If all eligible reports fit within the available space, individual buffer delay reports are transmitted 1318, each containing delay threshold indications, logical channel identifiers, buffer size indications, and explicit shortest remaining delay values.

If uplink resources are constrained, the WTRU optimizes report structuring by aggregating 1320 low-priority logical channel data into a combined multi-buffer delay report. This combined report represents the weighted average delay of multiple low-priority logical channels, reducing the total number of bits required for transmission. High-priority logical channels experiencing imminent delay outages still receive individual reports to ensure precise feedback to the RAN node. The WTRU encodes delay information efficiently, using multi-bit fields for triggered delay threshold indications and dynamically adjusting report sizes based on network feedback.

Finally, the WTRU prioritizes the transmission of buffer delay reports for logical channels at risk of buffer overflow. It calculates the inflow and outflow rates of buffered packets and predicts potential congestion events. If a logical channel is expected to exceed its buffer capacity before the next reporting occasion, its delay report is assigned a higher priority, ensuring that the network may take proactive measures to prevent service disruption. This logical flow ensures that buffer delay reporting remains adaptive, resource-efficient, and capable of maintaining the low-latency demands of XR applications. The WTRU transmits an aggregated report 1322.

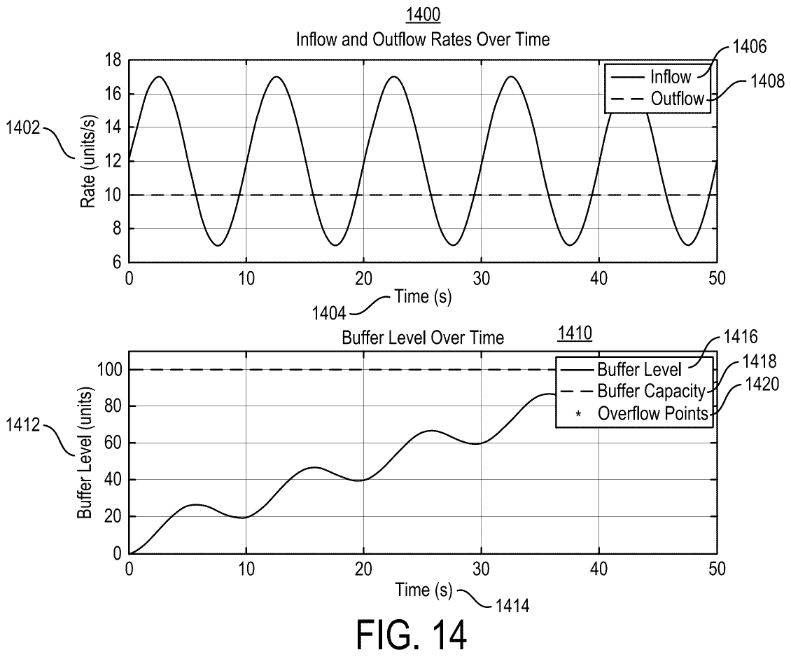

FIG. 14 illustrates a graph 1400 of inflow 1406 and outflow 1408 rates 1402 over time 1404. FIG. 14 also shows a graph 1410 demonstrating buffer level 1416 over time 1414. Buffer level in units 1412 is shown on the vertical axis. Because the buffer level 1416 does not reach its buffer capacity 1418 there are no overflow points 1420 shown, but once the buffer level 1416 does exceed buffer capacity 1418 there may be overflow points 1420.

An XR wireless transmit/receive unit (WTRU) for dynamic buffer delay compilation and reporting may comprise a transmitter that transmits, to a serving radio access network (RAN) node, capability information indicating support for on-device dynamic buffer delay compilation and reporting; a receiver that receives, from the serving RAN node, buffer delay reporting configurations, wherein the configurations include at least one of: (a) one or more delay thresholds to trigger buffer delay reporting, or (b) a maximum allowable number of buffer delay reports per uplink control channel occasion; circuitry configured to monitor and report, for each active buffered logical channel, the buffering time of buffered packets and calculating a shortest remaining delay associated with each logical channel before an outage by determining the shortest time difference between a target delay budget of a buffered packet and respective buffering time; circuitry configured to calculate a current capacity of an available uplink control channel occasion based on radio conditions, and determining a number of buffer delay reports that may be transmitted within the current capacity; circuitry configured to compile a buffer delay report comprising, for each eligible logical channel: a triggered delay threshold indication, a logical channel identifier, a buffer size indication, and explicit shortest remaining delay information; circuitry configured to prioritize transmission of buffer delay reports for logical channels determined to experience a buffer overflow and/or delay outage if not scheduled during the current control channel occasion, based on a comparison of packet inflow and outflow rates over a time period between the current and next control channel occasions; on a condition of the current control channel occasion capacity and configured maximum allowable number of buffer delay reports larger than or equal the available number of buffer delay reports, compiling and transmitting individual buffer delay reports for all eligible logical channels; and on a condition of the current capacity or configured maximum allowable number are smaller than the available number of buffer delay reports, generating a combined multi-buffer delay report for low-priority logical channels by computing a weighted average of shortest remaining delays, wherein weights correspond to buffer sizes of unreported logical channels; and transmitting an aggregated buffer delay report comprising prioritized high-priority buffer delay reports and the combined low-priority report during the current uplink control channel occasion.

Transmitting the capability information may comprise embedding the binary capability indication within a dedicated field of an RRCSetupRequest message during initial network attachment or within a UEAssistanceInformation message during an RRC connected state; or mapping the binary capability indication to a predefined bit position in uplink control information (UCI) transmitted via a physical uplink control channel (PUCCH) or a physical uplink shared channel (PUSCH), wherein the UCI is configured to include device-specific capability signaling.

The dedicated field in the RRCSetupRequest message or UEAssistanceInformation message further includes auxiliary parameters associated with the XR WTRU's buffer management capabilities, including at least one of: a maximum supported number of logical channels for simultaneous delay monitoring; and/or a granularity level for delay reporting in terms of a time unit (e.g., 1 ms, 5 ms); and/or a preferred periodicity information for buffer delay reporting occasions.

The binary capability indication may be encoded as a single-bit flag, where a first state indicates support for on-device dynamic buffer delay compilation and reporting, and a second state indicates lack of support.

Receiving the buffer delay reporting configurations may include decoding a radio resource control (RRC) reconfiguration message or system information block (SIB) transmitted by the serving RAN node, wherein the RRC reconfiguration message contains a BufferDelayReportingConfig information object specifying, for each logical channel and/or quality of service (QoS) class: one or more delay thresholds, and a maximum allowable number of buffer delay reports per uplink control channel occasion, wherein the maximum allowable number is adjusted based on network load or priority levels of active XR services.

The BufferDelayReportingConfig may further include a reporting format field indicating whether explicit remaining delay values, quantized delay ranges, or triggered threshold identifiers are to be included in buffer delay reports, and a validity timer defining a period during which the configurations remain active before requiring reconfiguration via a second RRC or DCI signaling.

Receiving the buffer delay reporting configurations may include decoding a downlink control information (DCI) message transmitted via a physical downlink control channel (PDCCH), wherein the DCI message includes a compact configuration payload comprising: an index mapped to a predefined delay threshold table stored at the XR WTRU, the table associating indices with delay threshold values scaled to application-specific delay budgets.

Monitoring and recording the buffering time of buffered packets for each active logical channel includes: tracking, via a timestamping mechanism, an elapsed time since each payload was stored in a buffer of the logical channel; and calculating the shortest remaining delay for the logical channel by identifying a payload within the buffer having a smallest remaining time before exceeding its target delay budget, wherein the remaining time is computed as the target delay budget minus the elapsed buffering time of the payload.

The target delay budget for each payload is predefined based on application-specific requirements of an XR service associated with the logical channel, and wherein the target delay budget is dynamically adjusted by the XR WTRU in response to changes in application rendering latency or network feedback.

Identifying the payload with the smallest remaining time includes: sorting buffered payloads in the logical channel based on their elapsed buffering times; and selecting a payload with a longest elapsed buffering time as the payload having the smallest remaining time before outage.

Monitoring buffered packets may include prioritizing payloads within a logical channel based on priority levels assigned by an XR application, wherein the shortest remaining delay is determined by evaluating only payloads marked as high-priority by the application.

Calculating a current capacity of the available uplink control channel occasion may include: determining an available resource unit (RU) budget or a maximum payload size for the control channel occasion based on a measured signal-to-interference-plus-noise ratio (SINR), channel quality indicator (CQI), or modulation and coding scheme (MCS) allocated by the serving RAN node; and computing the number of buffer delay reports that may be transmitted within the current capacity by dividing the available payload size by a predefined size of a single buffer delay report, wherein the predefined size of the buffer delay report is determined based on a fixed or semi-static configuration of the required number of representation bits of the triggered delay threshold indications, number of logical channels, buffer size indications, and explicit shortest delay information.

The predefined size of the buffer delay report is dynamically adjusted by the XR WTRU based on a number of triggered delay thresholds or logical channels requiring reporting, wherein the report size increases when multiple delay thresholds are triggered or decreases when only a subset of logical channels are active.

Determining the number of buffer delay reports that may be transmitted within the current capacity includes: calculating a total number of bits available for buffer delay reporting in the uplink control channel occasion based on a configured control channel resource allocation; dividing the total number of bits by a per-report bit requirement, wherein the per-report bit requirement includes the sum of bits allocated for the triggered delay threshold indications, logical channel identifiers, buffer sizes, and explicit shortest delay information; and rounding down the result to an integer value representing the maximum number of buffer delay reports that may be accommodated.

Compiling and reporting the buffer delay report includes, for each eligible logical channel: a triggered delay threshold indication as an index corresponding to a preconfigured threshold table received from the serving RAN node, the index identifying a specific delay threshold crossed by the logical channel; a logical channel identifier (LCID) mapped to a radio bearer or service data flow; a buffer size indication expressed as a number of bytes or packets queued in the logical channel's buffer; and/or explicit shortest remaining delay information quantized to a predefined granularity, wherein the granularity is configured via radio resource control (RRC) signaling or dynamically adjusted based on the target delay budget of the logical channel.

The triggered delay threshold indication may be encoded as a multi-bit field when multiple thresholds are crossed by the logical channel, the multi-bit field comprising a bitmap where each bit position corresponds to a configured threshold, and a set bit indicates that the logical channel's shortest remaining delay has crossed the associated threshold.

Determining the buffer delay reporting instant may comprise: for periodic reporting, initiating a report upon expiration of a timer configured via RRC signaling, the timer duration being specific to an XR service type or logical channel priority; and for conditional reporting, detecting that the shortest remaining delay of at least one logical channel has fallen below a configured delay threshold, wherein the threshold is set as a percentage of the target delay budget to enable pre-outage notification.

The explicit shortest remaining delay information may be encoded as a fixed-length field with a precision of milliseconds or sub-milliseconds, wherein the precision is predefined based on application requirements of the XR service associated with the logical channel.

The buffer size indication may be omitted from the inclusion in the buffer delay report for logical channels with buffer sizes below a configured minimum threshold, and wherein the explicit shortest remaining delay information is reported only for logical channels flagged as high-priority by the serving RAN node.

Prioritizing transmission of buffer delay reports for logical channels determined to experience a buffer overflow or delay outage may comprise calculating, for each logical channel, a packet inflow rate and a packet outflow rate over a time interval spanning the current control channel occasion and a next scheduled control channel occasion; determining a rate difference by subtracting the packet outflow rate from the packet inflow rate; predicting a buffer overflow event for the logical channel if the rate difference exceeds a buffer capacity of the logical channel divided by the time interval; and assigning a higher priority to buffer delay reports for logical channels with predicted overflow events or shortest remaining delays below a critical outage threshold.

Compiling and transmitting individual buffer delay reports for all eligible logical channels, comprises: generating a separate buffer delay report for each logical channel that has crossed at least one configured delay threshold, wherein each report includes the triggered delay threshold indication, logical channel identifier, buffer size indication, and explicit shortest remaining delay information; aggregating the individual buffer delay reports into a single uplink control information (UCI) payload; and transmitting the aggregated payload within the current uplink control channel occasion without truncation or compression, provided the total payload size does not exceed the current capacity.

Generating the combined multi-buffer delay report for low-priority logical channels comprises: calculating the weighted average of the shortest remaining delays by multiplying the shortest remaining delay of each unreported low-priority logical channel by its corresponding buffer size to generate weighted delay values; summing the weighted delay values to produce a total weighted delay sum; summing the buffer sizes of all unreported low-priority logical channels to produce a total buffer size; and dividing the total weighted delay sum by the total buffer size to compute the combined weighted average delay, wherein the combined report includes the weighted average delay and the total buffer size as aggregated parameters for the low-priority logical channels.

The low-priority logical channels are identified as those not determined to experience buffer overflow or delay outage within the time period between the current and next control channel occasion, based on a comparison of their packet inflow-outflow rate differences and buffer capacities.

The weighted average delay is quantized to a coarser granularity than explicit shortest remaining delay information in high-priority reports, wherein the quantization level is dynamically adjusted based on the total buffer size or available control channel capacity.

The aggregated buffer delay report is structured to include: a high-priority sub-report comprising individual buffer delay reports for logical channels flagged with imminent overflow or outage, each including explicit shortest remaining delay information; and a low-priority sub-report comprising the combined multi-buffer delay report, formatted with a header field indication distinguishing it from individual reports.

A numerical example is below.

### Setup:

LCGs: 3 (LCG 1, LCG 2, LCG 3). Thresholds: 5 ms, 10 ms, 15 ms. T_critical: 5 ms. B_overflow: 1000 bytes. Control channel size: Allows 3 detailed entries (plus a small combined entry if needed).

### Buffer Status:

LCG 1: 5 ms: 200 bytes, 3 ms (most stringent), 10 ms: 150 bytes, 8 ms; LCG 2: 5 ms: 1200 bytes, 4 ms (overflow), 10 ms: 300 bytes, 9 ms; LCG 3: 10 ms: 100 bytes, 10 ms, 15 ms: 50 bytes, 14 ms.

### Report Compilation:

Most Stringent Threshold: LCG 1, 5 ms [LCG 1, 5 ms, 200 bytes, 3 ms]; Overflow Thresholds: LCG 2, 5 ms [LCG 2, 5 ms, 1200 bytes, 4 ms]; Space Check: 2 of 3 entries used; 1 detailed entry remains. Additional Detailed Entry: LCG 2, 10 ms [LCG 2, 10 ms, 300 bytes, 9 ms]

### Aggregate Remaining:

LCG 1 (10 ms): 150 bytes, 8 ms; LCG 3 (10 ms): 100 bytes, 10 ms; LCG 3 (15 ms): 50 bytes, 14 ms; Combined Buffer Size: 150+100+50=300 bytes; Averaged Remaining Time: (150×8+100×10+50×14)/300=9.67 ms; Entry: [Combined, 300 bytes, 9.67 ms].

Final Report: [LCG 1, 5 ms, 200 bytes, 3 ms]; [LCG 2, 5 ms, 1200 bytes, 4 ms]; [LCG 2, 10 ms, 300 bytes, 9 ms]; [Combined, 300 bytes, 9.67 ms].

Example embodiments include: XR-specific capability signaling: Binary indication via UCI/RRC to enable dynamic buffer delay reporting; proactive outage prediction: Shortest remaining delay calculation (target delay budget-buffering time)+threshold-based triggers; prioritized overflow mitigation: Ranking channels by packet inflow/outflow rate differences+application-criticality elevation; resource-efficient combined reporting: Low-priority channels aggregated via buffer-size-weighted average delay; payload optimization: Bitmap thresholds, field omission, LCID compression, and dynamic quantization.

XR WTRU/device transmitting XR device capability information, as part of uplink UCI and/or RRC setup request signaling, towards serving RAN node, including a binary capability indication of supporting on-device dynamic buffer delay compilation and reporting; XR WTRU/device receiving buffer delay reporting configurations from serving RAN node, as part of either DCI and/or RRC setup complete signaling, including any of the following information element combinations: (a) one or more delay thresholds to trigger buffer delay reporting, and/or (b) maximum allowable number of buffer delay reports per each uplink control channel occasions; XR WTRU/device monitoring, tracking and determining delay information for each active buffered logical channel (e.g., active data buffer); XR WTRU/device calculating and determining the shortest remining delay of a buffered packet within each of the active logical channels before an outage is inflicted by calculating the time difference between the target delay budget of the payload (i.e., depending on the application requirements which generated the payload) and the buffering time of the payload; On condition of a buffer delay reporting instant (e.g., fulfilling a periodical reporting and/or a triggering delay threshold per logical channel), XR WTRU/device determining the current capacity of the available control channel occasion, based on current radio conditions, and calculates the number of buffer delay reports that can fit within the determined control channel capacity, given the size of the buffer delay report is known to the device and it includes: triggered delay threshold indication, location channel/buffer indication, buffer size indication, and/or explicit shortest or combined delay information; XR WTRU/device determining the one or more active logical channels of an expected buffer overflow event if not scheduled during the current control channel occasion by calculating the difference between the respective packet inflow rate versus the packet outflow rate over the time period between current and next available control channel occasions; On condition of a determined current uplink control capacity AND a configured maximum allowable number of buffer delay reports that are larger than or equal the available number of buffer delay reports (i.e., number of active logical channels of eligible delay report triggers that fulfil one or more of the configured delay thresholds), XR WTRU/device compiling and transmitting a buffer delay information report including delay information of available active logical channel, where for each, it includes triggered delay threshold indication, location channel/buffer indication, buffer size indication, and/or explicit shortest delay information; On condition of a determined current uplink control capacity AND/OR a configured maximum allowable number of buffer delay reports that are smaller than the available number of buffer delay reports, XR WTRU/device prioritizing transmission of one or more buffer delay reports which are determined to exhibit a buffer overflow and/or a delay outage if not scheduled during the current control channel occasion; On condition of a remaining control channel capacity after fitting the determined high-priority buffer delay reports, XR WTRU/device overriding configured maximum allowable number of buffer delay reports and compiling a combined multi-logical channel buffer delay report of the remaining low-priority logical channels and is computed as the weighted average of the shortest remaining times of the unreported threshold intervals, with the weights being their respective buffer sizes (Multiplying the buffer size of each unreported threshold interval by its shortest remaining time, Summing all these products together, Dividing this total sum by the sum of the buffer sizes of all unreported threshold intervals); XR WTRU/device appending the low-priority buffer delay report with the high-priority buffer delay report and transmitting the final aggregate delay report towards the serving RAN node during the current uplink control channel occasion.

Aspects of the proposed report implementation embodiment are as follows:
Designing and reporting a multi-precision multi-buffer delay info report such that no info is lost at all but reported with various precision depending on its urgency or importance. For instance, for a packet of 1 ms delay target, explicit delay info or very precise quantization is adopted, and for a packet of 10 seconds delay target, precision is relaxed to reduce signaling overhead which will not neglect this data though compared to existing implementation solutions.
Reporting delay info that does not only relate to delay urgency but expected buffer overflow events: consider the case where a device has multiple XR flows of low and high importance and so, it always prioritizes reporting delay info of high priority traffic. That may lead to simply blocking reporting and scheduling low importance traffic and so, respective buffers will be filled more and more until it overflows at some point because it is not freed and being blocked by higher importance traffic. MATLAB scenario results are shown below (with having a buffer of certain in flow and out flow rate and buffer capacity during a period of time) and with the solution, when the device detects or expects a green dot event (i.e., buffer overflow event) of a buffer (if the delay info of the buffer is NOT reported during current control channel occasion), it may immediately upscale the importance of such buffer such it becomes high priority and so, be eligible for reporting and scheduling immediately.

Modern Extended Reality (XR) applications may require architectures that deliver highly fast and proactive rendering to sustain immersive, high-fidelity experiences. In particular, lower capability XR devices are often unable to process complex graphical data in real time, necessitating the use of split rendering wherein the rendering workload is partitioned between a central server and the device. In this method, critical elements of a scene are pre-rendered by the server and transmitted to the device, which then combines these elements with locally rendered data to form a complete image. This approach not only leverages the superior processing power of centralized servers but also addresses the inherent processing limitations of less capable devices, ensuring that latency-sensitive operations such as motion-to-photon response times remain within acceptable thresholds.

However, the effective implementation of split rendering critically depends on the network's comprehensive awareness of the rendering configurations and the payload associated with the pre-rendered data. Without detailed insight into these configurations, the network risks being inundated with pre-rendered traffic, potentially overwhelming system capacity and degrading overall performance. To mitigate this, the network should be capable of dynamically adjusting transmission parameters and prioritizing traffic based on real-time assessments of rendering demands and network congestion. By integrating such network-aware controls into the rendering process, the system ensures that the advantages of split rendering—namely reduced local processing demands and maintained low-latency performance—are achieved without compromising the efficiency and scalability of the wireless network infrastructure.

U.S. Pat. No. 11,735,142 to Ranka et al., is reproduced by reference herein in its entirety. Ranka is focused on synchronizing rendered content between remote servers and local devices. U.S. Pat. No. 8,169,436 to Rivera et al is reproduced by reference herein in its entirety. Rivera addresses the division of rendering tasks (remote versus local). US Patent Publication No. 20240422511 to Rao is reproduced by reference herein in its entirety. Rao discloses a WTRU having an extended reality application that transmits requests to a base station.

In one exemplary embodiment, the radio access network (RAN) node is configured to manage extended reality (XR) traffic by first receiving a local rendering capability indication from active XR wireless transmit/receive units (WTRUs) through uplink control information or radio resource control signaling. In this embodiment, the indication, for example a 1-bit flag, communicates whether a device is capable of performing full XR local rendering or if it requires supplemental pre-rendered transport blocks.

In one exemplary embodiment, the RAN node then receives, from a core network entity via backhaul link(s), pre-rendered transport blocks that are each associated with a timestamp defining a start and an end slot or symbol instant, as well as with one or more XR pose inputs. The node calculates an average input packet rate based on the frequency of pre-rendered transport blocks received and an average scheduling packet rate reflecting the rate of successfully transmitted transport blocks. By determining the average available downlink capacity from aggregated channel quality reports and modulation and coding scheme indices, the RAN node is enabled to predict an anticipated congestion time instant when the difference between the input and scheduling rates exceeds the available capacity.

In another exemplary embodiment, the RAN node employs a dynamic selection process to optimize transmission under varying network conditions. When the aggregate size of the buffered pre-rendered transport blocks exceeds the available downlink capacity, the node identifies a first subset of XR devices whose associated transport blocks have timestamps overlapping with the anticipated congestion time. In such cases, if the available capacity is sufficient to handle the aggregate size of the buffered blocks, the RAN node schedules their transmission via a data channel and embeds the corresponding XR pose inputs (e.g. hand tracking, head movement, etc.) within the downlink control information. Conversely, if the capacity is insufficient, the node selects a second subset comprising devices with non-local rendering capabilities, transmitting the corresponding buffered blocks with pose-embedded control information, while flushing the buffered blocks for the remaining devices and issuing a local rendering request.

In another exemplary embodiment, on the device side, the XR WTRUs are designed to continuously assess and signal their rendering capabilities to the RAN node. In one exemplary embodiment, each XR device dynamically monitors its available computational resources and battery level, updating its local rendering capability indication in real time. This update, transmitted via the dedicated signaling channel, may reflect a shift from full XR local rendering capability to partial rendering mode, wherein the device requires supplemental pre-rendered transport blocks to complete scene generation. This dynamic interaction ensures that the RAN node is always informed of the device's current rendering state, thereby allowing for adaptive scheduling that is sensitive to the operational status of each device.

In yet another exemplary embodiment, both the RAN node and the XR devices incorporate advanced predictive and adaptive mechanisms to enhance the XR experience. The core network entity generates the pre-rendered transport blocks by analyzing historical movement patterns and employing machine learning models to predict future user behavior, thereby associating each block with a defined validity period. The RAN node, upon receiving these blocks, verifies the alignment of the embedded XR pose inputs with the current pose information reported by the devices. If the synchronization between the predicted and current poses falls outside a predefined tolerance threshold delta, the RAN node discards the transport block and triggers a fallback local rendering instruction. This collaborative approach between the network and the devices ensures that, regardless of fluctuating network conditions or unpredictable user behavior, the XR service delivery remains both robust and seamless.

Embodiments disclosed herein may be exemplified for Extended Reality (XR) traffic, such embodiments are broadly applicable to any proactive traffic profile requiring time-sensitive delivery and congestion-aware prioritization, such as real-time video streaming, industrial IoT telemetry, or autonomous vehicle coordination. In these scenarios, the Radio Access Network (RAN) node receives precomputed or pre-fetched data blocks from a core network entity, each tagged with a timestamp defining its validity period (start/end slot/symbol instants) and metadata specifying its criticality (e.g., latency tolerance, redundancy level). For example, in a video streaming context, pre-encoded video chunks for anticipated user playback points are timestamped to align with buffering deadlines, while in IoT deployments, pre-aggregated sensor data packets are valid only for specific reporting intervals. The RAN node leverages the same congestion prediction and prioritization framework-calculating input/scheduling rates, determining downlink capacity, and identifying congestion instants—to optimize delivery across diverse traffic types.

The core network entity, such as an IP Multimedia Subsystem (IMS) server, generates those pre-rendered or precomputed data blocks by leveraging user behavior analytics, service-level agreements (SLAs), and network state forecasts. For multimedia services like real-time video streaming, the IMS server analyzes historical viewing patterns (e.g., scene skip rates, pause/play habits) and device-specific buffering capacities to pre-encode video chunks tailored to anticipated user actions. Timing information (start/end slot/symbol instants) is derived from buffer occupancy reports and latency thresholds specified in SLAs, ensuring pre-fetched chunks are valid only for their expected playback windows. For instance, a video chunk predicted to be viewed at time T is timestamped with a validity period aligned to the user's buffer health (e.g., 10-second window). The IMS collaborates with Policy and Charging Rules Function (PCRF) nodes to prioritize blocks for latency-sensitive services (e.g., 4K live streams) over non-critical traffic. Machine learning models may additionally refine predictions using real-time feedback from the RAN node, such as flushed block notifications or pose deviations in XR scenarios, dynamically adjusting pre-rendered content and timestamps.

The adoption of split rendering in Extended Reality (XR) services, where computationally intensive rendering tasks are offloaded to edge servers, offers significant benefits for low-capability XR devices by reducing on-device processing demands. However, traditional implementations treat split rendering as an opaque application-layer process, decoupled from Radio Access Network (RAN) operations. This lack of cross-layer awareness creates systemic inefficiencies: unpredictable radio interface delays disrupt time-sensitive rendering pipelines, while edge servers proactively flood the RAN with pre-rendered payloads to mitigate latency risks. These pre-rendered payloads-often comprising redundant scene variations to account for potential user movements-overwhelm downlink resources, causing severe congestion that degrades performance for all active devices. For example, a sudden spike in pre-rendered traffic from multiple XR sessions can exhaust available bandwidth, leading to payload drops, increased retransmissions, and motion-to-photon latency violations that break user immersion.

The disclosed application addresses these challenges by integrating RAN-layer intelligence into split rendering workflows. By receiving explicit local rendering capability indications from XR devices—such as whether a device can fully, partially, or not at all render scenes locally—the RAN node dynamically coordinates with edge servers to optimize pre-rendered payload delivery. For low-capability devices dependent on network-assisted rendering, the RAN prioritizes transmission of pre-rendered transport blocks during anticipated congestion windows, embedding time-synchronized pose inputs (e.g., head orientation, gaze) into downlink control information (DCI) to ensure coherent scene assembly. Conversely, for devices with partial or full local rendering capabilities, the RAN node suppresses non-critical pre-rendered traffic, instead triggering on-device rendering via DCI commands that include fallback pose data and deadlines. This capability-aware traffic shaping prevents redundant payloads from congesting the radio interface while maintaining rendering continuity.

Thus, first, the RAN node calculates real-time downlink capacity using channel quality indicator (CQI) reports and modulation and coding scheme (MCS) indices, subtracting guard band margins to account for potential interference. It then predicts congestion time instants by extrapolating the difference between incoming pre-rendered packet rates and scheduled transmission rates. The RAN selectively transmits pre-rendered blocks only to devices lacking local rendering capabilities, while flushing non-essential blocks for capable devices and instructing them to render locally. This approach ensures radio resources are allocated strictly where needed, avoiding the “over-provisioning trap” inherent in traditional split rendering architectures. Furthermore, the RAN node coordinates with edge servers to regenerate pre-rendered blocks based on real-time pose feedback from devices, refining predictions and reducing redundant scene variations. By aligning network-assisted rendering with RAN conditions, the application achieves a sustainable balance between XR quality and radio efficiency, enabling scalable deployment of immersive services over wireless networks.

The RAN node interfaces with core network servers or edge servers via standardized or proprietary backhaul links to receive pre-rendered transport blocks and coordinate congestion-aware traffic management. For 5G/6G deployments, standardized interfaces such as Xn (inter-gNodeB), NG (Next-Generation Core), or F1 (CU-DU split) facilitate high-throughput, low-latency communication, enabling real-time delivery of timestamped blocks and metadata. Edge servers leverage ETSI MEC (Multi-access Edge Computing) APIs or O-RAN ALLIANCE specifications (e.g., A1, E2 interfaces) to transmit pre-rendered blocks with millisecond-level synchronization, ensuring alignment with RAN scheduling cycles. For legacy systems, X2 (LTE) or HTTP/2-based streaming protocols are utilized, with transport blocks encapsulated in IP packets or Ethernet frames. The RAN node further employs QUIC or gRPC for efficient, error-resilient block delivery in congested backhaul scenarios, prioritizing critical blocks via QoS tagging (e.g., DSCP for latency-sensitive traffic). Feedback mechanisms, such as flushed block notifications or pose deviation reports, are transmitted via SCTP or TCP-based control channels, ensuring reliable core network coordination. Virtualized backhaul options, including SDN (Software-Defined Networking) or NFV (Network Function Virtualization), dynamically route blocks based on RAN load forecasts, while time-sensitive networking (TSN) guarantees deterministic latency for validity-period-bound data. This flexible backhaul framework ensures seamless integration with heterogeneous network infrastructures, from centralized cloud cores to distributed edge compute nodes.

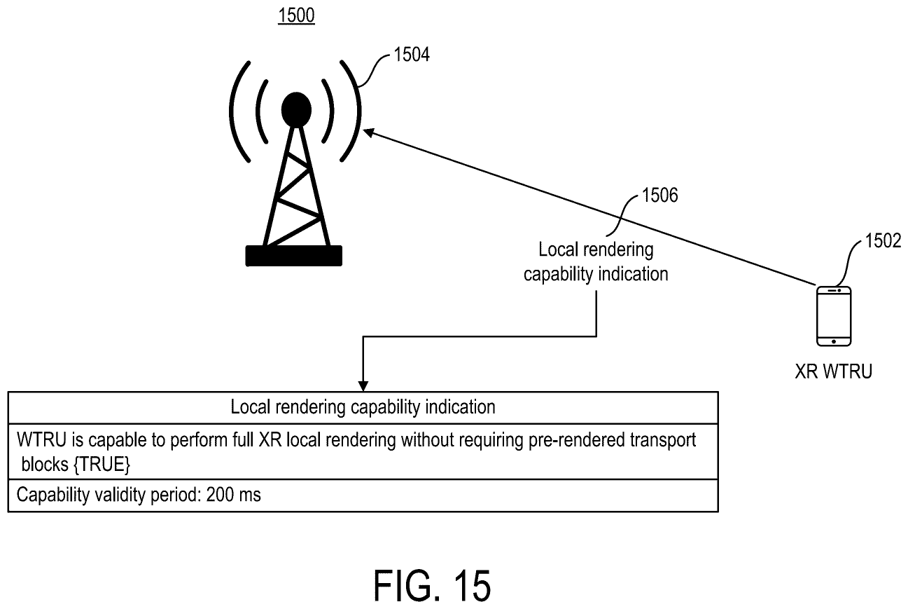

FIG. 15 is a system diagram 1500 which shows a Radio Access Network (RAN) node 1504 receiving explicit local rendering capability indications 1506 from active Extended Reality (XR) Wireless Transmit/Receive Units (WTRUs) 1502. These indications 1506 may be transmitted via standardized signaling mechanisms, such as Uplink Control Information (UCI) on the physical uplink control channel (PUCCH) or Radio Resource Control (RRC) signaling during session establishment or reconfiguration. The local rendering capability indication specifies whether a WTRU can perform full XR rendering locally (e.g., generating 3D scenes autonomously), partial rendering (e.g., requiring supplemental pre-rendered data from the network), or no local rendering (e.g., fully dependent on network-delivered content). For example, a WTRU equipped with a high-performance GPU may signal “full local rendering” via a 1-bit flag in a dedicated field, while a low-capability device may use RRC signaling to report “no local rendering,” triggering prioritized delivery of pre-rendered transport blocks.

The structure of these capability indications is optimized for efficiency and flexibility. In one embodiment, dynamic control information based signaling employs a compact format—such as a 1-bit flag or multi-bit enumerated field—to minimize overhead while enabling real-time updates. For instance, a WTRU transitioning from full to partial rendering due to battery depletion may dynamically update its capability via a UCI message in an uplink grant. Conversely, RRC signaling supports richer parameterization, such as specifying maximum tolerable rendering latency, supported texture resolutions, or available computational resources. This dual-layer signaling ensures seamless adaptation to varying device states and network conditions.

The RAN node processes these capability indications to categorize WTRUs into distinct rendering tiers. For example, WTRUs with full local rendering are excluded from pre-rendered traffic scheduling during congestion, while those with partial or no capabilities are prioritized. The RAN node stores these categorizations in a local database, cross-referencing them with pre-rendered transport block timestamps and pose inputs to optimize scheduling decisions. By integrating device capability awareness into radio resource management, the RAN node avoids overloading the network with redundant pre-rendered payloads for capable devices, thereby mitigating congestion and preserving downlink capacity for critical traffic.

Specifically, the RAN node prioritizes traffic delivery by categorizing active XR WTRUs into distinct rendering tiers-full local rendering, partial local rendering, and no local rendering- and dynamically aligning resource allocation with these capabilities. For WTRUs with full local rendering, the RAN node suppresses pre-rendered transport block transmission during any of the detected congestion periods, instead triggering on-device rendering via DCI commands to conserve downlink resources. WTRUs with partial local rendering receive prioritized supplemental transport blocks (e.g., scene deltas, dynamic object trajectories) synchronized with pose inputs embedded in DCIs, enabling them to composite final scenes using local and network-derived data. WTRUs with no local rendering receive full pre-rendered blocks as top priority, resource scheduling wise, ensuring uninterrupted service. The RAN node further cross-references timestamps of buffered blocks with congestion time instants, prioritizing blocks whose validity periods (start/end slot/symbol) overlap with anticipated congestion. Blocks nearing expiration are scheduled first, while misaligned blocks (e.g., pose predictions deviating from real-time WTRU feedback) are discarded. This capability-aware, timestamp-driven prioritization ensures radio resources are allocated to critical payloads for dependent devices, minimizing redundant transmissions and preserving downlink capacity. The RAN node dynamically adjusts prioritization in response to real-time updates (e.g., changes in WTRU battery levels or rendering capabilities), ensuring optimal balance between network efficiency and XR quality of experience (QoE).

The local rendering capability indication may be reported statically or in another case, being dynamically updated during active XR sessions to reflect real-time device conditions. For instance, a WTRU may initially signal “full local rendering” but later downgrade to “partial” due to thermal throttling or battery constraints, transmitting an updated indication via Uplink Control Information (UCI) or RRC signaling. The RAN node responds by adjusting its scheduling strategy—e.g., beginning delivery of supplemental pre-rendered blocks to the device while gradually reducing reliance on its local rendering pipeline. This dynamic coordination ensures uninterrupted XR experiences despite fluctuating device capabilities.

Furthermore, the RAN node leverages these capability indications to coordinate with core network entities. For example, upon receiving a “no local rendering” indication, the RAN node signals the core network (e.g., serving gateway, edge servers, or IMS) to prioritize pre-rendered block generation for the corresponding WTRU, ensuring timely delivery of high-priority scene data. Conversely, for WTRUs with full local rendering, the RAN node suppresses non-essential pre-rendered traffic, which implies the transport blocks that are destined for devices of full local rendering capability during detected congestion periods, reducing backhaul load and radio interface congestion. This cross-layer synergy between device capabilities, RAN scheduling, and core network rendering workflows forms the foundation of the application's efficiency gains, enabling scalable XR service delivery over resource-constrained wireless networks.

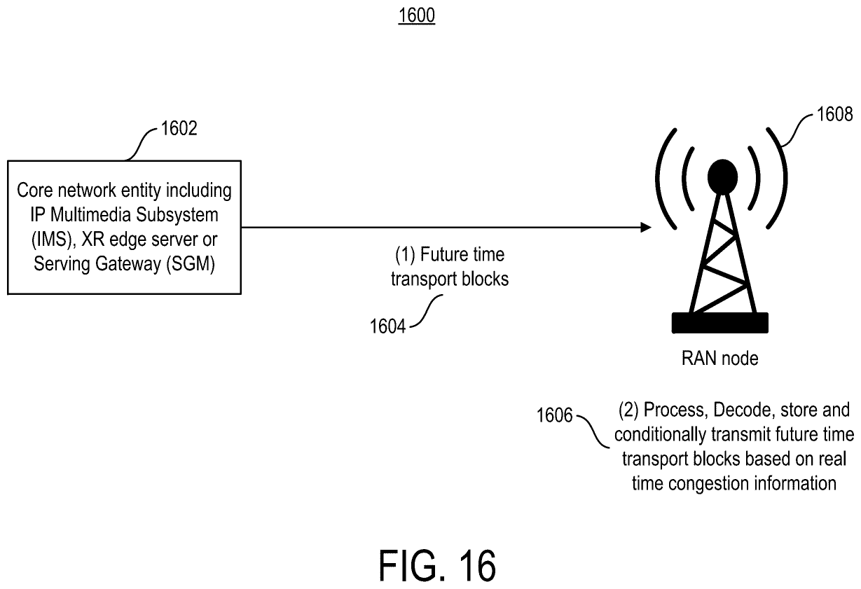

FIG. 16 is a system diagram 1600 which depicts the Radio Access Network (RAN) node 1608 receiving pre-rendered transport blocks 1604 from a core network entity 1602, such as an edge rendering server or centralized unit, via backhaul interfaces (e.g., X2, XN, or S1 links). These blocks 1604 contain scene data precomputed for active Extended Reality (XR) Wireless Transmit/receive Units (WTRUs), such as 3D frames, textures, or object meshes, tailored to anticipated user movements. Each transport block may be associated with a timestamp defining its validity period through explicit start and end slot/symbol instants, which align with the XR session's motion-to-photon latency requirements. For example, a block timestamped with a start instant at slot N and an end instant at slot N+5 should be transmitted within this five-slot window to ensure coherent rendering at the WTRU. Additionally, the blocks include XR pose inputs, such as predicted head orientation angles, gaze direction vectors, and hand position coordinates, which are synchronized with the timestamp to guide scene assembly at the device.

Upon reception, the RAN node stores 1606 the pre-rendered transport blocks in a local buffer, organized hierarchically by WTRU identifier, timestamp validity, and pose input metadata. The buffer employs priority queuing to ensure blocks nearing their end slot/symbol instants are scheduled first, minimizing rendering disruptions due to expired data. For instance, a block with an end instant at slot N+2 is prioritized over a block ending at slot N+10. The RAN node further validates the alignment between the timestamped pose inputs and real-time pose updates received from the WTRU. If a pre-rendered block's predicted pose deviates significantly from the WTRU's actual pose (e.g., exceeding a 10-degree head orientation tolerance), the block is discarded to avoid visual artifacts, and the core network is signaled to regenerate an updated block.

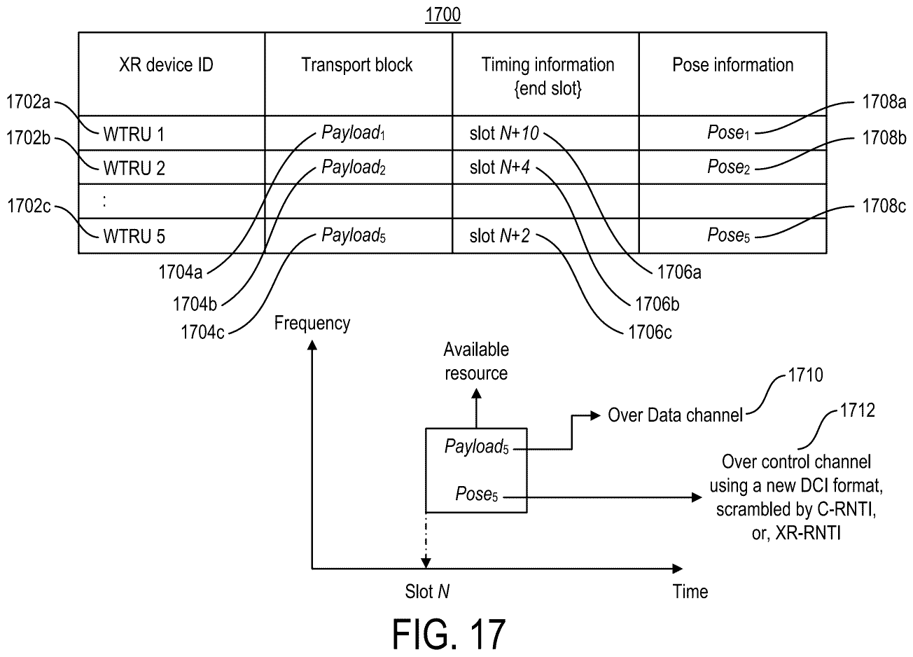

FIG. 17 depicts a scenario 1700 involving five active XR WTRUs 1702a-1702c, where the RAN node receives multiple pre-rendered transport blocks 1704a-1704c for each device 1702a-1702c, each associated with timestamps 1706a-1706c (start/end slot/symbol instants) and XR pose inputs 1708a-1708c. The RAN node calculates an anticipated congestion time instant (e.g., slot N) by analyzing the average input packet rate (pre-rendered blocks received) against the average scheduling packet rate (blocks transmitted) and available downlink capacity. Upon identifying congestion, the RAN cross-references timestamps of all buffered blocks to determine overlapping validity periods with the congestion instant. For example, Device 1's blocks are valid to N+10), while Device 5's blocks (valid to N+2) expire closest to the congestion instant.

Given the limited available capacity, the RAN node prioritizes Device 5 1702c, whose timestamped validity period is shortest and nearest to the congestion instant, as its blocks cannot tolerate scheduling delays without expiration. Device 5's blocks 1710 are transmitted first, with pose inputs 1712 embedded in DCIs for time-coherent rendering.

The core network entity generates pre-rendered transport blocks using machine learning models trained on historical user behavior (e.g., gaze patterns, locomotion trends) or real-time sensor analytics. For example, a WTRU's tendency to turn right in a virtual environment triggers the core network to pre-render rightward scene variations, tagged with timestamps corresponding to predicted movement windows. The RAN node, upon receiving these blocks, cross-references their timestamps with anticipated congestion time instants—periods where downlink capacity is projected to be insufficient—to determine which blocks are critical for transmission. During non-congestion periods, over which a negative difference of the input and scheduling payload rate is not anticipated, the RAN node transmits blocks indiscriminately, but as congestion approaches, it selectively discards blocks for WTRUs capable of local rendering, conserving resources for devices reliant on network-assisted rendering.

The timestamp mechanism also enables dynamic validity period adjustments. If the core network detects low confidence in its pose predictions (e.g., due to erratic user movement), it shortens the validity period of subsequent blocks, reducing their end slot/symbol instants. The RAN node responds by tightening its scheduling windows, ensuring only high-confidence blocks are buffered. Conversely, high-prediction confidence extends validity periods, allowing the RAN node to aggregate and transmit blocks in bulk during low-congestion intervals. This symbiotic coordination minimizes redundant transmissions while maintaining rendering continuity.

The RAN node continuously monitors the local buffer for expiring pre-rendered blocks. If a block's end slot/symbol instant passes without transmission, it is automatically flushed, and a local rendering fallback command is triggered. This command, embedded in a Downlink Control Information (DCI) message, instructs the WTRU to generate the scene locally using cached assets and the latest pose inputs. For example, a WTRU receiving a fallback command at slot N+6 (after its pre-rendered block expired at slot N+5) uses locally stored 3D models and the most recent pose data to render the scene, ensuring uninterrupted immersion. The RAN node simultaneously notifies the core network of the flushed block, prompting regeneration with updated timestamps and pose predictions.

The DCI format for triggering local rendering fallback comprises dedicated fields to encode rendering commands, synchronization parameters, and pose inputs. For individual XR WTRUs, the DCI utilizes a C-RNTI (Cell Radio Network Temporary Identifier) to scramble its cyclic redundancy check (CRC), ensuring the command is uniquely addressed to a specific device. The DCI payload includes: a 1-bit local rendering activation flag to signal the transition to on-device rendering. Quantized pose input fields (e.g., 16 bits for head orientation quaternions, 10 bits for gaze direction angles) compressed using fixed-point arithmetic. A synchronization marker (e.g., 4-bit slot/symbol index) aligned with the flushed pre-rendered block's original start instant, ensuring temporal coherence. Optional resource allocation fields (e.g., RBG bitmap) for supplemental data transmission, if partial blocks are permitted.

For group-based scenarios, where multiple WTRUs share similar rendering capabilities, the DCI employs a group-RNTI (e.g., XR-RNTI) to address a predefined subset of devices. The group DCI includes a masked identifier field (e.g., 8-bit bitmap) to map the command to specific WTRUs within the group, enabling efficient multicast signaling. The DCI size is dynamically adjusted based on the rendering tier (full/partial/none), with partial-capability WTRUs receiving additional fields for scene delta offsets or texture resolution parameters.

The RAN node configures the DCI format via RRC signaling during XR session establishment, tailoring field lengths of fields described herein and RNTI types (C-RNTI, group-RNTI) to device capabilities and network load. For example, a WTRU with partial rendering receives a DCI format 2_1 extension containing pose deltas and synchronization markers, while a full-capability device receives a compact DCI format 0_1 with only the activation flag. This adaptive DCI framework ensures minimal overhead while maintaining precise control over XR rendering transitions during congestion.

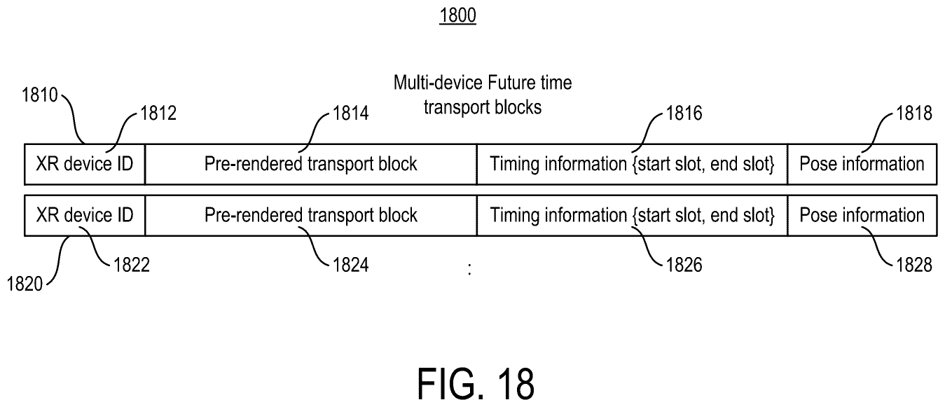

FIG. 18 illustrates the pre-rendered transport blocks 1800 received by the Radio Access Network (RAN) node from the core network entity, and which are structured to encapsulate both scene data and predictive metadata essential for synchronized Extended Reality (XR) rendering. Each block 1810, 1820 comprises an XR device ID 1812, 1822 and includes a pre-rendered transport block 1814, 1824 having XR scene content-such as 3D object geometries, textures, lighting parameters, or audio-visual elements-precomputed based on anticipated user interactions. These blocks are enriched with XR pose inputs 1818, 1828, which comprise a time-sequenced series of predicted head orientations, hand movements, and gaze directions mapped to a spatial coordinate system (e.g., Cartesian or spherical coordinates). For example, a transport block valid from slot N to N+5 may include a sequence of head rotation quaternions and hand position vectors sampled at each slot interval, synchronized with the block's timestamp to ensure temporal alignment during rendering. These pose inputs are derived from machine learning models analyzing historical user behavior, sensor telemetry, or real-time gaze analytics, enabling the core network to simulate probable user trajectories and pre-render corresponding scenes. Each block 1810, 1820 comprises timing information 1816, 1826.

To account for uncertain user behavior, the pre-rendered transport blocks include multiple scene variations, each representing a probabilistic outcome of user actions. For instance, a block may contain a “primary” scene variation depicting a user turning left (70% prediction confidence), a “secondary” variation for a right turn (25% confidence), and a “fallback” static scene (5% confidence). Each variation is tagged with metadata indicating its priority level, likelihood of occurrence, and prediction confidence. The RAN node leverages this metadata during congestion to optimize downlink resource usage. For example, if the available capacity suffices only for one variation, the RAN selects the highest-priority scene (e.g., the 70% confidence left turn) for transmission, discarding lower-priority variants. This selective transmission minimizes bandwidth waste while maintaining scene plausibility, as statistically improbable variations are suppressed unless surplus capacity exists.

The computation of probabilistic user behavior outcomes and associated confidence levels for pre-rendered scene variations is performed by core network entities (e.g., edge rendering servers, XR application servers) or dedicated machine learning (ML) inference nodes integrated within the network architecture. These nodes analyze multi-modal input streams, including historical user interaction patterns (e.g., gaze trajectories, movement habits), real-time sensor telemetry (e.g., head orientation, hand gestures reported via uplink signaling), and environmental context data (e.g., virtual scene topology, collaborative user positions). For instance, an edge server hosting a multiplayer XR game aggregates anonymized historical data from similar user sessions to train reinforcement learning models, predicting likely navigation paths with confidence scores. Real-time inputs, such as a WTRU's instantaneous velocity or abrupt head movement detected via inertial measurement units (IMUs), refine these predictions dynamically. The core network fuses these data streams using Bayesian inference or neural networks, assigning probability weights to each scene variation (e.g., 70% left turn, 25% right turn). These probabilities are embedded as metadata within pre-rendered transport blocks, alongside timestamps and pose inputs, and transmitted to the RAN node via backhaul interfaces (e.g., HTTP/2, RTP). The RAN node leverages this metadata without reprocessing the raw behavioral data, ensuring low-latency prioritization during congestion. Input data is sourced from WTRU-originated uplink reports, session history databases, and cross-service APIs (e.g., retrieving weather conditions for augmented reality overlays), with privacy safeguards (e.g., differential privacy) applied to anonymize sensitive user metrics.

The pose inputs and scene variations are tightly synchronized with the transport block's timestamp-defined validity period. For example, a head orientation sequence spanning slots N to N+5 is mapped to corresponding frame indices in the pre-rendered scene data, ensuring that each pose update aligns with the correct visual frame during playback. The RAN node validates this synchronization by cross-referencing the timestamp's start/end instants with real-time pose updates reported by the XR WTRU. If a mismatch exceeding a predefined threshold (e.g., a 15-degree deviation in gaze direction) is detected, the block is flagged as misaligned and discarded. The core network is then notified to regenerate an updated block with refined pose predictions, maintaining rendering continuity.

During congestion, the RAN node employs the priority tiers embedded in multi-variant blocks to dynamically throttle scene complexity. For example, if downlink capacity drops below a threshold, the RAN may transmit only low-resolution textures or simplified geometries from the highest-priority scene variation, discarding high-fidelity assets tagged as non-critical. Conversely, under ample capacity, supplemental variations (e.g., enhanced lighting effects or secondary viewpoint renders) are included to enrich immersion. This granular control over scene content ensures that radio resources are allocated proportionally to both user experience requirements and network constraints, resolving the inherent trade-off between XR quality and bandwidth efficiency.

Moreover, for XR WTRUs with partial local rendering capabilities, the pre-rendered blocks are designed as scene deltas-differences between locally generated content and network-predicted scenes. For instance, a WTRU rendering a static background locally may receive a pre-rendered block containing only dynamic foreground objects (e.g., avatars, interactive elements) synchronized with pose inputs. These elements may be received from an edge XR server, IMS or serving gateway in embodiments. The RAN node embeds these deltas and pose sequences into DCI, enabling the WTRU to composite (e.g. final) scenes with minimal latency. By decoupling static and dynamic elements, the application reduces payload sizes while preserving the benefits of both network-assisted and local rendering.

The Radio Access Network (RAN) node calculates average input packet rate and average scheduling packet rate across all active Extended Reality (XR) Wireless Transmit/receive Units (WTRUs) to quantify network load dynamics. The input packet rate is computed as the total number of pre-rendered transport blocks received from the core network per unit time (e.g., packets/second), measured over a sliding time window (e.g., 100 milliseconds). This rate reflects the volume of incoming XR traffic generated by edge rendering servers. Concurrently, the scheduling packet rate is derived from the number of transport blocks successfully transmitted to XR WTRUs via the data channel (e.g., PDSCH) within the same time window. A weighted averaging filter is applied to both rates, prioritizing recent measurements (e.g., 80% weight to the last 50 ms) to capture real-time fluctuations in XR session activity. For example, a sudden surge in pre-rendered blocks from the core network (e.g., during a multiplayer XR game event) increases the input rate, while radio interface bottlenecks (e.g., poor channel conditions) reduce the scheduling rate, creating a widening gap between the two.

To determine average available downlink capacity, the RAN node aggregates channel quality indicator (CQI) reports and modulation and coding scheme (MCS) indices from active XR WTRUs. Each WTRU's effective capacity is calculated based on its reported CQI (e.g., CQI index 12 corresponds to 64-QAM with a 0.7 code rate) and MCS, translating to achievable data rates under current channel conditions. These per-device capacities are summed to compute the total available downlink capacity, with a guard band margin (e.g., 15%) subtracted to account for potential interference or sudden channel degradation. For instance, if the aggregate capacity is 100 Mbps, the guard band reduces it to 85 Mbps, reserving resources for retransmissions or emergency signaling. This conservative approach ensures robustness against real-world radio variability.

Anticipated congestion time instants are identified by analyzing the divergence between input and scheduling rates relative to the available capacity. The RAN node extrapolates the difference between the two rates over a sliding time window (e.g., 200 ms) using linear regression or machine learning models trained on historical congestion patterns. When the extrapolated difference exceeds the average available downlink capacity, the earliest slot/symbol index where this occurs is flagged as the congestion time instant. For example, if the input rate is projected to exceed the scheduling rate by 20 Mbps at slot N+10, and the available capacity is only 15 Mbps, slot N+10 is identified as the congestion point. This predictive mechanism enables proactive mitigation, such as preemptively flushing non-critical pre-rendered blocks or prioritizing traffic for latency-sensitive WTRUS.

By proactive capacity estimation, and congestion prediction, the RAN node dynamically balances rendering quality and radio efficiency. During non-congestion periods, surplus capacity is allocated to high-resolution pre-rendered blocks or secondary scene variations. As congestion approaches, the node throttles non-essential traffic (e.g., background textures for locally rendering-capable devices) and reserves resources for critical payloads (e.g., foreground objects for network-dependent WTRUs). This closed-loop control ensures motion-to-photon latency thresholds are maintained even under volatile network conditions. For instance, in a congested cell serving 50 XR devices, the RAN node selectively discards 30% of low-priority pre-rendered blocks, preserving capacity for the remaining 70% critical data and avoiding systemic rendering failures.

The RAN node continuously recalibrates its calculations using incremental updates. For example, a sudden improvement in channel quality (e.g., a WTRU moving closer to the base station) triggers an upward adjustment of available capacity, delaying or canceling a predicted congestion event. Conversely, a spike in input rate (e.g., a burst of pre-rendered blocks for a new XR user) shortens the time to congestion, prompting earlier intervention. If a congestion instant is unavoidable, the node activates fallback protocols, such as instructing capable WTRUs to render locally using embedded pose trajectories in DCIs, while reserving residual capacity for incapable devices. This adaptive framework ensures uninterrupted XR experiences while maximizing spectral efficiency, resolving the historical trade-off between immersive quality and network sustainability.

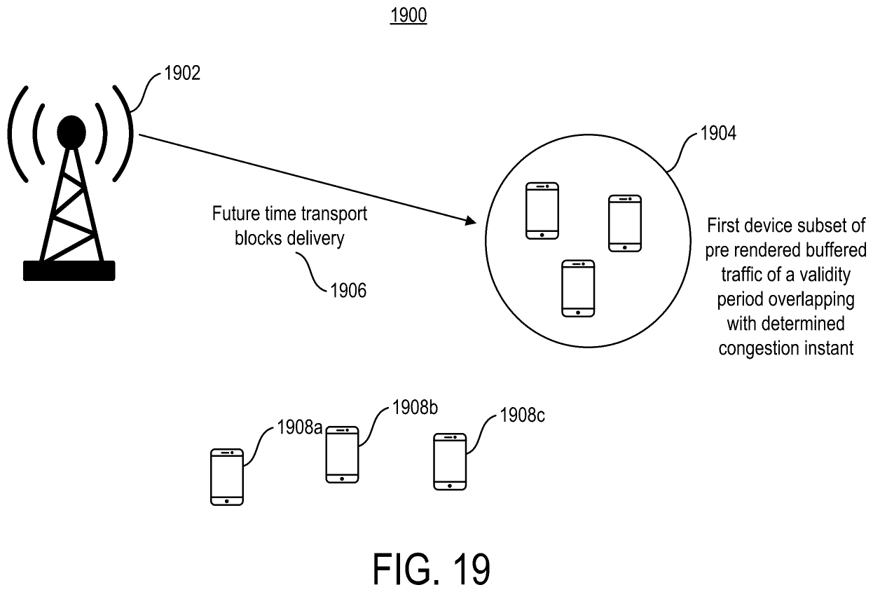

FIG. 19 is a system diagram 1900 that shows a Radio Access Network (RAN) node 1902 selecting a first subset of active Extended Reality (XR) Wireless Transmit/receive Units (WTRUs) 1904 by identifying pre-rendered transport blocks whose timestamps overlap with an anticipated congestion time instant. Each pre-rendered block 1906 is tagged with a timestamp defining its validity period via explicit start and end slot/symbol instants. For example, a block valid from slot N+2 to N+7 is considered overlapping with a congestion time instant predicted at slot N+5, as the congestion occurs within the block's validity window. The RAN node scans its local buffer to isolate blocks where the congestion time instant lies between their start and end instants, ensuring only time-critical data is prioritized for transmission. This timestamp-driven filtering guarantees that pre-rendered scenes remain relevant to the user's real-time pose and context during congestion, avoiding outdated or premature payloads that could cause visual discontinuities. Other WTRUs 1908a-1908c may be non-active.

The selection process hinges on precise alignment between congestion prediction and timestamped validity periods. The RAN node cross-references the congestion time instant—calculated from packet rate differentials and downlink capacity—with the start/end instants of all buffered blocks. For instance, if congestion is anticipated at slot N+10, the node selects blocks with timestamps such as [N+8, N+12] or [N+9, N+11], where the congestion instant falls within their validity windows. Blocks with narrower windows (e.g., [N+10, N+11]) are prioritized over those with broader ranges (e.g., [N+5, N+15]), as their expiration is imminent and their scene data is temporally precise. This prioritization minimizes the risk of transmitting expired blocks, which would otherwise waste radio resources and necessitate retransmissions.

Specifically, The RAN node prioritizes transmission of pre-rendered transport blocks by categorizing buffered blocks into distinct groups based on their timestamped validity windows relative to the anticipated congestion time instant. As an example, blocks are classified as: Category A: Blocks where the congestion time instant T_c occurs within the first 30% of their validity window (e.g., T_c∈[T_start, T_start+0.3(T_end−T_start)), indicating high temporal relevance. Category B: Blocks where T_c occurs in the middle 40% of their validity window (e.g., T_c∈[T_start+0.3 (T_end−T_start), T_start+0.7 (T_end−T_start))), indicating moderate relevance. Category C: Blocks where T_c occurs in the final 30% of their validity window (e.g., T_c∈[T_start+0.7 (T_end−T_start), T_end)), indicating imminent expiration.

The RAN node first transmits Category C blocks (e.g., validity window [N+10, N+11] for a detected congestion instant at N+10.5), as their expiration is nearest. It subsequently transmits Category A blocks (e.g., validity window [N+8, N+12]) to preemptively address upcoming congestion instant. Category B blocks (e.g., validity window [N+9, N+13]) are deferred until post-congestion periods unless capacity permits earlier transmission. Within each category, blocks are further prioritized by ascending T_end (earliest expiration first). Blocks with validity windows entirely outside the congestion instant (e.g., [N+5, N+7] during congestion at N+10) are retained in the buffer until their T_start approaches or discarded if their T_end lapses. This hierarchical prioritization ensures that the RAN node transmits Block A (e.g., high-priority, narrow window) before Block B (e.g., lower-priority, broader window), with explicit support for suppressing non-critical data (e.g., deferring Block B to slot N+12). Deferred blocks are either transmitted post-congestion or flushed with local rendering triggers, ensuring resource efficiency and claimable adherence to timestamp-driven scheduling.

By restricting the first subset to timestamp-overlapping blocks, the RAN node ensures that pre-rendered scenes are delivered within their validity periods, synchronizing with the XR WTRU's rendering pipeline. For example, a block valid from slot N+3 to N+6 containing predicted head orientations for a virtual turn is transmitted just in time for the WTRU to display the scene at slot N+4, aligning with the user's actual movement. This synchronization avoids motion-to-photon latency violations caused by late deliveries, where delayed blocks would force the WTRU to either stall rendering or display misaligned content. The RAN node further validates the pose inputs embedded in selected blocks against real-time pose updates from the WTRU, discarding blocks with deviations exceeding a tolerance threshold (e.g., >15% positional error) to prevent visual artifacts.

Therefore, the RAN node organizes its buffer hierarchically, grouping blocks by WTRU identifier and sorting them by end slot/symbol instants. During subset selection, blocks closest to expiration are flagged as high-priority, ensuring they are scheduled first. For instance, in a buffer containing blocks expiring at slots N+5, N+6, and N+8 for the same WTRU, the block ending at N+5 is prioritized if congestion occurs at N+5. This approach optimizes buffer utilization, reducing the likelihood of non-transmitted blocks expiring and triggering fallback mechanisms. By selectively transmitting only overlapping blocks, the RAN node minimizes redundant traffic, freeing capacity for other critical data flows and mitigating congestion escalation.

The core network entity generates pre-rendered blocks with timestamps calibrated to predicted user behavior, ensuring their validity periods align with probable interaction windows. The RAN node leverages these predictions during subset selection—for example, prioritizing blocks tagged for high-confidence scenarios (e.g., 90% predicted forward movement) over low-confidence edge cases (e.g., 10% predicted lateral shift). If congestion timing shifts due to dynamic network conditions (e.g., sudden capacity loss), the RAN node re-evaluates block validity windows in real time, discarding obsolete blocks and requesting updated predictions from the core network. This closed-loop coordination ensures timestamp relevance, balancing predictive accuracy with radio efficiency to sustain immersive XR experiences under constrained resources.

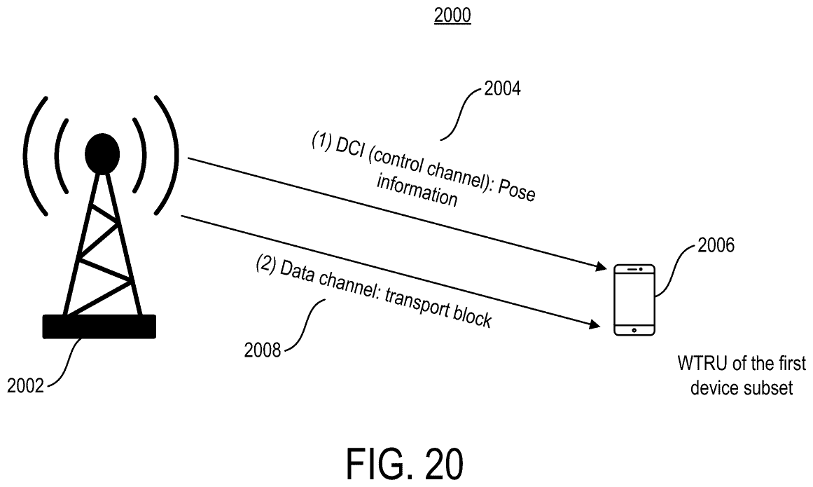

FIG. 20 is a diagram 2000 that shows the Radio Access Network (RAN) node 2002 encoding the Extended Reality (XR) pose inputs-including head orientation, gaze direction, and hand position-into a compressed binary format within dedicated fields of DCI 2004 for receipt by a WTRU 2006. This compression leverages quantization techniques to minimize overhead while preserving rendering fidelity. For example, head orientation is represented as a quaternion (four-dimensional vector) quantized into 16 bits by mapping continuous rotation values to a fixed-point scale, while gaze direction is encoded using spherical coordinates (azimuth and elevation angles) compressed into 10 bits. Hand positions, defined as 3D Cartesian coordinates, are similarly quantized using fixed-point arithmetic, reducing each axis to 8 bits. This structured encoding ensures pose data occupies minimal DCI payload space, enabling efficient transmission alongside scheduling grants on the physical downlink control channel (PDCCH).

To ensure temporal alignment between pre-rendered transport blocks 2008 and device-side rendering, the DCI 2004 includes a synchronization marker explicitly tied to the start slot/symbol instant of the associated block. This marker, implemented as a unique bit sequence (e.g., a 4-bit identifier), signals the XR WTRU to reset its rendering pipeline and synchronize scene assembly with the timestamped validity period of the incoming transport block. For instance, a DCI scheduling a block valid from slot N+3 to N+7 includes a synchronization marker aligned with slot N+3, instructing the WTRU to begin processing the block's pose inputs and scene data precisely at that slot. This mechanism eliminates jitter caused by misaligned frame processing, ensuring smooth visual transitions even under network latency fluctuations.

Upon receiving the DCI, the XR WTRU decodes the compressed pose inputs and synchronization marker, aligning them with its internal rendering cycle. For instance, a WTRU processing a block starting at slot N+5 uses the synchronization marker to schedule GPU operations precisely at N+5, ensuring scene updates coincide with the predicted pose trajectory. The quantized pose values are decompressed into floating-point coordinates, with interpolation algorithms smoothing minor discontinuities caused by compression. In hybrid rendering scenarios, the WTRU combines these network-derived poses with locally tracked sensor data (e.g., IMU readings) to refine scene accuracy, leveraging the DCI's pose inputs as a predictive baseline.

Embedding pose data directly into DCI eliminates the need for separate application-layer signaling, slashing motion-to-photon latency. For example, a WTRU receiving pose inputs in the same DCI as its scheduling grant can immediately decode and forward the data to its rendering engine, bypassing higher-layer processing delays. This integration is critical for time-sensitive XR applications, such as multiplayer gaming or industrial simulations, where sub-millisecond synchronization is paramount. Furthermore, the RAN node prioritizes DCIs with pose data for latency-critical WTRUs during congestion, ensuring uninterrupted immersion despite radio resource constraints.

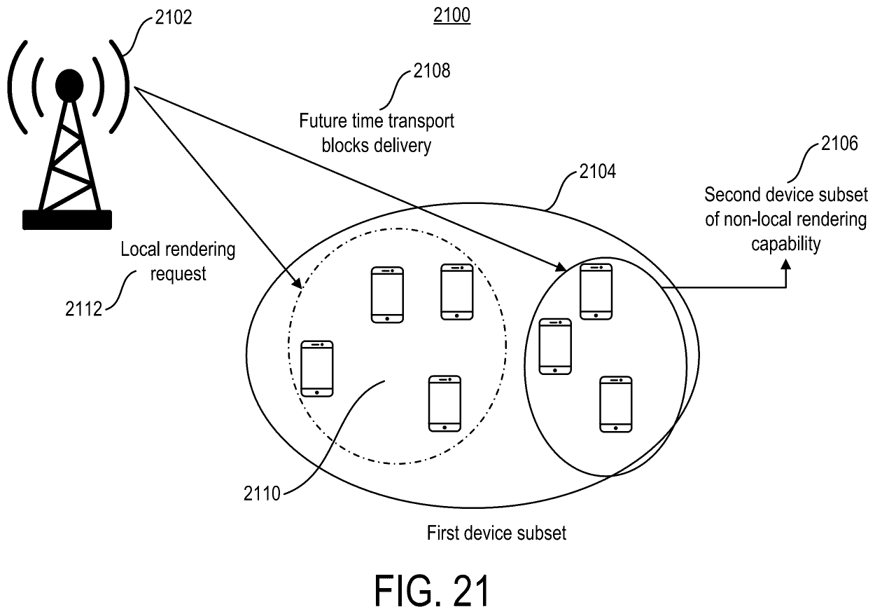

FIG. 21 is a system diagram 2100 that depicts an example where the average available downlink capacity is insufficient to accommodate the aggregate size of buffered transport blocks for the first subset of XR WTRUs. Accordingly, the Radio Access Network (RAN) node 2102 selects a second subset of WTRUs 2106 from the first subset 2104, prioritizing devices with partial local rendering capabilities. These WTRUs 2106 require supplemental pose-embedded control information to complete scene generation, such as dynamic object trajectories or contextual overlays that cannot be rendered locally. For example, a WTRU capable of rendering static backgrounds but dependent on network-provided avatars receives pre-rendered avatar movement sequences synchronized with pose inputs embedded in Downlink Control Information (DCI). The RAN node transmits only these critical blocks 2108 to the second subset, minimizing payload size while ensuring seamless scene compositing. Devices 2110 with full local rendering capabilities are excluded from the second subset, as they can generate scenes autonomously without network assistance. Devices 2110 may receive a local rendering request 2112.

The RAN node flushes buffered transport blocks for the remaining WTRUs 2110 in the first subset (those not in the second subset) only after receiving an acknowledgment via Uplink Control Information (UCI) confirming local rendering activation. For instance, a WTRU with full local rendering capabilities transmits a 1-bit UCI flag within a 50 ms window to signal successful activation of its rendering pipeline. If no acknowledgment is received within this window, the RAN node retransmits the flushing command or escalates to a higher-layer protocol (e.g., RRC reconfiguration) to enforce the transition. This conditional flushing prevents data loss for devices that fail to activate local rendering, ensuring continuity in XR experiences.

After flushing buffered blocks, the RAN node transmits a flush notification to the core network entity, identifying the discarded blocks by their timestamps, WTRU identifiers, and associated pose inputs. This notification triggers the core network to regenerate updated pre-rendered blocks tailored to the WTRUs' revised pose predictions. For example, if a flushed block was originally generated for a predicted head movement at slot N+5, but the WTRU's real-time pose indicates a deviation, the core network produces a corrected block valid from slot N+6 to N+9. The RAN node prioritizes these regenerated blocks during subsequent scheduling cycles, aligning them with refreshed congestion predictions to avoid recurring bottlenecks.

For WTRUs 2106 in the second subset with partial capabilities, the RAN node transmits minimal scene deltas alongside pose-embedded DCIs. These deltas contain only the differences between locally rendered content and the network's pre-rendered scenes. For example, a WTRU rendering a virtual room locally receives delta blocks with real-time lighting updates or interactive object movements, synchronized via DCI timestamps. The RAN node further embeds synchronization markers in these DCIs, ensuring the WTRU aligns delta integration with its rendering cycle. This hybrid approach reduces bandwidth consumption while maintaining visual coherence, even under constrained capacity.

The flush notification transmitted to the core network includes real-time pose feedback metrics from the WTRU, such as deviations in head orientation across predefined spatial axes (e.g., yaw, pitch, roll) and positional offsets in 3D coordinates (x, y, z). For instance, if the WTRU's actual head orientation diverges from the pre-rendered block's prediction by 20 degrees in the yaw axis (x-direction), 15 degrees in the pitch axis (y-direction), or 10 degrees in the roll axis (z-direction), the core network triggers an adjustment to its machine learning model. These thresholds are configurable per application (e.g., 5-degree tolerance for surgical simulations vs. 25 degrees for gaming) and dynamically adapt based on scene criticality. The core network computes deviations using quaternion or Euler angle comparisons between predicted and reported poses, weighting axial errors (e.g., higher sensitivity to yaw in navigation-heavy XR scenarios). Subsequent regenerated blocks incorporate axis-specific corrections—e.g., recalibrating yaw prediction weights in the model—to reduce future mismatches. For positional offsets, deviations exceeding 30 cm in the x/y plane or 15 cm in the z-axis (depth) trigger similar refinements. This granular, axis-aware feedback loop ensures prediction models evolve to reflect user behavior nuances, minimizing redundant flushing and optimizing pre-rendered content relevance.

Finally, a local rendering request 2112 is transmitted to flushed WTRUs which includes a fallback quality parameter (e.g., resolution, frame rate) dynamically adjusted based on the severity of congestion. For example, under a moderate congestion condition, where the available radio resource size fulfils a predefined range, WTRUs may render scenes at 720p resolution, while severe congestion triggers a drop to 480p. The RAN node monitors device compliance via periodic UCI reports, intervening with corrective DCIs if rendering quality deviates from network quality of service targets. This tiered fallback strategy balances immersion preservation with radio resource conservation, ensuring scalable XR service delivery across diverse network states.

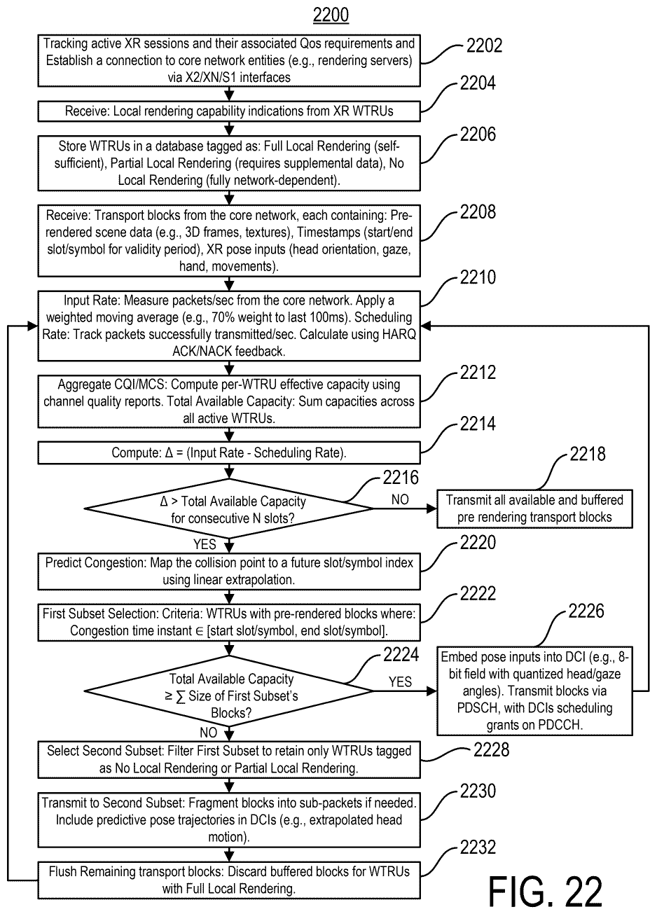

FIG. 22 shows a timeline 2200 for the Radio Access Network (RAN) node to execute the multi-step process to manage Extended Reality (XR) traffic, beginning with initialization and data collection. The node monitors 2202 active XR sessions, receiving 2204 and storing 2206 local rendering capability indications from Wireless Transmit/receive Units (WTRUs) via uplink control information (UCI) or Radio Resource Control (RRC) signaling. These indications categorize devices into three tiers: full local rendering (autonomous scene generation), partial local rendering (requires supplemental network data), or no local rendering (fully network-dependent). Concurrently, the RAN node receives pre-rendered transport blocks 2208 from the core network via backhaul links (e.g., X2/Xn interfaces). Each block includes scene data (e.g., 3D frames, textures) and XR pose inputs (head orientation, gaze direction, hand movements), tagged with timestamps defining validity periods (start/end slot/symbol instants). The node stores these blocks in a prioritized buffer, organized by expiration time and WTRU identifier.

Next, the RAN node calculates network metrics 2210 to assess traffic dynamics. It computes the average input packet rate (pre-rendered blocks received/sec from the core network) and average scheduling packet rate (blocks successfully transmitted/sec to WTRUs), applying weighted averaging to prioritize recent data. The node also determines 2212 average available downlink capacity by aggregating channel quality indicator (CQI) reports and modulation and coding scheme (MCS) indices from WTRUs, subtracting a guard band margin (e.g., 15%) to account for interference. Using these metrics, the node predicts anticipated congestion time instants by extrapolating the difference between input and scheduling rates 2214 over a sliding window. If the projected rate differential exceeds 2216 available capacity at a future slot/symbol, congestion is flagged. Otherwise, all available buffered pre rendering transports blocks are transmitted 2218.

The RAN node employs a configurable sliding window mechanism to analyze traffic dynamics and predict congestion 2220, where the window duration is defined in units of time (e.g., milliseconds), slots, or symbols, depending on network deployment. The window size and granularity are dynamically adjusted based on RAN-layer conditions, such as observed traffic volatility, XR session density, or channel coherence time, or predefined via core network signaling (e.g., OAM policies). For instance, in high-mobility scenarios with rapid channel fluctuations, the RAN node shortens the window to 10 slots to prioritize recent rate measurements, while in stable environments, it extends to 50 slots to smooth transient noise. The core network may initialize default window parameters (e.g., 20 ms for eMBB services) via non-real-time OAM interfaces, while the RAN autonomously adapts the window in real time—e.g., scaling to 5 ms during sudden load spikes. Within the window, the RAN node computes moving averages of input/scheduling rates and extrapolates trends using linear regression or machine learning models trained on historical congestion patterns. This adaptive windowing ensures proactive congestion detection while balancing responsiveness (short windows) and stability (long windows), enabling precise alignment of mitigation actions with network dynamics.

During congestion mitigation, the RAN node selects a first subset 2222 of WTRUs whose pre-rendered blocks have timestamps overlapping with the predicted congestion instant. For example, blocks valid from slot N+5 to N+10 are prioritized if congestion occurs at N+7. If downlink capacity suffices to transmit all blocks in the first subset, the node schedules their delivery via the data channel (e.g., PDSCH), embedding synchronized pose inputs into Downlink Control Information (DCI). The DCI fields are compressed to include quantized head orientation, gaze direction, and hand position values, alongside a synchronization marker aligned with the block's start slot/symbol to ensure time-coherent rendering.

If capacity 2224 is sufficient, pose inputs may be embedded in DCI 2226. If capacity 2224 is insufficient, the RAN node selects 2238 a second subset from the first, prioritizing WTRUs with partial or no local rendering capabilities. For instance, a WTRU capable of rendering static backgrounds but needing network-provided dynamic objects receives priority. The node transmits 2230 blocks to this subset while flushing 2232 buffered blocks for remaining WTRUs (those with full local rendering). Flushing is conditioned on receiving acknowledgments via UCI, where WTRUs confirm local rendering activation within a predefined window (e.g., 50 ms). Unacknowledged WTRUs trigger retransmissions or RRC reconfiguration commands. Flushed blocks are reported to the core network, prompting regeneration of updated blocks with revised pose predictions.

The RAN node updates the core network with identifiers of flushed blocks and real-time pose feedback, enabling iterative refinement of pre-rendered content. The node dynamically recalculates network metrics, adjusting guard bands and retraining congestion prediction models based on historical data. For expired blocks, emergency local rendering is activated via DCI commands, instructing WTRUs to use cached assets and the latest pose inputs. The node continuously validates alignment between transmitted pose data and WTRU-reported poses, discarding misaligned blocks to prevent visual artifacts.

A radio access network (RAN) node for managing extended reality (XR) traffic may comprise a receiver for receiving, from one or more active XR wireless transmit/receive units (WTRUs), a local rendering capability indication via uplink control information (UCI) or radio resource control (RRC) signaling; the receiver may receive, from a core network entity via backhaul links, and storing one or more pre-rendered transport blocks for the one or more active XR WTRUs, each pre-rendered transport block associated with a timestamp indicating a start slot/symbol instant and an end slot/symbol instant, and one or more XR pose inputs; the RAN node may calculate an average input packet rate and an average scheduling packet rate across all active XR WTRUs and determine an average available downlink capacity based on channel quality reports received from the active XR WTRUs; the RAN may identify an anticipated congestion time instant when a difference between the average input packet rate and the average scheduling packet rate exceeds the average available downlink capacity; the RAN node may select a first subset of active XR WTRUs whose associated pre-rendered transport blocks have timestamps overlapping with the congestion time instant; on the condition of the average available downlink capacity equal or larger than the aggregate sum size of buffered transport blocks for the first device subset: the RAN node may schedule transmission of the buffered transport blocks to the first WTRU subset via a data channel, and the RAN node may embed respective XR pose inputs in DCIs scheduling the data channel; on the condition of the average available downlink capacity smaller than the aggregate sum size of buffered transport blocks for the first device subset: the RAN node may select a second subset of XR WTRUs from the first subset with WTRUs of the second subset associated with local rendering capabilities; the RAN node may transmit corresponding buffered transport blocks with pose-embedded control information; the RAN node may flush buffered transport blocks for remaining XR WTRUs in the first subset, and may transmit a local rendering request towards the remaining XR WTRUs.

The local rendering capability indication comprises a 1-bit flag transmitted in a dedicated field of the uplink control information (UCI) or radio resource signaling (RRC) signaling, the 1-bit flag explicitly indicating whether the respective XR WTRU is capable to perform full XR local rendering without requiring pre-rendered transport blocks from the RAN node.

The local rendering capability indication is dynamically updated by the XR WTRU during an active XR session, the update triggered by a change in available computational resources or battery level of the XR WTRU.

The local rendering capability indication differentiates between full XR local rendering and partial XR local rendering, wherein partial XR local rendering requires supplemental pre-rendered transport blocks from the RAN node to complete scene generation.

The pre-rendered transport blocks are generated by the core network entity based on predicted user behavior derived from historical movement patterns, gaze analytics, or machine learning models, the predicted user behavior corresponding to a scene rendering requirement anticipated during the timestamp-associated time period.

The timestamp further defines a validity period for the pre-rendered transport block, the validity period dynamically adjusted by the core network entity based on a calculated confidence level of the predicted user behavior associated with the transport block.

The one or more XR pose inputs embedded in the pre-rendered transport block include a sequence of predicted head orientations, hand movements, and gaze directions mapped to a spatial coordinate system, the sequence synchronized with the start slot/symbol instant and end slot/symbol instant of the timestamp.

The RAN node discards pre-rendered transport blocks upon expiration of their associated end slot/symbol instant, the expiration triggering a local rendering fallback instruction to the XR WTRU if the transport block remains unscheduled.

The pre-rendered transport blocks include multiple scene variations corresponding to probabilistic user behavior outcomes, each variation tagged with a priority level based on likelihood of occurrence and/or prediction confidence level, and wherein the RAN node selects a scene variation for scheduling and transmission based on the priority level and available downlink capacity.

The RAN node verifies alignment between the timestamp of a pre-rendered transport block and a current pose input received from the XR WTRU before scheduling transmission, discarding the transport block if misalignment exceeds a predefined tolerance threshold.

Calculating the average input packet rate and the average scheduling packet rate comprises applying a weighted averaging filter to prioritize recent packet flow measurements over historical measurements, the weighted averaging filter dynamically adjusted based on fluctuations in XR session activity.

Determining the average available downlink capacity further includes aggregating channel quality indicator (CQI) reports and modulation and coding scheme (MCS) indices from the active XR WTRUs, and subtracting a guard band margin to account for interference or sudden channel degradation.

Identifying the anticipated congestion time instant includes extrapolating the difference between the average input packet rate and the average scheduling packet rate over a sliding time window, the congestion time instant mapped to a future slot or symbol index where the extrapolated difference first exceeds the average available downlink capacity.

The average input packet rate is calculated as a total number of pre-rendered transport blocks received from the core network entity per millisecond or second, and the average scheduling packet rate is calculated as a total number of transport blocks successfully scheduled and transmitted via the data channel per millisecond or second.

Selecting the first subset of active XR WTRUs comprises identifying pre-rendered transport blocks whose timestamp includes the congestion time instant within a time window defined by the start slot/symbol instant and the end slot/symbol instant, such that the congestion time instant occurs during the validity period of the pre-rendered transport block.

Embedding the respective XR pose inputs in the downlink control information (DCI) comprises encoding the pose inputs into a compressed binary format within dedicated one or more DCI fields, the format including quantized values for head orientation, gaze direction, and hand position.

The DCIs embedding the XR pose inputs further include a synchronization marker aligned with the start slot/symbol instant of the pre-rendered transport block, ensuring time-coherent rendering at the XR WTRU.

Selecting the second subset of XR WTRUs comprises prioritizing WTRUs with partial local rendering capabilities, wherein the partial capabilities require supplemental pose-embedded control information to complete scene generation.

Flushing the buffered transport blocks for the remaining XR WTRUs is conditioned on receiving an acknowledgment from the respective WTRUs confirming activation of local rendering, the acknowledgment transmitted via uplink control information (UCI) within a predefined time window.

The RAN node transmits a pre-rendering transport block flush notification to the core network entity identifying the flushed buffered transport blocks, triggering regeneration of updated pre-rendered blocks for the remaining XR WTRUs based on revised pose predictions.

In mobile communication systems, handover procedures enable a wireless device (also referred to as a user equipment or UE) to transition its active connection from one serving cell or beam to another, ensuring service continuity during mobility. A successful handover is critical to maintain consistent user experience, reduce service interruption, and avoid dropped connections. As network deployments evolve to include dense heterogeneous topologies, high-speed mobility, and directional beamforming, the timing and accuracy of handovers become even more crucial.

Conventional handover mechanisms rely on the UE measuring signal quality metrics from neighboring cells or beams and reporting them to the radio access network (RAN), which then decides whether and when to initiate a transition. However, current specifications leave several aspects of early measurement and reporting behavior (i.e., triggering measurements proactively prior to pre-set hard triggers based on dynamic radio conditions) to device-specific implementation choices. These include ambiguities in how reference symbols are selected (e.g., based on sub-band full-duplex support), how channel state information (CSI) is derived (e.g., with varying demodulation reference signal densities), and when uplink reports are transmitted relative to configured grant repetitions. As a result, mismatches between RAN-side expectations and UE-side behavior may occur, leading to inaccurate CSI reports, poor modulation and coding selection, or even failed handovers.

In one embodiment, a RAN node that initiates a mobility-related measurement procedure generates an Early-CSI Reference & Multiplexing Descriptor (ERMD) that encapsulates a complete set of assumptions required to interpret channel state information (CSI) reported by the wireless device (i.e., early measurement implies dynamic rules with which the device may trigger handover reporting earlier than the preset hard conditions). The ERMD includes parameters such as whether to inherit reference settings from the target cell's initial bandwidth part, specific demodulation reference signal (DMRS) configurations including length and position, a validity mask for allowed symbol types under sub-band full duplex conditions, an explicit repetition policy for Type-A reporting, and a pointer to the applicable uplink reporting occasion. By signaling this compact descriptor together with a candidate selection or conditional handover command, the RAN ensures that the UE computes and transmits CSI in full alignment with its interpretation logic, thus reducing ambiguity and enabling deterministic decoding.

In another embodiment, a WTRU that receives a candidate selection command including an ERMD derives CQI, PMI, and RI feedback using only the measurement resources indicated in the descriptor. This includes filtering downlink measurements to the symbols allowed by the validity mask—such as SBFD-valid symbols only—and computing CSI using the DMRS density, length, and spacing as explicitly configured by the RAN. The WTRU then places the resulting CSI report on the uplink transmission occasion indicated by the ERMD, following the specified repetition rule for Type-A or defaulting to first actual for Type-B, ensuring predictable report timing that avoids uplink scheduling collisions or missed reports.

In a further embodiment, a WTRU supports deterministic fallback behavior in scenarios where the ERMD is not received or cannot be decoded. The WTRU applies a hardcoded rule that maps Type-B repetitions to the first actual uplink opportunity and Type-A repetitions to the nearest feasible scheduled PUSCH occasion after a minimum processing delay. To ensure transparency, the WTRU includes a fallback indicator within the CSI report, allowing the RAN to understand the deviation from expected behavior and apply decoding logic accordingly without misinterpreting the quality metrics.

In another embodiment, the RAN node enhances handover robustness by broadcasting a lightweight rate-match coordination bitmap during the early measurement window. This bitmap identifies downlink time-frequency resources that should be reserved for candidate cell CSI-RS transmissions, allowing other co-channel transmissions to avoid interfering with the UE's measurements. This ensures that the CSI collected by the UE—especially in scenarios with beamformed or periodic CSI-RS—is of high integrity and reflects the true state of the target channel.

In one embodiment, the ERMD includes a continuity identifier that increments with each distinct mobility execution attempt. The WTRU uses this continuity ID to detect duplicate or stale descriptors and suppress redundant CSI processing, particularly useful after discontinuous reception cycles or paging events. By avoiding unnecessary measurements and CSI generation, the UE conserves power and reduces signaling overhead, while the RAN benefits from timely and fresh measurement data aligned to the current handover context.

In a further embodiment, when a handover is triggered using RRC Reconfiguration with Synchronization, the RAN node optionally echoes the previously transmitted ERMD within the reconfiguration message. This allows the WTRU to maintain the same measurement assumptions and reporting schedule during the execution of the handover, ensuring that uplink CSI transmitted immediately after synchronization completion remains consistent with what the RAN expects, thereby preserving decoding accuracy and MCS selection integrity across layer-3 mobility procedures.

In yet another embodiment, the RAN node generates and signals separate ERMD instances for each candidate cell or beam considered during a multi-candidate mobility evaluation process. Each ERMD independently defines the CSI derivation parameters and uplink placement policy for its corresponding target, allowing the UE to prepare and transmit distinct reports per candidate without confusion or parameter overlap. This per-candidate alignment ensures better beam or cell ranking and reduces the risk of selecting a suboptimal target due to mismatched measurement conditions.

In another embodiment, the WTRU supports the decoding of the ERMD as a compact type-length-value (TLV) container embedded within a MAC control element. Upon receiving the descriptor, the UE parses each field-reference inheritance flag, DMRS profile, symbol mask, repetition policy, and occasion index- and configures its measurement and reporting modules accordingly. This efficient TLV structure enables backward compatibility with existing MAC signaling formats while minimizing the control overhead required to convey complex measurement alignment policies.

In one embodiment, the RAN node selects the Type-A repetition policy adaptively based on predicted uplink congestion or grant overlap. For instance, if the RAN detects that the first scheduled grant is likely to be occupied by retransmissions or other high-priority traffic, it configures the ERMD to instruct the UE to delay CSI placement to the second repetition. This preemptive signaling avoids conflicts and missed reports without requiring dynamic coordination at runtime, enabling more efficient uplink usage.

In another embodiment, a WTRU that receives an updated ERMD as part of a synchronization message maintains the previously received measurement assumptions and report placement configuration unless the continuity identifier has changed. This allows the WTRU to sustain consistent behavior throughout the handover window, while still supporting dynamic re-alignment if a new descriptor is issued, thus combining stability with responsiveness in the handover process.

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

Accordingly, while the present application has been described herein in detail in relation to various embodiments, it is to be understood that this disclosure is illustrative of one or more concepts expressed by the various example embodiments and is made merely for the purposes of providing a full and enabling disclosure. The following disclosure is not intended nor is to be construed to limit the present application or otherwise exclude any such other embodiments, adaptations, variations, modifications and equivalent arrangements, the present embodiments described herein being limited only by the claims appended hereto and the equivalents thereof.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

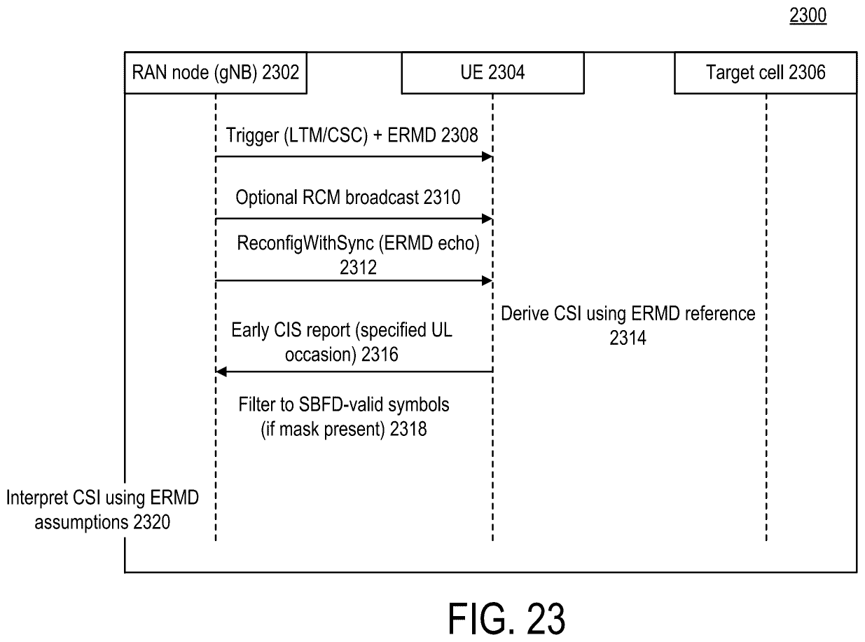

FIG. 23 illustrates a timing diagram 2300 on device ERMD configuration from a first RAN node 2304. In an embodiment, a method is performed by a radio access network (RAN) node 2302, such as a gNB, for acquiring early channel state information (CSI) associated with a target cell or beam. The method begins with the RAN node initiating an early measurement procedure for a wireless device in anticipation of a mobility event, such as a conditional handover, candidate beam reselection, or beam failure recovery. This triggering 2308 may occur upon satisfaction of predefined criteria including signal degradation at the serving cell, receipt of updated measurement reports, or fulfillment of a conditional mobility command. The RAN node determines one or more target candidates requiring channel quality evaluation and prepares for early CSI acquisition without immediately finalizing the handover execution.

In order to ensure alignment between the RAN's interpretation of reported measurements and the wireless device's 2304 computation logic, the RAN generates a compact signaling descriptor that binds together a reference measurement configuration and an explicit multiplexing policy for the placement of the uplink CSI report. This signaling descriptor, referred to herein as the Early-CSI Reference & Multiplexing Descriptor (ERMD), is constructed to include critical interpretation parameters such as a reference-inheritance flag indicating whether to use target cell bandwidth part defaults or alternative settings, demodulation reference signal (DMRS) parameters including density and length, a validity mask that defines allowable downlink symbol types (e.g., SBFD-valid symbols), and a scheduling directive that identifies the first applicable uplink transmission opportunity by index and the expected repetition policy type (e.g., Type-A or Type-B).

In additional embodiment, the Early-CSI Reference & Multiplexing Descriptor (ERMD) generated by the RAN node 2302 includes a reference configuration that instructs the wireless device on how to compute early channel state feedback based on a prescribed set of physical-layer assumptions. The reference configuration may include a reference-inheritance flag that, when set, causes the device to inherit the DMRS density and symbol structure from the initial Bandwidth Part (BWP) of the target cell. For example, in a target cell with an initial BWP configured with a normal cyclic prefix, 30 KHz subcarrier spacing, and DMRS density profile Type 1 (e.g., every fourth symbol), the UE uses this structure to compute its CSI, ensuring alignment with the gNB's interpretation of quality metrics. Alternatively, if the flag is unset, the descriptor signals an explicit DMRS profile, for instance, a compact Type 3 profile with increased density for narrow-beam targets. The ERMD may also include an override for BWP-specified parameters, enabling fallback to a standardized CSI reference structure when the target BWP is not yet activated. This flexibility ensures that UEs can support both legacy BWP-based and future modular PHY models under a single aligned framework.

There may be an optional RCM broadcast 2310.

In an embodiment, the ERMD may further include a multiplexing policy that dictates when and where the UE shall place its uplink CSI report in order to avoid ambiguity or timing mismatch. For Type-A repetition configurations, the ERMD explicitly signals whether the first repetition must be used (e.g., policy=“force first”) or whether the device is permitted to choose among the available configured grant repetitions (e.g., policy=“UE-discretion with deadline T_proc”). For example, if three Type-A repetitions are configured following a grant window, the ERMD may instruct the UE to use the second one, indexed relative to grant slot+2, ensuring processing time sufficiency and avoiding collision with scheduled HARQ traffic. For Type-B configurations, the ERMD enforces a “first actual” rule, whereby the device shall place the CSI on the first dynamically scheduled PUSCH that follows both processing completion and time-to-report constraints. This removes ambiguity associated with vendor-implementation choices and enables the RAN node to anticipate CSI arrival without the need to monitor multiple uncertain repetitions.

Furthermore, the ERMD descriptor may further support encoding of a virtual bandwidth part (BWP) index, which may refer to either a configured or on-demand virtual BWP constructed across non-contiguous spectrum components. For instance, a UE supporting hierarchical BWP configurations may receive an ERMD that references BWP-ID 5, corresponding to a wideband aggregate of multiple 100 MHz slices for XR services.

The reference-inheritance flag, when used in combination with a BWP override field, allows the device to resolve conflicts between default BWP numerologies and descriptor-imposed settings. Additionally, to reduce control overhead and improve switching responsiveness, the ERMD may be encoded as a differential update from a previously signaled reference state, requiring the UE to modify only changed fields such as the DMRS density or symbol-type mask. This forward-compatible signaling approach enables early CSI procedures to benefit from the BWP pooling, cross-BWP coordination, and modular PHY features being developed for 6GR.

The RAN node transmits 2308 the ERMD to the wireless device together with or as part of a candidate selection control element, thereby enabling the device to derive CSI for the target based on a synchronized set of assumptions and to multiplex the uplink report at a deterministically known location. Through this procedure, the RAN ensures that early channel quality feedback received from the device reflects the actual conditions experienced on the target cell or beam under a common reference model, eliminating ambiguity caused by device-specific interpretations, report misplacement, or inconsistent symbol processing, and thereby enabling more accurate beam ranking, MCS selection, and mobility decision-making.

Specifically, the Early-CSI Reference & Multiplexing Descriptor (ERMD) is transmitted 2308 by the radio access network (RAN) node 2302 in conjunction with, or embedded within, a candidate selection control element, such as a conditional handover (CHO) MAC control element (MAC-CE), RRC ReconfigurationWith Sync message 2312, or LTM (Layer-Triggered Mobility) procedure. An optional RCM broadcast 2310 may occur. The RAN node 2302 determines a target cell 2306 or beam, for example based on signal thresholds, measurement history, or a ranked candidate list, and attaches the ERMD to the control signaling directing the UE 2304 toward that target 2306. The ERMD may be encoded as a compact MAC CE using a type-length-value (TLV) format or as a dedicated information element within an RRC message, with fields including a reference inheritance flag, DMRS profile, symbol-type validity mask, multiplexing policy (e.g., Type-A/Type-B), and a PUSCH reporting index.

To ensure timing consistency, the RAN node schedules the ERMD-containing message such that the device has sufficient processing time before the first applicable CSI transmission window, typically allowing for at least one symbol burst of CSI-RS from the target. If multiple MAC-CEs are involved, such as during multi-beam reselection or multi-panel mobility, the ERMD may be encoded per target beam and linked to a candidate ID to maintain clarity. This transmission model ensures that all relevant CSI derivation 2314 and reporting parameters are co-delivered with the candidate selection, avoiding misinterpretation and guaranteeing uplink CSI report 2316 placement at a deterministically expected location, thus improving early beam ranking, MCS initialization, and handover continuity.

In another embodiment, the ERMD signaling framework is extended to support 6G-era multi-cell and virtual component carrier configurations, wherein a group of logical or virtualized component carriers (VCCs) is treated as a unified measurement and reporting entity. In this context, the ERMD is generated per virtual component carrier group, referred to herein as a VCC-Group, which may span multiple beams, panels, or even nodes, as defined under the 6G virtual cell or virtual carrier aggregation framework.

The ERMD may include an additional carrier group identifier (e.g., VCC-ID) and may optionally include a bitmap of logical carrier indices, each associated with either a shared or carrier-specific DMRS profile. The descriptor further defines whether CSI should be computed per virtual carrier and reported 2316 in a joint, compressed format or individually multiplexed across separate PUSCH occasions. For example, in a system where three VCCs (e.g., virtual carriers operating across distinct numerologies or frequency bands) are associated with a common candidate handover, the UE may be instructed to measure channel quality over all three using unified assumptions (e.g., SBFD-valid symbols only, DMRS profile B) and to compute either individual CQI/PMI/RI tuples or a single representative composite. The ERMD may encode this instruction using a reporting strategy field and reference inheritance per carrier, enabling the RAN to control granularity of feedback and avoid excessive signaling. This model is especially beneficial in dense or high-throughput scenarios, such as joint TRP operations, distributed MIMO, or beam-centric architectures where logical mobility involves overlapping carriers with different RAN anchors. The use of ERMD per VCC group also supports advanced scheduling and beam management strategies, enabling the RAN to correlate CSI reports 2316 with resource assignment across virtualized layers, leading to improved multi-carrier handover precision and better spectral efficiency under disaggregated RAN deployments.

In an embodiment, a radio access network node generates a compact signaling descriptor designed to jointly convey, in a single transmission, both the measurement reference configuration and the uplink multiplexing policy applicable to an early channel state information (CSI) procedure for a target cell or beam. The descriptor, termed an Early-CSI Reference & Multiplexing Descriptor (ERMD), is constructed to encode all essential physical-layer parameters that the wireless device must apply when deriving channel quality and precoding feedback prior to handover or beam transition.

Within the ERMD, the network node specifies a reference configuration that identifies whether the wireless device shall inherit parameters from the target cell's initial bandwidth part or instead utilize a standardized default set, and further defines demodulation reference signal (DMRS) characteristics including density profile, maximum sequence length, and position indices. The descriptor may also include a symbol-type validity mask that explicitly restricts measurement averaging to particular downlink symbols, such as sub-band full-duplex-valid symbols, thereby ensuring that both the device and the network rely on a consistent subset of the received signal for CSI derivation. Concurrently, the RAN node encodes within the same descriptor a multiplexing policy that deterministically identifies where the device shall place its uplink CSI report. This policy includes a reference to the first applicable physical uplink shared channel (PUSCH) occasion relative to a scheduling grant or configured grant window, as well as a rule governing the handling of Type-A and Type-B repetitions-specifying, for instance, that Type-A shall use the first repetition and Type-B the first actual occurrence.

The radio access network node includes in the Early-CSI Reference & Multiplexing Descriptor (ERMD) a reference configuration flag that instructs the wireless device whether to inherit measurement assumptions from the target cell's initial bandwidth part (BWP) or instead use a predefined default configuration. When the flag is set to “inherit,” the wireless device applies the DMRS density profile, maximum sequence length, and positioning derived from the initial active BWP of the target cell as specified in system information or RRC reconfiguration. This approach ensures that channel quality feedback aligns with how the target cell will actually operate upon handover completion.

In contrast, when the flag is set to “default,” the wireless device disregards target BWP signaling and instead applies a standardized default configuration defined by the network—for example, using a fixed 30 KHz SCS, Type-1 DMRS density, maximum sequence length of 4 symbols, and position indices starting at symbol 2. This fallback is particularly valuable in early mobility scenarios where the BWP context of the target cell is not yet activated, misaligned across carriers, or subject to cross-BWP scheduling complexity. The use of this inheritance flag enables a hybrid signaling model where both explicit default alignment and implicit BWP referencing are supported, allowing the network to tailor early CSI acquisition to the availability, readiness, and complexity of the target cell's BWP configuration.

In another embodiment, the ERMD's reference configuration may support advanced BWP control information, including hierarchical BWP structures, virtual BWP overlays, and per-BWP QoS mappings. In this configuration, the reference configuration portion of the ERMD includes not only a BWP inheritance flag, but also a BWP-ID field and an optional virtual BWP index, which together define the specific bandwidth context to be used for CSI derivation. For instance, in a target cell supporting five configured BWPs and a hierarchy of grouped BWPs for XR, URLLC, and IoT traffic, the network may indicate that the UE shall derive CSI assuming operation under BWP-3 (URLLC) but override the default DMRS density to use Type-3 profile due to beam width constraints.

Alternatively, if virtual BWPs are used—for example, spanning fragmented spectrum components, the ERMD may reference a virtual BWP ID that aggregates those carriers for early measurement purposes while deferring full activation to later RRC signaling. Furthermore, when BWP-level QoS association is supported, the ERMD may signal an early alignment between measurement assumptions and expected QoS class (e.g., 5QI), ensuring that CSI reflects the propagation environment relevant to the intended traffic class.

The compact structure of the ERMD allows these interdependent parameters to be communicated atomically within a single MAC control element or TLV container, avoiding fragmented configuration signaling that could lead to misalignment between network expectations and device behavior. Once transmitted to the wireless device, this unified descriptor enables the device to compute CSI precisely under the conditions assumed by the network and to transmit the report in a time-synchronized and collision-free manner, improving reliability of early channel estimation and enabling smoother, low-latency mobility execution.

Accordingly, the radio access network node transmits the compact descriptor, comprising both the reference configuration and the multiplexing policy, to the wireless device in a time-aligned and context-aware manner, such that the device can immediately act upon the instructions to initiate early channel state information (CSI) processing. The transmission of the descriptor occurs in conjunction with a candidate selection command or a conditional handover control element, ensuring that the wireless device interprets it within the correct mobility context.

The descriptor may be encapsulated as a MAC control element or carried within a type-length-value (TLV) container appended to an LTM (Layer Triggered Mobility) or ReconfigurationWithSync message. Upon receipt, the wireless device parses the reference configuration portion of the descriptor to determine which demodulation reference signal (DMRS) resources to use, whether to inherit parameters from a target cell's initial bandwidth part, and which downlink symbols are considered valid for averaging based on SBFD or other duplexing masks. Simultaneously, the device uses the multiplexing policy portion to identify the exact uplink reporting opportunity by index or timing alignment and applies the repetition rule indicated for Type-A or Type-B configurations.

In one example, the wireless device, upon receiving the ERMD encapsulated within a MAC control element or TLV container appended to a Layer-Triggered Mobility (LTM) or ReconfigurationWith Sync message, parses the reference configuration portion to determine which demodulation reference signal (DMRS) resources are applicable for early channel state information (CSI) derivation. The ERMD may include an explicit DMRS density profile identifier-such as Type-1, Type-2, or Type-3-along with optional parameters including maximum sequence length (e.g., four symbols), position indices (e.g., symbols 2, 6, 10), and frequency-domain spreading flags.

If the ERMD specifies a “reference inheritance” flag set to TRUE, the device retrieves the active parameters from the target cell's initial bandwidth part (BWP), as signaled via RRC, including the configured numerology (e.g., 30 KHz subcarrier spacing), CP type, and DMRS mapping type. Conversely, if the inheritance flag is set to FALSE, the device uses a predefined default measurement configuration—for example, a compact DMRS pattern with fixed 2-symbol length starting at symbol index 2 and defaulted to even-numbered PRBs only. This mechanism ensures that CSI is computed under assumptions synchronized with the target cell's operational context, whether inherited or explicitly overridden, and avoids misalignment stemming from vendor-specific device heuristics or BWP unavailability at early handover stages.

In another implementation example, the ERMD includes a symbol-type validity mask that directs the wireless device to limit its CSI measurement averaging only to a subset of downlink symbols that are deemed valid under the current or expected duplexing configuration. For example, in systems supporting sub-band full duplex (SBFD), where certain symbols are designated for uplink operation within the same TDD slot, the symbol-type validity mask may indicate that only downlink-only symbols (e.g., symbols 0, 2, 4, 7, 9) should be included in the measurement process, while uplink-overlapping symbols (e.g., 5, 6, 11) are explicitly excluded.

Such masking may be encoded as a binary bitmap or a symbolic index range within the ERMD and is interpreted by the device to gate the accumulation of channel estimates. In another variant, for half-duplex FDD or flexible duplex systems, the descriptor may instruct the device to apply a dynamic mask based on measured interference conditions or known traffic directionality. By enforcing strict alignment of symbol inclusion criteria between the RAN and the device, the system avoids CQI bias introduced by averaging over distorted, uplink-contaminated, or ambiguous symbols, thereby ensuring that reported CSI values—especially under beamformed or low SNR conditions—reliably reflect the usable channel quality of the target cell or beam.

This allows the wireless device to perform CSI measurement and report placement in strict accordance with the RAN node's expectations. As a result, the network receives channel quality reports that are not only accurate in terms of physical-layer assumptions but also precisely timed and correctly aligned with grant windows, thereby eliminating misinterpretations or missed CSI due to placement ambiguity or asynchronous measurement logic. This transmission of a compact, deterministic descriptor forms the core of a synchronized early measurement framework that reduces handover delays, prevents resource collisions, and significantly improves the robustness and reliability of mobility decisions in dense, multi-beam, or high-speed deployment scenarios.

The Early-CSI Reference & Multiplexing Descriptor (ERMD) enables deterministic timing alignment between the radio access network node and the wireless device by encoding a reference index to the first applicable uplink transmission occasion within a configured grant or dynamic scheduling window. The descriptor provides an index relative to a known anchor slot, such as the scheduling grant slot or the last downlink measurement slot, thereby allowing the wireless device to compute an exact offset (Δ slot) for its CSI report placement. For example, if the ERMD specifies “first applicable occasion index=2” the device places its report on the second uplink opportunity following the indicated anchor.

The RAN node, using the same deterministic offset and repetition rule (Type-A or Type-B) stored in its scheduler, opens the corresponding reception window precisely aligned in time and frequency resources. Because both sides share the same reference slot, repetition rule, and offset logic, the CSI report arrival is perfectly synchronized with the RAN's reception configuration, preventing placement ambiguity that might otherwise result from implementation-specific latency or grant interpretation differences. This deterministic alignment ensures that channel quality reports are decoded exactly when expected, even under variable UE processing or beam-switching conditions.

In another embodiment, such correct uplink alignment is achieved by coupling the ERMD's multiplexing policy with the RAN scheduler's grant-window management. When a configured grant contains multiple repetitions, the ERMD explicitly designates which repetition index is valid for the CSI report. For instance, for Type-A repetition, the ERMD may specify “use first repetition,” meaning that the UE must transmit the CSI report during the very first occurrence of the scheduled uplink opportunity within the grant window, while for Type-B repetition, the descriptor mandates transmission on the “first actual feasible” PUSCH following decoding of the descriptor. This eliminates the ambiguity of whether the UE should transmit on the first or second repetition when timing constraints differ across implementations. The RAN scheduler, being aware of the repetition policy signaled in the same ERMD instance, synchronizes its receive-buffer activation and HARQ expectations accordingly. As a result, the CSI report is both correctly timed and resource-aligned, reducing missed receptions, redundant monitoring, and uplink contention, particularly in dense-beam deployments where multiple UEs compete for overlapping PUSCH opportunities.

In a further embodiment, the symbol-level alignment is achieved by associating the ERMD timing reference with the same synchronization domain used for the target cell or beam's CSI-RS transmission, ensuring consistency between the downlink measurement epoch and the uplink reporting instance. Specifically, the RAN node encodes a measurement-to-report interval parameter within the ERMD, indicating the number of OFDM symbols or slots between the completion of the downlink CSI-RS measurement and the start of the uplink CSI transmission. For example, an interval value of 14 symbols corresponds to a full slot delay, ensuring that both transmitter and receiver account for the same propagation and processing latency. This coordination prevents cases where the UE reports CSI based on outdated channel observations, which is especially critical in high-speed mobility or multi-beam switching where channel coherence time is short. The result is a precisely aligned CSI timeline in which the reported metrics reflect the channel state at the intended instant, thereby improving modulation and coding selection and beam ranking accuracy for mobility decisions.

In additional embodiment, the RAN node maintains a scheduler-anchored alignment model that associates each transmitted ERMD instance with a specific scheduler frame identifier or absolute timing reference (e.g., system frame number modulo value). Upon receiving the ERMD, the wireless device maps the indicated reference frame number to its internal timing counter, ensuring that the uplink report is transmitted at a deterministically calculated slot boundary known to both ends. This mechanism allows multiple UEs or carrier groups operating under separate ERMD instances to remain orthogonal within shared spectrum, reducing collisions between concurrent CSI reports. In multi-carrier systems or virtual component carrier (VCC) aggregation scenarios, the alignment anchor may further include a carrier index field to specify the frequency domain of the expected report. The synchronized timing anchors ensure that even when reports from different carriers are aggregated, each CSI instance arrives at the correct reception interval relative to its corresponding beam or VCC group, thereby maintaining coherence and avoiding mis-association in the RAN's multi-link processing chain.

In one embodiment, the compact descriptor comprising the reference configuration and multiplexing policy for early channel state information (CSI) acquisition is conveyed by the radio access network node as a MAC control element that is transmitted together with, or piggybacked upon, a candidate-selection or conditional handover control element. This allows the network to atomically deliver all relevant mobility parameters to the wireless device within a single procedural context, eliminating the need for fragmented signaling across multiple layers or protocol transactions. Specifically, when the network triggers a conditional handover or beam switch scenario, it includes the Early-CSI Reference & Multiplexing Descriptor (ERMD) alongside the candidate selection indication in the same MAC protocol data unit (PDU), enabling the device to immediately interpret both the target and the assumptions under which measurements are to be made.

This co-location of signaling ensures that the descriptor is interpreted as contextually bound to the candidate named in the command, and that the wireless device does not inadvertently apply parameters to an outdated or incorrect target cell or beam. Moreover, conveying the ERMD within the MAC layer offers reduced latency and minimizes the risk of misalignment caused by delayed RRC signaling, while maintaining compatibility with existing control element encoding schemes. By embedding the compact descriptor at the point of candidate command issuance, the network ensures procedural determinism, improves measurement integrity, and lays the foundation for a synchronized early CSI pipeline that enhances mobility responsiveness in modern RAN deployments.

The compact descriptor generated by the radio access network node includes a reference configuration flag that explicitly instructs the wireless device on how to derive the physical-layer parameters used for early channel state information (CSI) measurements toward the target cell or beam. This flag serves as a binary or enumerated indicator that resolves ambiguity regarding which configuration baseline the device should apply-either to inherit parameters from the initial bandwidth part (BWP) associated with the target cell or to fall back to a predefined default reference set that may be standardized or locally defined by the network. When the flag signals inheritance, the device applies the specific demodulation reference signal (DMRS) density, subcarrier spacing (SCS), cyclic prefix (CP), and PRB-level bundling settings associated with the target cell's initial BWP configuration, as would be used for normal data transmission after handover.

Conversely, when the flag indicates the use of a default configuration, the device disregards the target cell's BWP and instead applies a minimal or standardized set of assumptions optimized for early measurement stability and universal compatibility across diverse target types. By embedding this reference configuration flag within the compact descriptor, the network ensures that both the transmitter (device) and the receiver (gNB) are aligned in their assumptions about the reference signals used for CSI derivation, thereby eliminating interpretation mismatches and enabling the gNB to make precise mobility decisions based on predictable and consistent measurement conditions. This flag-based reference model selection supports flexible deployment strategies, including scenarios where BWP reconfigurations are pending or unavailable during early measurement, and is critical to enabling robust early feedback in time-sensitive or beam-dense environments.

Therefore, the reference configuration conveyed within the compact descriptor includes explicit indications of one or more demodulation reference signal (DMRS) density profiles to be used by the wireless device when deriving early channel state information (CSI) for a target cell or beam. These DMRS-related indications comprise at least a maximum length parameter, which defines the number of contiguous or periodic symbols across which DMRS sequences are expected to span, and may further include additional position settings that specify the exact symbol locations, spacing, or time-frequency offsets at which DMRS are present within the target transmission structure.

Specifically, the compact descriptor transmitted by the radio access network node specifies the maximum DMRS length parameter to be used by the wireless device during early channel state information (CSI) measurement. This parameter defines how many OFDM symbols contain valid demodulation reference signal sequences across the slot or subframe. The choice of DMRS span is adapted based on the spatial beam characteristics and the expected coherence properties of the channel.

For example, in a widebeam scenario or when the UE is located at the cell edge, the DMRS span may be extended to four symbols to improve averaging and channel estimation accuracy over a noisier or more frequency-selective channel. Conversely, for narrow beam targets-such as during precise beamforming or when mobility is low—the DMRS length may be set to one or two symbols to reduce overhead and limit channel contamination across symbols. The ERMD includes this length parameter explicitly, allowing the device to apply it uniformly across the measurement window, thus ensuring that the reported CQI, PMI, or RI reflects the channel under the exact same structural assumptions as used by the gNB in decoding or beam selection.

Accordingly, the ERMD includes position index settings for DMRS symbols, defining the exact OFDM symbol locations—e.g., symbols 2, 6, and 10—at which the demodulation reference signal appears in the downlink slot structure. These positions are selected based on several operational factors, including subcarrier spacing (numerology), slot duration, duplex configuration (e.g., SBFD), and the CSI-RS scheduling pattern of the target cell or beam. In high mobility scenarios, where Doppler spread is significant, closer DMRS symbol spacing (e.g., every 2 symbols) is preferred to allow the UE to track rapid channel variation. In contrast, under static or low-mobility conditions, the positions may be spaced more sparsely to reduce power consumption while maintaining sufficient channel estimation granularity. Moreover, when the system operates under sub-band full duplex, DMRS positions are chosen to avoid overlap with uplink-interfered symbols, with the ERMD's symbol-type mask ensuring that the UE averages CSI only across clean DMRS-bearing symbols. This explicit signaling of DMRS position indices allows for dynamic, per-candidate adaptation of measurement granularity while maintaining strict alignment between RAN-side assumptions and UE-side computations.

By providing these parameters directly within the descriptor, the radio access network node ensures that the wireless device computes channel quality metrics—such as CQI, PMI, and RI—using the same reference signal structure that the network will assume when interpreting the report. This alignment is critical because any mismatch in DMRS expectations between transmitter and receiver can lead to incorrect interpolation, misestimation of signal-to-noise ratio, and ultimately erroneous MCS selection or beam evaluation.

Further, the inclusion of DMRS density and position parameters within the reference configuration eliminates reliance on implicit or device-specific defaults and guarantees that the derived CSI accurately reflects the propagation conditions experienced on the target cell under a shared physical-layer interpretation. This deterministic coordination of DMRS usage enhances the fidelity of early measurements, reduces variance in feedback quality across devices, and supports more confident mobility decisions, particularly in multi-beam, multi-panel, or high-mobility scenarios where timing and structure alignment are paramount.

In another option, the compact descriptor transmitted by the radio access network node may include a symbol-type validity indication that serves to constrain the wireless device's measurement operations to only a specific subset of downlink symbols deemed valid for channel state information (CSI) derivation under the applicable duplexing configuration. In scenarios where sub-band full duplex (SBFD) operation is enabled—allowing simultaneous uplink and downlink transmissions within separate subbands of the same carrier, the symbol-type validity indication explicitly identifies which symbols, within a given time slot or subframe, are considered free from uplink interference or self-cancellation effects and therefore suitable for reliable downlink measurements.

For example, the indication may define a binary mask, symbol index range, or other compact encoding that restricts the wireless device from including symbols that are reserved for uplink transmission, subject to cross-link interference, or otherwise impaired under the SBFD timing plan. Alternatively, in systems not operating under SBFD, the symbol-type validity indication may default to allowing measurements over all non-overlapping downlink symbols, providing consistency across duplexing modes. By explicitly communicating this constraint as part of the reference configuration, the RAN node ensures that the wireless device derives CQI, PMI, and RI based only on a vetted and mutually agreed set of downlink samples. This prevents the averaging of disallowed symbols, which may distort the perceived channel quality and lead to inaccurate mobility or modulation decisions. The use of a symbol-type validity indication enhances the determinism and precision of CSI feedback in advanced duplexing scenarios, ensuring that device-side measurements remain tightly aligned with network-side assumptions, particularly in time-critical or spectrum-constrained deployments.

In one implementation, the reference configuration may include a symbol-type validity mask designed not only to restrict symbols based on time-domain duplexing modes (e.g., SBFD-valid symbols) but also to account for virtualized carrier structures wherein a virtual component carrier spans multiple physical resource sets. In this embodiment, the RAN node assigns a logical uplink-downlink configuration to the virtual carrier, including a duplexing plan that defines symbol reusability across physical component carriers. The validity mask may explicitly exclude symbol indices that, while appearing as downlink in the virtual view, map to uplink or shared symbols in one or more underlying physical carriers, thereby avoiding cross-link interference or measurement pollution.

In another implementation, the symbol-type validity field can be enhanced to reference a virtual carrier ID along with a cross-mapping table that specifies for each symbol index whether it is usable for downlink CSI derivation, given the composite scheduling of multiple physical carriers. The wireless device, upon receiving the ERMD descriptor, consults this mapping and eliminates any symbols deemed ambiguous or conflicting due to their shared use across uplink-dominant physical carriers. This selective exclusion ensures that CSI metrics such as CQI, PMI, and RI are derived from temporally and spectrally stable symbols across the virtual carrier, maintaining consistency with the network's reference assumptions.

In a further embodiment, the reference configuration within the ERMD includes a bitmask that flags symbols which, although permitted under the SBFD plan, are concurrently allocated to semi-persistent uplink or grant-free HARQ transmissions in an adjacent physical component carrier. The RAN node precomputes these collision scenarios and restricts the descriptor accordingly. The wireless device applies this bitmask to dynamically prune its measurement window, avoiding contaminated symbols and thereby improving CSI accuracy for virtual carrier setups where overlapping transmission configurations are present.

In yet another embodiment aligned with the 6G virtual carrier concept, the network signals the validity mask as a compressed bitmap referencing “safe zones” within a virtual slot, wherein no inter-carrier uplink conflict or out-of-band emission impact is anticipated. These safe zones may be derived from coordinated multi-carrier scheduling or per-beam interference nulling plans. The wireless device limits its CSI derivation exclusively to these zones, yielding high-fidelity measurements despite overlapping numerologies or time-aligned scheduling across carriers.

The multiplexing policy encoded within the compact descriptor explicitly distinguishes between Type-A and Type-B uplink repetition modes and prescribes deterministic placement rules for each, thereby eliminating ambiguity in CSI report timing. For Type-A uplink repetitions, which involve multiple pre-scheduled opportunities for the wireless device to transmit a given transport block, the multiplexing policy includes a directive indicating whether the device shall use the first repetition regardless of internal readiness, or may select among the configured repetitions based on processing constraints or timing feasibility.

This directive ensures that both the network and the device apply a consistent rule when determining the transmission slot for the channel state information report, preventing timing mismatches that may arise when the device assumes it can defer transmission to a later repetition while the network expects the report in the earliest slot. For Type-B uplink repetitions, which involve dynamic or grant-based occasions without a pre-configured redundancy structure, the multiplexing policy requires the wireless device to transmit the CSI report at the first actual feasible transmission opportunity following the descriptor trigger.

Such constraint ensures that CSI reports in Type-B mode are delivered promptly without relying on undefined delay margins, and that the RAN can anticipate their arrival without needing to monitor extended repetition windows. By encoding these repetition-specific rules within the descriptor, the RAN ensures that uplink report timing is both predictable and compatible with its reception scheduling, thereby improving the robustness of CSI delivery in scenarios involving conditional handovers, fast beam switching, or rapid RRC reconfiguration.

Specifically, the multiplexing policy contained within the compact descriptor includes a precise identification of the first applicable uplink transmission occasion on which the wireless device shall place its channel state information (CSI) report, expressed as an index relative to either an explicit uplink grant or a preconfigured grant window. This index-based referencing mechanism enables deterministic mapping of the CSI report to a specific physical uplink shared channel (PUSCH) opportunity, thereby eliminating ambiguity that might otherwise arise from variable device-side readiness, grant overlap, or network-side assumptions about uplink timing. For instance, upon receiving the compact descriptor, the wireless device locates the referenced uplink opportunity within the grant window by interpreting the index value in the context of configured timing parameters, such as slot offsets, repetition structure, or HARQ process alignment, and places the CSI report accordingly.

In an embodiment, the RAN node signals a multiplexing policy that includes an index value referencing the N-th uplink opportunity following an explicitly scheduled uplink grant. The wireless device uses the grant's transmission slot and configured PUSCH mapping to locate the anchor occasion and counts forward to identify the target slot. If the scheduled uplink grant includes repetitions, the index may apply to the first non-repetitive occurrence, unless otherwise overridden by a repetition rule (e.g., Type-A uses first repetition, Type-B uses first actual occurrence). The device verifies slot availability and uplink resource compatibility before placing the CSI report on the identified PUSCH instance, ensuring alignment with RAN-side HARQ tracking and feedback scheduling.

In another embodiment, the multiplexing policy may reference a preconfigured grant (CG) window rather than an explicit dynamic grant. The RAN node signals an index i representing the i-th scheduled CG opportunity within the active window, with CG opportunities determined by UE-side parameters such as periodicity, offset, and time-domain resource assignment. The UE locates the CG window using the configured offset and then identifies the corresponding PUSCH occasion by advancing i slots or subframes. To resolve conflicts or ambiguities—such as the PUSCH already carrying scheduled HARQ or SR—the policy may include a rule prioritizing CSI placement over lower-priority content, or triggering a fallback to the next CG opportunity.

In a further embodiment, the RAN node may additionally define the CSI report placement index relative to an HARQ process anchor. For example, the multiplexing policy may state that the CSI report must be placed in the first available PUSCH opportunity associated with HARQ process X, subject to a defined offset (e.g., +2 slots). The wireless device, upon decoding the HARQ process mapping and uplink feedback expectations, calculates the CSI placement slot using the process-to-slot mapping table. The rule may include alignment constraints such as modulation boundary, minimum spacing, or duplication suppression in case of overlapping CSI-triggered HARQ.

In yet another embodiment, such multiplexing policy may further include a repetition resolution rule: for Type-A CSI reporting (e.g., when early reporting is encouraged for beam mobility), the device uses the first repetition even if it is earlier than the scheduling anchor; for Type-B CSI reporting (e.g., feedback tied to accurate CSI), the device uses the first actual PUSCH occurrence, skipping repetitions. These rules allow the RAN to control trade-offs between latency and accuracy. The descriptor may encode a 1-bit repetition policy field to distinguish between these behaviors, and the UE's MAC scheduler resolves the timing accordingly.

In an additional embodiment, the descriptor includes a conflict handling rule that defines the behavior when the selected PUSCH opportunity overlaps with ongoing uplink data, SR, or another CSI report. The rule may define precedence (e.g., CSI over SR) or merging logic (e.g., joint MAC CE container or prioritized TLV order). Alternatively, the device may be instructed to defer the CSI placement to the next suitable PUSCH opportunity within the same HARQ timing budget. This allows deterministic yet flexible CSI multiplexing, especially under tight resource constraints or multi-service contention.

This deterministic positioning allows the radio access network node to anticipate the exact time-frequency location of the report with high confidence, improving scheduling efficiency and reducing the likelihood of CSI reception failure due to misaligned expectations. Furthermore, by signaling the uplink occasion in relative terms rather than absolute system time, the network retains flexibility to apply the mechanism across a variety of timing configurations and grant types, including configured grants, dynamic grants, and semi-persistent scheduling. The result is a robust and flexible reporting mechanism that aligns CSI feedback timing with network-side interpretation logic, thereby improving the effectiveness of early measurement procedures in mobility-critical scenarios.

The RAN node, after initially transmitting the compact descriptor as part of a candidate selection or early measurement command, further echoes the descriptor, or a summary thereof—in a subsequent reconfiguration-with-synchronization message directed to the wireless device. This ensures that, during a layer-3 handover or conditional mobility execution, the device retains access to the original reference configuration and multiplexing policy without requiring re-derivation or inference based on incomplete context.

By embedding the descriptor, or selected key fields such as the continuity identifier, DMRS profile, symbol-type mask, and multiplexing policy parameters, within the reconfiguration message, the network reinforces the validity of the prior assumptions even as the device transitions to a new serving cell or timing reference. This approach is particularly critical in scenarios where handover occurs rapidly following an early-CSI procedure or where the CSI report is scheduled to be transmitted immediately after synchronization, as it ensures that the report remains aligned with the target network's interpretation framework.

Without this echoing mechanism, the device might default to fallback assumptions or incorrectly reset its measurement and reporting logic, leading to misaligned CSI content, missed transmission windows, or degraded mobility decisions. By explicitly maintaining cross-layer consistency through the reconfiguration message, the network preserves the integrity of the early measurement flow, enabling seamless continuation of the reporting pipeline and reducing latency and signaling overhead during the critical transition phase of handover execution.

Additionally, the RAN node may broadcast, during the early-measurement window, a downlink rate-match coordination indication that informs all co-channel transmission sources within the system to avoid occupying specific time-frequency resources reserved for channel state reference signals (CSI-RS) of the target cells or beams under evaluation. This coordination indication may be implemented as a lightweight bitmap, mask field, or scheduling hint mapped to anticipated CSI-RS occasions, and is distributed over a system information block, dedicated control signaling, or a multicast layer to minimize overhead.

By proactively marking certain resource elements as protected, the RAN prevents interference from overlapping downlink traffic—such as unicast data or broadcast services—thereby safeguarding the integrity of the CSI measurements collected by wireless devices for mobility decision-making. This is especially crucial in multi-beam or dense network deployments, where beamformed CSI-RS signals may be narrow in time-frequency scope and highly susceptible to contamination. The rate-match coordination mechanism ensures that UEs can measure the reference signals as intended, with minimal distortion, leading to more accurate CQI/PMI/RI feedback and higher success rates for beam or cell reselection.

Furthermore, such compact descriptor transmitted by the RAN node may also include a continuity identifier that increments or updates uniquely across distinct executions of the early measurement procedure. This identifier serves two primary functions on the wireless device side: to suppress redundant or duplicate processing of parameter sets already acted upon, and to enable graceful resumption and realignment of the measurement and reporting procedure following a discontinuous reception (DRX) cycle or paging-induced suspension.

When the wireless device receives a descriptor with a continuity ID matching a previously processed instance, it can avoid recomputing measurements or duplicating CSI reports, conserving processing energy and radio resources. Conversely, when the continuity ID is incremented or differs from the prior invocation, the device treats it as a new execution context and initiates a fresh measurement cycle in accordance with the newly signaled parameters. This continuity tracking mechanism enhances robustness and synchronization between device and network behavior, particularly in energy-constrained scenarios or when mobility triggers are deferred across DRX boundaries, by ensuring that measurements are only performed when contextually relevant and mutually understood.

In a further embodiment, when the radio access network node evaluates multiple target cells or beams for mobility purposes-such as in candidate ranking for handover or beam reselection, it generates and transmits separate compact descriptors on a per-candidate basis, with each descriptor independently defining the reference configuration and multiplexing policy appropriate for its corresponding target. This per-candidate approach allows the network to tailor the measurement assumptions and report timing to the specific characteristics of each target, such as varying DMRS configurations, bandwidth part structures, duplexing modes, or uplink grant conditions.

For example, one candidate may require SBFD-specific measurement filtering and deferred uplink reporting, while another may permit full-band averaging with immediate CSI transmission. By generating distinct ERMD instances per candidate, the network ensures that wireless devices apply the correct logic for each target independently, avoiding cross-contamination of assumptions and supporting accurate comparison of beam quality or cell readiness. This granular signaling model also supports scalable mobility management in systems employing multi-TRP, multi-panel, or multi-carrier configurations, where per-target customization is essential for optimal performance.

The RAN node 2302 may interpret 2320 CSI using ERMD assumptions.

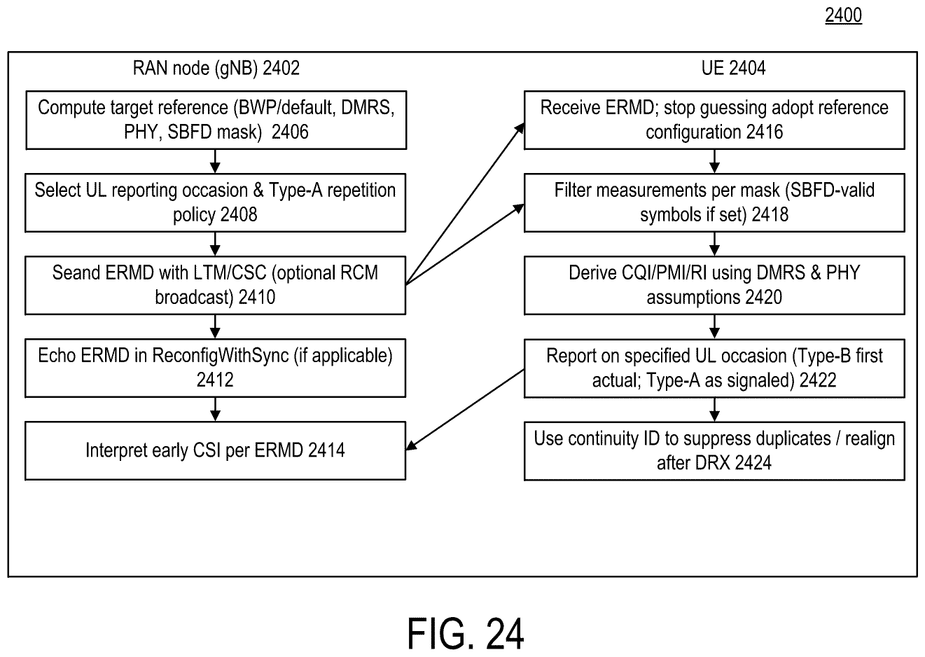

FIG. 24 illustrates the proposed change of device behavior based on ERMD configurations from RAN node. Specifically a RAN node 2402 may compute 2406 target reference information, select 2408 an uplink reporting occasion and type-a repetition policy and send 210 an ERMD with LTM/CSC. The UE 2404 may receive 2416 the ERMD and filter measurements 2418. The UE may derive 2420 the CQI/PMI/RI using DMRS And PHY assumptions. The RAN node may echo 2412 ERMD in reconfigwithsync. The UE may report 2422 on a specified UL occasion and may use 2424 a continuity ID to suppress duplicates/realign after DRX. The RAN node may interpret early CSI per the ERMD.

A wireless device, upon detecting a mobility-related trigger such as a conditional handover command, beam reconfiguration, or signal degradation at the serving cell, receives from the radio access network node a compact descriptor that jointly encodes both a reference configuration for early channel state information (CSI) derivation and a multiplexing policy for uplink report placement. The device parses this descriptor upon receipt and activates its measurement and feedback module in accordance with the signaled reference configuration, which may include inheritance of parameters from a target cell's initial bandwidth part or default values explicitly defined in the descriptor, as well as demodulation reference signal (DMRS) profiles and symbol-type validity constraints. Using this configuration, the device derives channel quality metrics, such as channel quality indicator (CQI), rank indicator (RI), and precoding matrix indicator (PMI), over the designated downlink symbols and reference signals.

Simultaneously, the device consults the multiplexing policy to determine the precise uplink transmission occasion—indexed relative to a configured grant or dynamic scheduling window—on which the CSI report is to be transmitted. The device then places the report on the named occasion using either the first repetition for Type-A or the first actual opportunity for Type-B, as instructed by the policy. This cohesive behavior ensures that the generated report adheres strictly to the assumptions understood by the network, avoiding misalignment in timing, symbol scope, or interpretation, and enables timely and accurate feedback for mobility decisions such as beam switching, target cell reselection, or handover execution.

Further, on the device side, it, upon receiving the compact descriptor from the radio access network node, filters its downlink measurements to include only those symbol types that are explicitly indicated as valid by a symbol-type validity mask encoded in the descriptor. This filtering ensures that the device excludes disallowed or interference-prone symbols, such as uplink-overlapping symbols in sub-band full duplex (SBFD) scenarios, from the measurement averaging process. When the descriptor specifies SBFD-valid-only symbols, the device applies a mask or rule to isolate only those downlink symbols that are guaranteed to be free from uplink contamination, thus preserving the integrity of the derived channel quality indicators. This targeted filtering avoids the inclusion of degraded or invalid samples, thereby ensuring that channel state information such as CQI, PMI, and RI is computed on a clean and network-aligned symbol basis, enhancing the accuracy and reliability of mobility decisions and initial access performance.

In another embodiment, when the wireless device does not receive the compact descriptor-due to loss, scheduling conflict, or control-plane unavailability, it enters a deterministic fallback procedure to select a suitable uplink reporting occasion and indicate this fallback condition to the network. For Type-B uplink repetitions, the device identifies and uses the first actual feasible PUSCH occasion following the mobility trigger or measurement completion. For Type-A configurations, the device selects the nearest scheduled uplink opportunity after a minimum internal processing time that accounts for decoding, measurement, and CSI preparation. To enable the radio access network node to correctly interpret the resulting report and distinguish fallback behavior from misalignment or error, the device embeds a fallback indicator in the report header or control field. This deterministic fallback mechanism ensures that early channel state information is still transmitted in scenarios where signaling is incomplete, and preserves scheduling robustness without sacrificing interpretation fidelity on the network side.

In a further embodiment, the wireless device maintains an internal record of the continuity identifier associated with each received compact descriptor, and uses this identifier to suppress redundant or duplicate processing when a subsequently received descriptor carries the same continuity value as one already processed. This mechanism prevents the device from repeating channel measurements, CSI computation, or report placement unnecessarily, particularly in scenarios involving DRX wakeups, conditional handover re-evaluation, or paging-induced control resynchronization. By leveraging the continuity identifier as a session or instance boundary marker, the device ensures that only new or updated measurement procedures are executed, conserving power and reducing redundant uplink signaling while maintaining accurate alignment with network expectations.

The UE/device may further restrict its channel state measurement operations to only those reference signals and physical-layer parameters explicitly indicated in the compact descriptor. These may include detailed demodulation reference signal (DMRS) configurations, such as density profiles, sequence lengths, and symbol positions, as well as optional subcarrier spacing (SCS) and cyclic prefix (CP) values that deviate from default or serving-cell assumptions. By adhering strictly to the signaled parameters, the device ensures that all channel quality derivations reflect the exact assumptions used by the radio access network node when interpreting the resulting CSI. This constraint eliminates ambiguity introduced by device-side heuristics or implementation-dependent defaults, and allows the network to decode and act upon CSI with high confidence and minimal calibration overhead.

The compact descriptor includes a field-type classification table or flag bitmap that distinguishes between mandatory and optional parameter fields. Each element of the descriptor, such as the demodulation reference signal (DMRS) density profile, subcarrier spacing (SCS), or cyclic prefix (CP), is tagged with an associated compliance requirement. The wireless device parses this classification to determine whether CSI derivation must strictly follow the indicated configuration or whether fallback to a default or legacy behavior is permitted. For instance, if the descriptor indicates a non-standard CP value marked as mandatory, the UE must discard the CSI procedure if it lacks CP support, and instead issue a failure indicator or skip reporting.

Accordingly, the device performs a CSI computability check upon parsing the compact descriptor. If the reference signal configuration (e.g., sparse DMRS density, incompatible SCS) prevents valid CQI, PMI, or RI derivation within hardware or firmware capabilities, the device generates a short error report—e.g., a MAC control element or lightweight Layer 1 indication—informing the network of the inability to compute valid CSI. This report may include an error code (e.g., unsupported symbol pattern, DMRS gap too large, SCS mismatch) and optionally suggest supported alternatives if configured to do so. This enables the network to refine future descriptor generation and maintain service continuity.

In a further embodiment, the compact descriptor supports partial CSI computation through a field validity bitmap or CSI subset indication. When the device encounters a configuration that prevents it from reporting all components (e.g., can compute CQI but not PMI due to angular resolution limits), it uses a CSI-validity field in the report to flag which components were successfully derived. The network, upon receiving the CSI report, interprets only the valid subfields and disregards others. This flexible framework allows descriptor-driven measurement while supporting a graceful degradation in cases of UE capability mismatch or resource limitations.

In another embodiment, the compact descriptor itself is structured as a compact type-length-value (TLV) container, as shown by Table 8, wherein each field is encoded with minimal overhead and clearly delineated boundaries. The TLV container includes at least a reference-inheritance flag, which determines whether the device should inherit target cell parameters or use defaults; a demodulation reference signal profile field, defining DMRS density and placement; a symbol-type validity mask applicable to sub-band full duplex configurations; a repetition policy field for Type-A uplink transmission behavior; and an index value pointing to the first applicable uplink reporting opportunity. This encoding format allows the descriptor to be parsed efficiently by the device and supports flexible extensibility for future parameters, while minimizing control-plane payload size and facilitating integration with MAC control element structures.

TABLE 8
Exemplary ERMD TLV content

| Field Name | Type | Length (bits) | Description |
|---|---|---|---|
| Reference- | Boolean | 1 | Indicates whether the |
| Inheritance Flag | | | device should inherit |
| | | | target cell parameters |
| | | | or use defaults. |
| DMRS Profile | Enum/Bitmap | 4-8 | Defines DMRS |
| Field | | | density, sequence |
| | | | length, and |
| | | | placement. |
| Symbol-Type | Bitmap | 14-28 | Indicates valid |
| Validity | | | downlink symbols for |
| Mask | | | measurement, |
| | | | especially for SBFD |
| | | | scenarios. |
| Repetition | Enum | 2-3 | Specifies the |
| Policy | | | repetition strategy for |
| Field | | | Type-A uplink |
| | | | transmission. |
| Uplink | Integer | 5-7 | Points to the first |
| Opportunity | | | applicable UL |
| Index | | | reporting occasion |
| | | | relative to a |
| | | | configured window. |

Accordingly, the wireless device's derivation of early channel quality metrics based on the received reference configuration comprises computing at least one of channel quality indicator (CQI), rank indicator (RI), and precoding matrix indicator (PMI), using the exact demodulation reference signal positions and density values signaled by the radio access network node. These computations are constrained to only the allowed symbol types and reference signals, and adhere to any physical-layer assumptions such as subcarrier spacing or bandwidth part alignment contained in the descriptor. By basing all CSI computation on the network-prescribed configuration, the device produces a report that is not only accurate in reflecting propagation conditions, but also directly decodable and interpretable by the gNB using deterministic logic.

In an embodiment, the radio access network node determines the Type-A repetition policy to be signaled in the compact descriptor based on a projected analysis of overlapping uplink traffic, scheduled HARQ transmissions, or known grant repetitions that may compete with CSI delivery. For example, if the network anticipates high uplink congestion during the earliest repetition of a configured grant, it may preemptively instruct the device, via the descriptor, to use a later repetition window to avoid scheduling collision or report loss. This adaptive repetition policy selection allows the network to optimize CSI reliability without requiring real-time reconfiguration, thereby enhancing measurement throughput and feedback integrity in high-load or timing-sensitive scenarios.

Moreover, the compact descriptor transmitted by the radio access network node includes not only a repetition policy for the CSI report, but also for other uplink feedback transmissions that share scheduling constraints, such as Hybrid Automatic Repeat Request (HARQ) acknowledgments, Scheduling Request (SR) indicators, Sounding Reference Signals (SRS), or buffer status reports (BSR). The RAN node evaluates the projected uplink load or grant collision profile over upcoming transmission opportunities and adaptively assigns a repetition index for each of these feedback types within the descriptor. For example, in scenarios where the first configured repetition window is expected to be congested due to overlapping HARQ re-transmissions or SRS triggers, the descriptor may indicate that SR or BSR be deferred to the second or third repetition instance. This avoids resource contention and improves transmission success probability without requiring dynamic reconfiguration via higher layer signaling.

Thus, upon receiving a reconfiguration-with-synchronization message from the radio access network node that either echoes or updates the previously received compact descriptor, the wireless device maintains the same reference configuration and multiplexing policy during the handover execution without re-deriving or recalculating local assumptions. This approach ensures continuity between the early measurement context and the post-handover operation, allowing the device to proceed with uplink channel state information (CSI) reporting using the exact parameters originally provided. In doing so, the wireless device preserves alignment with the network's expectations even as the serving cell context changes, which is especially critical when CSI reports are scheduled to be transmitted shortly after synchronization.

By avoiding re-evaluation or fallback behavior, the device minimizes processing overhead, reduces latency in resuming normal operation after handover, and ensures that the measurement and reporting logic remain stable across the mobility boundary, thereby supporting seamless and accurate mobility management in high-speed or low-latency applications.

The compact descriptor is transmitted by the radio access network node together with a conditional candidate selection message, such that the wireless device receives all required measurement and reporting configuration parameters in advance of the condition being satisfied. Once the condition—such as a signal quality threshold or mobility trigger—is met and the candidate is selected, the descriptor remains valid for a bounded period determined either by the continuity identifier embedded in the descriptor or by an associated validity counter signaled by the network. This validity scope allows the device to begin or resume channel state measurements and CSI reporting using the previously signaled configuration without waiting for redundant control signaling, while also ensuring that stale descriptors are ignored beyond their intended application window.

The bounded validity mechanism reduces signaling overhead, supports deferred execution of early measurement logic, and provides robust timing boundaries that prevent misinterpretation or misuse of outdated measurement instructions. This mechanism is particularly valuable in conditional handover scenarios and pre-configured beam-switching use cases, where deferred but deterministic execution of measurement procedures is required.

A method performed by a radio access network node for obtaining early channel state information for a target cell or beam, the method comprising: triggering an early-measurement procedure for a wireless device; generating a compact descriptor that signals, in a single message, a reference configuration to be used by the wireless device when deriving channel quality and precoding feedback for the target, and a multiplexing policy identifying where the wireless device shall place an uplink report; and transmitting the compact descriptor toward the wireless device such that the wireless device derives the early channel state information according to the signaled reference configuration and transmits the report in accordance with the multiplexing policy.

The compact descriptor is conveyed as a MAC control element that is transmitted in conjunction with, or piggybacked upon, a candidate-selection or conditional handover control element (handover command).

The reference configuration ‘flag’ signaled in the compact descriptor indicates that the wireless device shall inherit parameters from an initial bandwidth part of the target cell or, alternatively, shall use a default set of parameters for the target cell. This may give flexibility which of the original or target cells actually tells the UE how exactly to do the measurement.

The reference configuration comprises one or more demodulation reference signal density or density profile indications including at least one of a maximum length and additional position setting, such that the wireless device computes channel quality using the same reference signal density assumed by the radio access network node.

The compact descriptor further includes a symbol-type validity indication that constrains measurements to downlink-valid symbols under sub-band full duplex operation or to non-full-duplex symbols, thereby preventing the wireless device from averaging over disallowed symbols. RAN may enforce how devices should measure and which symbols in case SBFD is active at any of the target cells. So, all measurements from all devices may become consistent and measured with the same methodology.

The multiplexing policy specifies, for Type-A uplink repetition, whether the wireless device shall use a first repetition or may select among scheduled repetitions, and for Type-B uplink repetition requires the wireless device to use a first actual repetition.

The multiplexing policy identifies a first applicable uplink occasion by index relative to a grant or configured grant window, such that the wireless device places the report on the named occasion without ambiguity.

A method may comprise echoing of the compact descriptor or a summary thereof in a reconfiguration-with-synchronization message directed to the wireless device, thereby maintaining alignment across layer-3 handover.

Broadcasting, during an early-measurement window, a downlink rate-match coordination indication that causes co-channel transmissions to avoid time-frequency resources reserved for target-cell channel state reference signals to be measured by the wireless device. Rate matching is a fundamental feature to match traffic volume to available resources. Some channels are co-shared now in real time and so, a real time rate matching may be needed for devices. When a RAN node triggers a device to measure an adjacent RAN early, in an optional embodiment, it can also tell all active devices (not those under early measurement) to avoid using the resources indicated and those are the ones the downlink reference signals of the adjacent cells will be transmitted over and so, a clean measurement opportunity may be presented for handing over devices.

For an impacted active device, when receiving such broadcast, the device(s) would assume that any previously granted resources overlapping with signaled resource pool, are temporarily not available for them to receive anything. The compact descriptor includes a continuity identifier that increments across distinct executions of the procedure and enables the wireless device to suppress duplicate processing of repeated parameters and to realign after discontinuous reception.

The radio access network node generates separate compact descriptors on a per-candidate basis when multiple target cells or beams are considered, each compact descriptor independently defining the reference configuration and multiplexing policy for its corresponding candidate. In an option, one measurement configuration may be associated to a cell or carrier frequency. For SSB detection, for example, sending configs each associated with each carrier frequency and/or cell may be performed.

A method performed by a wireless device, the method comprising: receiving, responsive to a mobility-related trigger, a compact descriptor from a serving radio access network node, the compact descriptor jointly signaling a reference configuration for deriving early channel state information for a target cell or beam and a multiplexing policy identifying where to place a corresponding uplink report; deriving channel quality and precoding feedback according to the reference configuration signaled in the compact descriptor; and transmitting the uplink report in accordance with the multiplexing policy signaled in the compact descriptor.

Measurements may be filtered to only those downlink symbol types identified as valid by a symbol-type validity indication in the compact descriptor, including restricting measurements to sub-band full duplex-valid downlink symbols when so indicated.

When the compact descriptor is not received, selecting a reporting occasion according to a deterministic fallback rule that uses a first actual repetition for Type-B and a nearest feasible scheduled occasion after a minimum processing time for Type-A, and tagging the report with a fallback indicator.

Duplicate processing of parameters may be suppressed when a continuity identifier carried in a subsequently received compact descriptor matches a continuity identifier previously processed by the wireless device.

Channel state measurements may be limited to reference signals and physical parameters identified by the compact descriptor, including demodulation reference signal assumptions and optional subcarrier spacing or cyclic prefix assumptions.

The compact descriptor may be encoded as a compact type-length-value container comprising fields respectively indicating at least a reference-inheritance flag, a demodulation reference signal profile, a symbol-type validity mask for sub-band full duplex operation, a repetition policy for Type-A, and an index to a first applicable uplink reporting occasion.

Deriving channel quality may be performed according to the reference configuration comprises computing at least one of channel quality indicator, rank indicator, and precoding matrix indicator using demodulation reference signal positions and density signaled by the radio access network node.

The radio access network node may select a repetition policy for Type-A based on a projected overlap between configured grant repetitions and other uplink traffic and signals the selected policy in the compact descriptor to avoid missed reports.

Upon receipt of a reconfiguration-with-synchronization message that echoes or updates the compact descriptor, a same reference configuration and multiplexing policy may be maintained across a handover execution without re-deriving local assumptions.

A compact descriptor may be transmitted together with a conditional candidate selection message and, when the condition is met, remains valid for a bounded time indicated by the continuity identifier or an associated validity counter.

What is claimed is:

1. A method performed by a wireless device operating in a wireless local area network (WLAN), the method comprising:
receiving, by the wireless device, one or more data packets; and
transmitting, by the wireless device, a response message on an uplink resource, wherein the response message comprises one or more acknowledgements to the first message;
wherein the response message further comprises one or more of:
one or more buffer delay reports indicative of an amount of data currently awaiting transmission;
an urgency level of low latency traffic; and
information indicative of a data bearer.

2. The method of claim 1, wherein the wireless device computes a number of BSRs which are included.

3. The method of claim 1, wherein a remaining time before a deadline is included in the ack.

4. The method of claim 1, wherein delay is specified by no more than 3 bits.

5. The method of claim 1, wherein the delay corresponds to a number of milliseconds.

6. A method performed by a radio access network (RAN) node for managing extended reality (XR) traffic, the method comprising:
receiving, from one or more active XR wireless transmit/receive units (WTRUs), a local rendering capability indication;
receiving and storing one or more pre-rendered transport blocks, each pre-rendered transport block associated with a timestamp;
calculating an average input packet rate and an average scheduling packet rate;
determining an average available downlink capacity; and
identifying an anticipated congestion time instant.
